(19) United States
(12) Patent Application Publication
(10) Pub. No.: US 2026/0310378 A1
(43) Pub. Date: Oct. 8, 2026

(54) Systems and Methods for Direct-From-Non-Volatile-Memory Neural Network Inference and Hidden-State Reuse

(71) Applicant: BrainChip, Inc., Laguna Hills, CA (US)

(72) Inventors: M. Anthony Lewis, La Jolla, CA (US); Jonathan Tapson, Telluride, CO (US)

(21) Appl. No.: 19/638,037

(22) Filed: Apr. 2, 2026

Related U.S. Application Data
(60) Provisional application No. 63/782,339, filed on Apr. 2, 2025.

(51) Int. Cl. G06F 3/06; G06N 5/04

(52) U.S. Cl. CPC G06F 3/0655; G06F 3/0604; G06F 3/0673; G06N 5/04

(57) ABSTRACT

Systems and methods for performing inference with a neural network model using model weights stored in non-volatile memory without loading the model weights into dynamic random-access memory (DRAM) prior to inference. A processing system reads model weights from non-volatile memory, streams the model weights to a compute engine, generates outputs by performing multiply-accumulate operations using the streamed model weights, and maintains intermediate states in on-chip volatile memory. In some embodiments, a recurrent computational model maintains a hidden state with fixed dimensionality independent of sequence length. In some embodiments, the processing system pre-processes context data to generate hidden states, stores the hidden states, and retrieves the hidden states to resume inference without reprocessing the context data. The hidden states may be stored as tuples comprising a key and a hidden state in a vector database.

### RELATED APPLICATIONS

This application claims the benefit of priority to U.S. Provisional Patent Application No. 63/782,339 entitled “Systems and Methods for Direct-From-Flash Large Language Model Inference Without DRAM” filed on Apr. 2, 2025, the entire contents of which are hereby incorporated by reference for all purposes.

### BACKGROUND

In recent years, edge computing devices such as smartphones, smart sensors, self-driving systems, smart speakers, personal computers, and appliances have become increasingly powerful and complex, incorporating system-on-chips (SoCs), multiple microprocessor cores, microprocessor units (MPUs), central processing units (CPUs), digital signal processors (DSPs), graphics processing units (GPUs), neural processing units (NPUs), artificial intelligence (AI) processors, and other specialized hardware components.

Concurrent advancements in artificial intelligence (AI) and machine learning (ML) have produced highly capable large computational models, including large language models (LLMs), large speech models (LSMs), large vision models (LVMs), and large multimodal models (LMMs). Collectively referred to as large generative AI models (LXMs), these models may process and interpret diverse data types (e.g., text, images, audio) and are increasingly used across a wide range of applications, including natural language processing, computer vision, and speech recognition.

Due to their complexity and substantial computational demands, LXMs are typically deployed in cloud environments where they consume large amounts of computational resources. Cloud-based deployments allow these models to handle the substantial processing and power demands associated with resource-intensive tasks such as real-time text processing. However, the reliance on cloud infrastructure often introduces inefficiencies (e.g., latency, power, bandwidth, etc.) that could degrade the user experience in applications that are dependent on real-time or near-real-time responses. In contrast, deploying LXMs on edge devices or other resource-constrained devices may shift the cost of computing from the manufacturer to the customer, allowing for reduced reliance on cloud resources and potentially mitigating some of the inefficiencies associated with cloud-based models.

The increasing use of edge computing platforms and Internet of Things (IoT) systems has sparked increased interest in distributing computational tasks between edge devices and cloud platforms. Offloading all or portions of LXMs to edge devices may improve the user experience by, for example, reducing latency and power consumption. However, due to the resource-intensive nature of conventional LXM solutions, there are a number of significant technical challenges when attempting to run LXM models on edge devices.

Recent advances in technologies such as recurrent neural networks and state-space AI models offer potential solutions by allowing more efficient processing with lower power requirements. Yet, despite all these advancements, conventional solutions have been unable to overcome various technical challenges in processing large datasets in real time and are generally not adequate for use in edge devices.

### SUMMARY

The embodiments include methods, which may be performed by a processing system that includes a controller, a compute engine, an on-chip volatile memory, and a non-volatile memory, which may include storing model weights associated with a neural network model in the non-volatile memory, streaming the model weights from the non-volatile memory over a serial interface to the compute engine without loading the model weights into dynamic random access memory (DRAM), performing multiply-accumulate operations using the model weights, and storing intermediate state data associated with the neural network model in the on-chip volatile memory. In some embodiments, the non-volatile memory may include at least one of flash memory, MRAM, ReRAM, or PCM. In some embodiments, the on-chip volatile memory may include at least one of SRAM, a register file, or a scratchpad memory. In some embodiments, the streaming may include sequentially accessing address ranges corresponding to layers. In some embodiments, the streaming and multiply-accumulate operations may be performed concurrently. In some embodiments, the serial interface may include a high-speed serial interface. In some embodiments, the method may further include selectively writing at least a portion of the intermediate state data to the non-volatile memory. In some embodiments, writing may include distributing write operations across memory blocks. In some embodiments, the method may further include tracking a write count for each memory block. In some embodiments, the neural network model may include a language, speech, vision, or multimodal model. In some embodiments, streaming and computation may be overlapped in a pipelined manner.

Some embodiments include a method for performing inference using a neural network model. The method may include processing a sequence of input tokens using the neural network model, maintaining a hidden state associated with the neural network model that represents previously processed tokens, updating the hidden state for each input token from the sequence of input tokens, and generating an output based on the hidden state. The hidden state may have a fixed dimensionality independent of sequence length. In some embodiments, the neural network model may include a state-space model. In some embodiments, the hidden state may be stored in on-chip volatile memory. In some embodiments, the updating may include applying a recurrence. In some embodiments, the hidden state may involve resuming processing using the neural network model without reprocessing tokens. In some embodiments, the hidden state may occupy a fixed memory footprint.

Some embodiments include a method for accelerating inference of a neural network model. The method may include processing context data associated with a feature to generate a hidden state associated with the neural network model, storing the hidden state in a memory, receiving an input query associated with the feature, retrieving the hidden state, and continuing inference using the neural network model and using the hidden state as an initial state. In some embodiments, the hidden state may be stored as a tuple comprising a key and the hidden state. In some embodiments, the key may include an embedding vector. In some embodiments, the hidden state may represent a compressed representation. In some embodiments, retrieving may avoid reprocessing context data. In some embodiments, the hidden state may be generated offline. In some embodiments, the hidden state may be used as an initial condition.

Some embodiments include a method for performing inference using a neural network model that includes retrieving multiple hidden states associated with the neural network model, determining relevance scores, combining the hidden states to generate a fused hidden state, and performing inference using the fused hidden state. In some embodiments, combining may include computing a weighted sum. In some embodiments, a relevance score may be determined using an embedding. In some embodiments, the hidden states may correspond to different sources.

Some embodiments include a method for modifying an inference associated with a neural network model. The method may include maintaining a hidden state associated with the neural network model, receiving a modification indication related to the hidden state, computing a prior hidden state associated with the neural network model by reversing update operations, and continuing inference using the neural network model based on the prior hidden state. In some embodiments, reversing update operations may include applying an inverse recurrence. In some embodiments, the modification indication may include an indication associated with removing tokens.

Some embodiments include a method for storing and retrieving intermediate state data. The method may include generating a hidden state associated with a machine learning model, generating a key, storing a tuple comprising the key and the hidden state, receiving an input query, matching the input query to the key, and retrieving the hidden state associated with the machine learning model. In some embodiments, the key may include an embedding vector. In some embodiments, the hidden state may represent compressed data.

Some embodiments include a method for executing a neural network model that includes streaming weights associated with a first portion of the neural network model, performing a computation associated with the first portion of the neural network model, streaming weights associated with a second portion of the neural network model at least partly during the computation associated with the first portion, and performing a computation associated with the second portion of the neural network model. In some embodiments, the portions may correspond to layers.

Some embodiments include a method for generating a response to an input query that includes receiving the input query, generating a query representation, retrieving a hidden state associated with a model, initializing the model using the hidden state, and generating the response. In some embodiments, retrieving may include accessing tuples.

Some embodiments include a method for performing inference of a neural network model that includes streaming weights for a layer, processing the layer, discarding the weights for the layer, and repeating for one or more subsequent layers.

Some embodiments include a method for operating a processing system that includes storing weights associated with a plurality of machine learning models, performing an inference using a first machine learning model, switching to a second machine learning model without loading weights associated with the second machine learning model into DRAM, and performing an inference using the second machine learning model.

Some embodiments include a system comprising a processing system, an on-chip volatile memory, a non-volatile memory, and a serial interface. The non-volatile memory may be configured to store model weights associated with a neural network model. The processing system may be configured to stream the model weights from the non-volatile memory over the serial interface without loading the model weights into DRAM, perform multiply-accumulate operations using the model weights, and store intermediate state data in the on-chip volatile memory. In some embodiments, the non-volatile memory may include flash memory, MRAM, ReRAM, or PCM. In some embodiments, the on-chip volatile memory may include SRAM, a register file, or a scratchpad memory. In some embodiments, the processing system may sequentially access address ranges corresponding to layers. In some embodiments, streaming and multiply-accumulate operations may be performed concurrently. In some embodiments, the processing system may selectively write intermediate state data to the non-volatile memory and may distribute write operations across memory blocks and track write counts. In some embodiments, the processing system may overlap streaming and computation in a pipelined manner.

Some embodiments include a device for performing inference using a neural network model. The device may include one or more processors and a memory storing instructions that cause the processors to process input tokens, maintain a hidden state with fixed dimensionality independent of sequence length, update the hidden state for each token, and generate an output. In some embodiments, the device may be an edge device. In some embodiments, the hidden state may be stored in on-chip volatile memory and may occupy a fixed memory footprint.

Some embodiments include a system for accelerating inference comprising one or more processors and a memory storing instructions that cause the processors to process context data to generate a hidden state, store the hidden state, receive a query, retrieve the hidden state, and continue inference using the hidden state as an initial state. In some embodiments, the hidden state may be stored as a tuple comprising a key and the hidden state. In some embodiments, the hidden state may be generated offline.

Some embodiments include a system for performing inference comprising one or more processors and a memory storing instructions that cause the processors to retrieve multiple hidden states, determine relevance scores, combine the hidden states to generate a fused hidden state, and perform inference using the fused hidden state. In some embodiments, combining may include computing a weighted sum.

Some embodiments include a system for modifying an inference comprising one or more processors and a memory storing instructions that cause the processors to maintain a hidden state, receive a modification indication, compute a prior hidden state by reversing update operations, and continue inference based on the prior hidden state. In some embodiments, reversing may include applying an inverse recurrence.

Some embodiments include a system for storing and retrieving intermediate state data comprising one or more processors and a memory storing instructions that cause the processors to generate a hidden state, generate a key, store a tuple comprising the key and the hidden state, receive a query, match the query to the key, and retrieve the hidden state.

Some embodiments include a system for executing a neural network model comprising a processing system, a non-volatile memory storing weights, and an interface coupling the non-volatile memory to the processing system. The processing system may stream weights for a first portion, perform a computation for the first portion, stream weights for a second portion at least partly during the first computation, and perform a computation for the second portion.

Some embodiments include a system for generating a response to a query comprising one or more processors and a memory storing instructions that cause the processors to receive the query, generate a query representation, retrieve a hidden state, initialize a model using the hidden state, and generate the response.

Some embodiments include a system for performing inference comprising a processing system and a memory storing weights for layers. The processing system may stream weights for a layer, process the layer, discard the weights, and repeat for subsequent layers.

Some embodiments include a system comprising a memory storing weights for a plurality of machine learning models and one or more processors configured to perform inference using a first model, switch to a second model without loading weights into DRAM, and perform inference using the second model.

Some embodiments include a non-transitory processor-readable storage medium storing instructions that cause a processing system to store model weights in non-volatile memory, stream the weights over a serial interface without loading into DRAM, perform multiply-accumulate operations, and store intermediate state data in on-chip volatile memory. In some embodiments, streaming may include sequentially accessing address ranges corresponding to layers. In some embodiments, streaming and multiply-accumulate operations may be performed concurrently. In some embodiments, the instructions may cause selectively writing intermediate state data to non-volatile memory and distributing write operations across memory blocks.

Some embodiments include a non-transitory processor-readable storage medium storing instructions that cause a processing system to process input tokens using a neural network model, maintain a hidden state with fixed dimensionality independent of sequence length, update the hidden state for each token, and generate an output. In some embodiments, the hidden state may be stored in on-chip volatile memory.

Some embodiments include a non-transitory processor-readable storage medium storing instructions that cause a processing system to process context data to generate a hidden state, store the hidden state, receive a query, retrieve the hidden state, and continue inference using the hidden state as an initial state. In some embodiments, the hidden state may be stored as a tuple comprising a key and the hidden state.

Some embodiments include a non-transitory processor-readable storage medium storing instructions that cause a processing system to retrieve multiple hidden states, determine relevance scores, combine the hidden states to generate a fused hidden state, and generate an inference based on the fused hidden state.

Some embodiments include a non-transitory processor-readable storage medium storing instructions that cause a processing system to maintain a hidden state, receive a modification indication, compute a prior hidden state by reversing update operations, and generate an inference based on the prior hidden state.

Some embodiments include a non-transitory processor-readable storage medium storing instructions that cause a processing system to generate a hidden state, generate a key, store a tuple comprising the key and the hidden state, receive a query, match the query to the key, and retrieve the hidden state.

Some embodiments include a non-transitory processor-readable storage medium storing instructions that cause a processing system to stream weights for a first portion of a neural network model, perform a computation for the first portion, stream weights for a second portion at least partly during the first computation, and perform a computation for the second portion.

Some embodiments include a non-transitory processor-readable storage medium storing instructions that cause a processing system to receive a query, generate a query representation, retrieve a hidden state, initialize a model using the hidden state, and generate a response.

Some embodiments include a non-transitory processor-readable storage medium storing instructions that cause a processing system to stream weights for a layer, process the layer, discard the weights, and repeat for subsequent layers.

Some embodiments include a non-transitory processor-readable storage medium storing instructions that cause a processing system to store weights for a plurality of machine learning models, perform inference using a first model, switch to a second model without loading weights into DRAM, and perform inference using the second model.

### BRIEF DESCRIPTION OF THE DRAWINGS

FIG. 1 is a component diagram of an on-chip system (SOC) suitable for implementing some embodiments.

FIG. 2 is a component block diagram illustrating example components in a system configured to apply input to an LXM in the retrieval-augmented generation (RAG) mode.

FIG. 3A is a component block diagram illustrating example components in a system configured to pre-compute and store hidden states for reuse in accordance with some embodiments.

FIG. 3B is a block diagram illustrating an example of query processing in real time using a state-space model (SSM) architecture in accordance with some embodiments.

FIG. 3C is a block diagram illustrating an example of a system configured to generate an answer in real time in accordance with some embodiments.

FIG. 3D is a process flow diagram illustrating a method of offline precog record creation and single-source query-time reuse on a SSM in accordance with some embodiments.

FIG. 3E is a process flow diagram illustrating a method of tuple-centric storage and retrieval for reuse on a SSM in accordance with some embodiments.

FIG. 4 is a process flow diagram illustrating an example flow/method in an RAG system for edge devices in accordance with some embodiments.

FIG. 5A is a process flow diagram illustrating an example precognition method for edge devices in accordance with some embodiments.

FIG. 5B is a process flow diagram illustrating a method for performing inference with a neural network model using non-volatile memory in accordance with some embodiments.

FIG. 6A is a process flow diagram that illustrates a method of executing an LXM on an edge device in accordance with some embodiments.

FIG. 6B is a process flow diagram illustrating a method of processing a sequence of input tokens using a recurrent computational model in accordance with some embodiments.

FIG. 6C is a process flow diagram illustrating a method for accelerating inference of a neural network model in accordance with some embodiments.

FIG. 7 is a component block diagram illustrating an example edge computing device in the form of a headset that is suitable for implementing some embodiments.

FIG. 8 is a component block diagram illustrating an example edge computing device in the form of a laptop that is suitable for implementing some embodiments.

FIG. 9 is a component diagram of a server suitable for implementing some embodiments.

FIG. 10 is a block diagram illustrating a system configured for direct-from-non-volatile-memory neural network model inference without dynamic random-access memory in accordance with some embodiments.

FIG. 11A is a block diagram illustrating a conventional transformer neural network model architecture in accordance with some embodiments.

FIG. 11B is a block diagram illustrating an optional-DRAM SSM neural network architecture configured for direct-from-non-volatile-memory inference without dynamic random-access memory in accordance with some embodiments.

FIG. 11C is a block diagram illustrating a conventional transformer neural network model architecture that uses dynamic random-access memory in accordance with some embodiments.

FIG. 11D is a block diagram illustrating a system configured for direct-from-non-volatile-memory neural network model inference in accordance with some embodiments.

FIG. 12 is a sequence diagram illustrating parallel pipelined execution of non-volatile memory read and compute operations across multiple layers in accordance with some embodiments.

FIG. 13 is a system diagram integrated with a process flow diagram illustrating a pre-computed hidden state architecture integrated with a vector database and used for retrieval-augmented generation in accordance with some embodiments.

FIG. 14 is a process flow diagram illustrating an example method for generating a response to a query by reusing precomputed hidden states of a SSM in accordance with some embodiments.

FIG. 15 is a process flow diagram illustrating an example method for performing neural network inference by streaming model weights directly from non-volatile memory to a compute engine without using DRAM.

FIG. 16 is a process flow diagram illustrating an example method for performing neural network inference using a state-space model with a fixed-size hidden state that represents prior inputs.

FIG. 17 is a process flow diagram illustrating an example method for generating and storing reusable hidden-state representations of context data in a vector database.

FIG. 18 is a process flow diagram illustrating an example method for generating a response to a query by retrieving and reusing a stored hidden state without reprocessing prior context.

FIG. 19 is a process flow diagram illustrating an example method for generating a response using a fused hidden state derived from multiple stored hidden states.

FIG. 20 is a process flow diagram illustrating an example method for updating inference after input modification by reverting to a prior hidden state without replaying unchanged. input.

### DETAILED DESCRIPTION

The various embodiments may be described in detail with reference to the accompanying drawings. Wherever possible, the same reference numbers may be used throughout the drawings to refer to the same or similar parts. References made to particular examples and implementations are for illustrative purposes and are not intended to limit the scope of the invention or the claims.

The word “exemplary” may be used herein to mean “serving as an example, instance, or illustration.” Any implementation described herein as “exemplary” is not necessarily to be construed as preferred or advantageous over other implementations.

In overview, the embodiments include methods, and computing devices and processing systems configured to implement the methods of performing neural network model inference directly from non-volatile memory such as flash memory without dynamic random access memory or optionally not loading information into dynamic random access memory. In these embodiments, the processing system stores model parameters persistently in non-volatile memory, reads parameters from non-volatile memory during inference operations without loading them into DRAM, and generates tokens by applying multiply-accumulate operations to retrieved parameters. The processing system may temporarily store intermediate computational states in an on-chip volatile memory such as static random access memory. In some embodiment, the processing system may selectively write these states back to non-volatile memory. In some embodiments, write operations to the non-volatile memory may be distributed across multiple memory blocks independent of storage capacity constraints, such that endurance of the non-volatile memory is managed during normal operation. In addition, the processing system may manage non-volatile memory endurance through distributed write operations among multiple memory blocks and may use serial interfaces for efficient data transfers, thus may support reduced power consumption, simplified memory architecture, and/or extended operational lifetime. Further details regarding such embodiments are disclosed and described below.

The term “computing device” may be used herein to refer to devices that include memory and programmable processors capable of executing machine learning algorithms or other computational tasks to provide the functionality described herein. Examples of computing devices include server computing devices, personal computing devices, desktop computers, laptops, tablets, smartphones, wearable devices (e.g., smartwatches), Internet of Things (IoT) devices (e.g., smart speakers, smart thermostats, smart home hubs, smart displays), connected vehicles, autonomous vehicles, drones, and audio devices (e.g., smart speakers).

The term “processing system” may be used herein to refer to hardware that includes one or more processors, memory, interconnect, and input-output resources that perform operations described herein. A processing system may execute processor-executable instructions or may control a state machine that performs the operations. The state machine may be implemented as microcode, firmware, programmable logic, or logic circuitry. The processing system may reside within a system-on-chip (SoC) or a system-in-a-package (SiP). A non-transitory processor-readable storage medium may store data and configurations that control the state machine or cause a processor in the processing system to perform method operations described herein.

The term “compute engine” may refer to any hardware component or combination of hardware components configured to perform computational operations associated with inference of a neural network model, including operations on model weights and intermediate state data. The compute engine may be a component of the processing system and may be configured to perform computational operations, while the processing system coordinates data movement, memory access, and execution of the neural network model. The compute engine may include one or more processing elements configured to perform arithmetic operations, including multiply-accumulate operations, vector operations, matrix operations, or other numerical computations. In some embodiments, the compute engine comprises a neural processing unit (NPU), graphics processing unit (GPU), tensor processing unit (TPU), digital signal processor (DSP), central processing unit (CPU), application-specific integrated circuit (ASIC), field-programmable gate array (FPGA), or any combination thereof. The compute engine may further include specialized hardware configured to process neural network layers, including recurrent layers, convolutional layers, attention mechanisms, or state-space model (SSM) operations. In some embodiments, the compute engine is configured to operate on streamed model weights received from a non-volatile memory and to generate outputs and intermediate state data based on the streamed model weights. In certain embodiments, the compute engine operates concurrently with a controller to process model weights as the model weights are streamed over a serial interface, such that computation overlaps with data transfer. The compute engine may be coupled to or integrated with on-chip volatile memory configured to store intermediate state data, including hidden states. The compute engine may be implemented as a standalone integrated circuit, as part of a system-on-chip (SoC), or as part of a multi-chip module or system-in-package (SiP) in which the compute engine is co-packaged with a non-volatile memory.

In some embodiments, a processing system may be operatively coupled to a non-transitory non-volatile processor-readable memory for certain operations and coupled to a volatile memory for certain other operations. The processing system may conduct these operations in tandem and/or in parallel. For example, the processing system may read model parameters from non-volatile memory while simultaneously maintaining intermediate computational states in volatile memory. The processing system may coordinate data transfers between the non-volatile memory and the volatile memory to support inference operations, precomputation of hidden states, or query-time retrieval and generation.

The term “state machine” may be used herein to refer to a computer-implemented configuration executed by a processor or embodied in logic circuitry that defines a set of states and transitions between the states. In some embodiments, a state machine may be implemented as microcode, firmware, programmable logic, or software that operates on a processor. A non-transitory processor-readable storage medium may store data and configurations that control a state machine or cause a processor to perform method operations described herein.

The term “system-on-chip” (SoC) may be used herein to refer to a single integrated circuit (IC) chip that includes multiple resources or processors on a single substrate. A single SoC may include digital, analog, mixed-signal, and radio-frequency circuitry. A single SoC may include at least one processor of a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, a SoC may include an application processor that operates as the SoC's main processor, central processing unit (CPU), microprocessor unit (MPU), etc.). Each such processor may include one or more arithmetic logic units (ALUs). An SoC processing system may include software for controlling integrated resources and processors as well as for controlling peripheral devices. In some embodiments, an SoC may include a neural processing unit (NPU), a digital signal processor (DSP), or a graphics processing unit (GPU) for on-device execution of a state-space model (SSM). In some embodiments, the SoC may pair with flash storage or other non-volatile storage accessed through a serial interface such as MIPI M-Phy or UFS and may store model weights and compact hidden states without dynamic random-access memory. In some embodiments, the SoC may include on-chip volatile memory. In some embodiments, a processing system may read model weights directly from non-volatile memory, such as flash storage, through serial interfaces without loading the model weights into DRAM, and may use on-chip volatile memory, such as static random-access memory (SRAM), for intermediate computational states during inference operations of an ML model. In some embodiments, the SoC may support precomputation and query-time operations described herein while omitting DRAM controllers to reduce power consumption and system footprint.

The term “system-in-a-package” (SiP) as used herein may refer to a single module or package that contains multiple resources, computational units, cores, or processors on two or more IC chips, substrates, or SoCs. For example, a SiP may include a single substrate on which multiple IC chips or semiconductor dies are stacked vertically. Similarly, the SiP may include one or more multi-chip modules (MCMs) on which multiple ICs or semiconductor dies are packaged into a unifying substrate. A SiP may also include multiple independent SoCs coupled together via high-speed communication circuitry and packaged in close proximity, such as on a single motherboard, in a single user equipment (UE), or a single CPU device. The proximity of the SoCs may support high-speed communications and the sharing of memory and resources. In some embodiments, a SiP may support on-device execution of an SSM, storage of compact hidden states in standard-performance memory, and precomputation and query-time operations for retrieval-augmented generation (RAG) on an edge device.

The term “edge device” as used herein may refer to a computing device configured to perform data processing at or near a source of data generation, rather than relying primarily on remote or cloud-based systems. Examples of edge devices may include, but are not limited to, smartphones, smart sensors, smart cameras, smart thermostats, smart appliance regulating systems, smart self-driving systems, smart speakers, Internet of things (IoT) systems, personal computers, and appliances, which have become increasingly powerful and complex and may incorporate system-on-chips (SoCs), multiple microprocessor cores, microprocessor units (MPUs), central processing units (CPUs), digital signal processors (DSPs), graphics processing units (GPUs), neural processing units (NPUs), artificial intelligence (AI) processors, and other specialized hardware components. The edge device may include a processing system having one or more processors, a compute engine, on-chip volatile memory, and non-volatile memory, and may be configured to execute machine learning or neural network models using locally stored model weights and locally maintained intermediate state data. In some embodiments, the edge device may operate under resource constraints relative to cloud systems and may be configured to perform inference with reduced latency, bandwidth usage, and power consumption, including, in certain implementations, performing inference using model weights stored in non-volatile memory without loading the model weights into dynamic random-access memory (DRAM).

The terms “machine learning algorithm” and “artificial intelligence model” and similar terms may be used interchangeably herein to refer to a variety of computational models or information structures that may be used by a computing device to perform tasks, computations, or evaluations. Examples of machine learning algorithms include neural network models, inference models, classifiers, random forest models, spiking neural network (SNN) models, convolutional neural network (CNN) models, recurrent neural network (RNN) models, state-space models (SSMs), deep neural network (DNN) models, generative adversarial networks (GANs), ensemble networks, and genetic algorithm models. In some embodiments, a machine learning algorithm may include an architectural definition, weight values, and one or more hidden-state representations that support precomputation and reuse during query-time operations.

The term “neural network” may be used herein to refer to an interconnected group of processing nodes that collectively operate as a software application or process that controls a function of a computing device and/or generates an overall inference result as output. Individual nodes in a neural network may emulate biological neurons by receiving input data, performing simple operations on the input data to generate output data, and passing the output data (also called “activation”) to the next node in the network. Each node may be associated with a weight value that defines the relationship between input data and output data. A neural network may learn to perform new tasks over time by adjusting these weight values. In some cases, the overall structure of the neural network and/or the operations of the processing nodes remain unchanged as the neural network learns a task. Rather, learning is accomplished during a training process in which the values of the weights in each layer are determined. As an example, the training process may include causing the neural network to process a task for which an expected output is known, comparing the activations generated by the neural network to the expected output, and determining the values of the weights in each layer based on the comparison. After the training process is complete, the neural network may perform inference to process a new task with the determined weights.

The term “inference” may be used herein to refer to a process that is performed at runtime or during the execution of the software application program corresponding to the machine learning algorithm. Inference may include traversing the processing nodes in a network (e.g., neural network, etc.) along a forward path to produce one or more values as an overall activation or inference result. In some embodiments, inference may include initializing a model with a stored hidden state, processing query tokens as part of query-time operations, and generating output based on the updated hidden state. In some embodiments, inference may include resuming a model previously initialized with a stored hidden state, processing query tokens as part of query-time operations, and generating output based on the updated hidden state.

The term “deep neural network” may be used herein to refer to a neural network that implements a layered architecture in which the output of a first layer of nodes becomes an input to a second layer of nodes, the output of a second layer becomes an input to a third layer, and so on. As such, computations in a deep neural network may be distributed over a population of processing nodes that make up a computational chain. Deep neural networks may also include activation functions and sub-functions between the layers. The first layer of nodes of a multilayered or deep neural network may be referred to as an input layer. The final layer of nodes may be referred to as an output layer. The layers in between the input and final layers may be referred to as intermediate layers.

The term “recurrent neural network” (RNN) may be used herein to refer to a class of neural networks suited for sequence data processing. Unlike feedforward neural networks, an RNN may include cycles or loops within the network that allow information to persist. This may allow an RNN to maintain a memory of previous inputs in the sequence, which may be beneficial for tasks in which temporal dynamics and the context in which data appears may be relevant. In some embodiments, an RNN may expose a hidden state that a processing system may reuse or initialize to support on-device query-time operations.

The term “transformer” may be used herein to refer to a neural network that includes an encoder or a decoder and is suited for sequence data processing. Transformers may use multiple self-attention components to process input data in parallel. The self-attention components may weigh different parts of an input sequence when producing an output sequence and may compute a weighted sum of positions in the input sequence for each position. The model may consider other parts of the sequence when encoding each element. This may benefit tasks that use contextual relationships between elements in a sequence, such as sentence completion, translation, and summarization. Training may determine the weights. Transformers often serve as foundational elements in constructing conventional large generative AI models (LXMs).

The term “large generative AI model” (LXM) may be used herein to refer to an advanced computational framework that includes specialized AI models such as large language models (LLMs), large speech models (LSMs), large vision models (LVMs), vision-language models (VLMs), hybrid models, and multimodal models. An LXM may include multiple layers of neural networks such as recurrent neural networks, transformer networks, or state-space models (SSMs) including variants such as Temporal Event-Based Neural Networks (TENNs). An LXM may include millions or billions of parameters. LXMs support dialogic interactions and encapsulate knowledge in an internal structure. LXMs may provide direct answers and may perform tasks such as text summarization, translation, complex question answering, and conversational interaction. LXMs may operate as standalone units or may be integrated into other systems, such as a SoC or a SiP, and may interface with hardware accelerators to improve latency and throughput. In some embodiments, an LXM may include an adaptive algorithm that improves context handling or evaluation of weights between nodes in a feature graph. In some embodiments, a processing system may perform the adaptive algorithm or may distribute it across multiple processing systems. In some embodiments, an LXM that implements a state-space model may maintain a fixed-length hidden state to support precomputation, storage, and reuse on an edge device.

For ease of reference and to focus the discussion on the most relevant features, some of the embodiments below are discussed with reference to an LLM. However, it should be understood that the embodiments may be applicable to any LXM. As such, nothing in this application should be used to limit the claims to LLMs unless expressly recited as such in the claims.

The term “relevance model” may be used herein to refer to a trained computational unit executed by a processing system that evaluates the pertinence of candidate data with respect to a query. A relevance model may assign numeric scores to data chunks stored in memory. A processing system may use the scores to select documents, chunks, or stored hidden states during retrieval-augmented generation (RAG) or other query-time operations. The relevance model may be implemented as a neural network, a classifier, or another trained function deployed on edge hardware or server systems.

The term “feature space” may be used herein to refer to a multi-dimensional space or information structure in which each dimension represents a specific feature or attribute of the data being analyzed. Each data point (e.g., object, event, observation, etc.) may be represented as a vector in this multi-dimensional space/structure. The dimensions of the feature space may correspond to the features of the dataset, which may include various properties or characteristics of the data points. For example, in a dataset of images, features might include color histograms, texture, shape descriptors, etc.

The term “high-dimensional vector” may be used herein to refer to numerical representations of data points in a space with many dimensions in which each dimension captures a distinct attribute or feature of the data. High-dimensional vectors may be used to represent complex data, computer-implemented data structure stored in memory that encodes attributes of features such as tokens in natural language processing or image features in computer vision or other data elements including learned features. Each vector component or dimension of a vector may correspond to a value that represents a specific characteristic or feature of the original data or a learned feature, and the high dimensionality allows for detailed encoding of relationships and patterns within the data. For example, a token may be represented as a high-dimensional vector in which different dimensions capture aspects such as syntactic structure, semantic meaning, or contextual relevance. A processing system may generate, store, and manipulate high-dimensional vectors in memory as part of operations such as similarity comparison, retrieval, or hidden-state initialization. In some embodiments, high-dimensional vectors may be stored in volatile or non-volatile memory as multidimensional arrays or tensors accessible to processors within a SoC or a SiP.

The term “embedding layer” may be used herein to refer to a neural network layer executed by a processing system that maps tokens into continuous vector representations. The embedding layer may be a specialized layer within a neural network, typically at the input stage, which transforms continuous or discrete categorical values or tokens into feature spaces or continuous, high-dimensional vectors, or vectors of fixes dimension. An embedding layer may also transform high-dimensional data into low-dimensional vectors (e.g., using “dimensionality reduction” techniques, etc.), which may be particularly useful when the original data is complex or too large to handle efficiently. In some embodiments, the embedding layer may convert tokens (typically low-dimensional entities) into high-dimensional vectors or feature spaces. An embedding layer may operate as a lookup table in which each unique token or category is mapped to a point in a continuous vector space. An embedding layer may update the vectors during training so that the vectors capture semantic or structural attributes. The vectors may be refined during the model's training phase to encapsulate the characteristics or attributes of the tokens in a manner that is conducive to the tasks the model is configured to perform.

The term “token” may be used herein to refer to a computer-readable data element that represents a unit of input that an LXM may read as a single input during training and inference. In text-centric models, a token may represent a paragraph, a sentence, a clause, a word, a subword, or a character. In auditory models, a token may represent a phoneme, a spectrogram frame, a temporal dependency, or a Mel-frequency cepstral-coefficient vector that represents small segments of an audio waveform. In visual models, a token may represent a portion of an image (e.g., pixel blocks) or a sequence of video frames. In multimodal systems, a token may be a complex data structure that encapsulates information from various sources. For example, a token may include both textual and visual information, where each modality independently contributes to the token's overall representation in the model. A processing system may store tokens in memory. A processing system may convert tokens into vectors using an embedding layer. A processing system may process tokens through layers of a neural network.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 300 dimensions, etc.) in which each dimension in the vector captures a unique attribute, quality, or characteristic of the token. For example, dimension one (1) of the numerical vector may encode the frequency of a word's occurrence in a corpus of data, dimension two (2) may represent the pitch or intensity of the sound of the word at its utterance, and dimension three (3) may represent the sentiment value of the word. The numerical vectors may use a fixed dimension such as 512, 768, or 2048. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, RNNs, or long short-term memory networks (LSTMs). In some embodiments, an SSM may update a fixed-length hidden state as the system processes tokens and may reuse the hidden state during query-time operations on an edge device.

The term “sequence data processing” may be used herein to refer to techniques or technologies for handling ordered sets of tokens in a manner that preserves their original sequential relationships and captures dependencies between various elements within the sequence. The resulting output may be a probabilistic distribution or a set of probability values, each corresponding to a “possible succeeding token” in the existing sequence. For example, in text completion tasks, the LXM may suggest the possible succeeding token determined to have the highest probability of completing the text sequence. For text generation tasks, the LXM may choose the token with the highest determined probability value to augment the existing sequence, which may subsequently be fed back into the model for further text production. Sequence data processing may include generating a probability distribution over candidate next tokens, selecting or sampling from that distribution, and appending a token to extend the sequence.

The term “state-space model” (SSM) may be used herein to refer to a type of computational model particularly well-suited for handling sequence data by maintaining a compact hidden state that evolves over time based on the input data. SSMs process input data serially, updating the hidden state at each step, where the hidden state captures all prior information without increasing in size as more data is processed. SSMs may be distinct from traditional recurrent neural networks (RNNs) because, for example, they offer more efficient memory usage and are more suitable for use on resource-constrained devices such as edge devices. In some embodiments, SSMs may be integrated with machine learning algorithms or LXMs for more efficient processing of large datasets, including natural language inputs, while reducing resource usage requirements. SSMs may be particularly beneficial in systems that benefit from real-time sequence processing, including retrieval-augmented generation (RAG) systems and other advanced AI-driven applications that could be implemented and used on edge devices.

The term “serial interface” may be used herein to refer to any interface configured to transfer model weights in a sequential manner from a non-volatile memory to a compute engine, including but not limited to high-speed serial communication interfaces, point-to-point links, or packet-based transfer mechanisms. In some embodiments, the serial interface may comprise one or more of: a MIPI M-PHY interface, a UFS interface, a PCIe interface, or any equivalent high-speed serial communication interface. The serial interface may be configured to enable streaming of model weights concurrently with execution of multiply-accumulate operations by the compute engine

For ease of reference, some of the embodiments below are discussed with reference to an SSM. However, it should be understood that the embodiments may be applicable to any recurrent computational model. As such, nothing in this application should be used to limit the claims to SSMs unless expressly recited as such in the claims.

The term “hidden state” may be used herein to refer to an internal representation maintained by a computational model (e.g., SSM, etc.) during the processing of input data. A hidden state may encapsulate the computational model's memory of previously processed information and may evolve as new data is processed. In some embodiments, the hidden state may be represented as a fixed-length vector that is updated sequentially as additional input is processed to allow the computational model to retain relevant information about past inputs without increasing the size of the representation. In some embodiments, the hidden state may capture and store information about an input sequence, such as to allow for context-aware processing in tasks such as inference or RAG. In some embodiments, the hidden state may serve as a compact summary of the processed data that may be used to continue processing new data, generate responses, or retrieve relevant information without the need to reprocess previous inputs.

The term “retrieval augmented generation” (RAG) may be used herein to refer to a technique that combines the retrieval of relevant data from a database with the generative capability of an LXM. In response to a query, the system may retrieve relevant context using a vector database or another knowledge base and provide the retrieved context to the model. The retrieved information may be used as additional input or context information for the LXM to produce more accurate and contextually relevant outputs. In some embodiments, RAG may integrate with an SSM by retrieving one or more stored hidden states that correspond to relevant data chunks and by initializing the model with the retrieved hidden state or a fused hidden state. This solution may reduce memory access, computation, and latency during query processing on an edge device. Such systems may provide access to a large corpus of pre-stored data while reducing the need for the LXM to process the full dataset in real time.

The term “data chunk” may be used herein to refer to a subset of a dataset that a computing system may process individually. A data chunk may include discrete units of text, audio, or image data. The system may tokenize a data chunk and may convert tokens into high-dimensional vectors during processing by a model. The size and format of a data chunk may vary by application, such as sentences or paragraphs for text or image sections for vision. The system may process, store, and retrieve data chunks independently or in combination to generate results during inference, retrieval-augmented generation, or sequence data processing. In some embodiments, the system may store one stored hidden state per data chunk and may associate that stored hidden state with a key for retrieval. In some embodiments, the system may organize and select data chunks to improve memory use and computational efficiency while maintaining compact hidden states as new data chunks are processed. Data chunks may allow for efficient handling of large datasets, particularly on edge devices with limited memory and processing power, by enabling incremental processing and compact storage of representations such as hidden states or feature vectors.

The term “document chunk” may be used herein to refer to a data chunk that originates from a document or a corpus and that the system treats as a unit for retrieval and precomputation. A document chunk may correspond to a sentence or a paragraph or a section or a table caption or a figure caption. A document chunk may include a document identifier and a chunk identifier and a position index. The system may tokenize a document chunk and may form a stored hidden state that summarizes tokens of the document chunk and may link that stored hidden state to a key for retrieval. The system may bound a document chunk by a token budget for offline precomputation. The system may persist a tuple that includes the key and the stored hidden state for each document chunk in a vector database and may retrieve one tuple for reuse during query-time operations.

The term “query-time operations” may be used herein to refer to runtime operations that use one stored hidden state or multiple stored hidden states. Example query-time operations may proceed as follows. The system may receive a query as a sequence of tokens and may compute a key that serves as a retrieval index for locating a stored hidden state. The system may search a vector database and may retrieve one stored hidden state or multiple stored hidden states that match the key. The system may compute a combined hidden state when selecting multiple sources and may initialize the SSM with either a stored hidden state or the combined hidden state. The system may process the query tokens, update an intermediate hidden state, generate output tokens that form a response, and present the response through a display or an audio interface. In some embodiments, query-time operations may include a rollback that returns the hidden state to reflect a user edit without reprocessing earlier tokens.

The term “multiply-accumulate operations” (MAC operations) may be used herein to refer to computational operations in which a first value and a second value may be multiplied together and the result may be added to an accumulated value. Such operations may be performed repeatedly over sequences of data, such as vectors or matrices, to generate outputs of a neural network or other computational model. In some embodiments, multiply-accumulate operations may be executed by a processing system in a compute engine, such as a central processing unit (CPU), graphics processing unit (GPU), digital signal processor (DSP), neural processing unit (NPU), or other hardware accelerator, and may be used to apply model weights to input data during inference or training of a machine learning model.

The term “key” may be used herein to refer to a retrieval index vector for locating a stored hidden state. A key may take the form of a sentence embedding or another vector representation. In some embodiments, a key may match a key associated with a stored [key, hidden_state] tuple in a vector database. In some embodiments, a processing system may use the key with one scoring method or multiple scoring methods to select one stored hidden state or multiple stored hidden states for initialization or fusion.

The term “rollback” may be used herein to refer to an operation that returns the SSM hidden state to a prior point in a sequence without full re-computation. A user interface may capture text entry events and deletion events during query composition. The processing system may update the hidden state as the user adds input tokens and may revert the hidden state after a deletion event.

The various embodiments include methods (and computing devices, processing systems, and components configured to implement methods) for configuring, deploying, and operating LLMs or other LXMs on edge devices. The embodiments address technical challenges associated with running LLMs on edge devices. The embodiments reduce compute demand, memory bandwidth demand, and reliance on high-speed memory.

Conventional solutions for running neural network models, especially those based on transformer architectures, require substantial computational power and memory bandwidth. Edge devices typically have more limited resources compared to cloud-based systems and often cannot support these models efficiently. Conventional solutions typically involve dynamic random-access memory (DRAM), whether high-bandwidth memory (HBM) or standard-performance options such as DDR4 SDRAM or DDR5 SDRAM, which increases power consumption and system footprint. Conventional solutions that compress models, improve inference processes, or add hardware accelerators still rely on DRAM and substantial computational resources, which renders them unsuitable for deployment on edge devices.

In contrast, the embodiments described herein render involvement of DRAM optional and can eliminate reliance on DRAM entirely by reading model weights directly from non-volatile storage, like flash storage, through serial interfaces and using only on-chip static random-access memory (e.g., SRAM) for intermediate computational states.

In some embodiments, the processing system may be configured to overcome these limitations of conventional solutions of involving DRAM by using computational models implemented through neural networks (e.g., recurrent neural networks), such as State Space Machines (SSMs), that handle neural network models more efficiently on resource-constrained devices. An SSM maintains a compact hidden state represented as a fixed-length vector whose dimensionality is defined by the model and does not increase with context length. The hidden state captures all tokens received up to a specific point in the input context and remains the same size as the input token embeddings, regardless of the length of the input context. This property may reduce memory consumption and support the use of SSMs in edge devices.

Additionally, in some implementations, SSMs may call for a tailored compute infrastructure for inference compared to conventional systems, like those for transformer-based LLM, understanding that processing of each token during inference may invoke all the weights for the model to be used. For example, using a 1B model this results in 1B of memory to be read. The actual computational load and memory load may be approximately one MAC per weight, or for example, 10 tokens/sec which maps to approximately 10 GB/s memory reads but only 10 GOp/s compute. Thus, in some instances, the process can be constrained or tested by the heavy load on memory read, rather than the relatively light load on computation.

In some embodiments, the processing system may precompute stored hidden states for input text that is likely to be reused, such as in RAG systems. In traditional Transformer-based LLMs, both the input context and the query are processed simultaneously, which may call for significant computational resources and bandwidth to handle long contexts. Precomputation of one or more hidden states representing information in the form of input context may allow the system to store the hidden states in compact form and reuse them during query-time operations without processing the same context multiple times. This may improve system efficiency by allowing for the reuse of previously computed hidden states. In real-time query processing, the system may load the stored hidden state corresponding to a known context and process the query from that point forward. This may eliminate the need to process the known context during runtime, thereby improving speed and responsiveness while reducing computational overhead.

In some embodiments, the processing system may improve memory efficiency by reducing memory access during LLM processing. Conventional solutions for large inputs often recompute activations and repeatedly access parameters for each token. By loading stored hidden states, the system may reduce memory bandwidth use and improve overall processing efficiency.

Conventional flows for large contextual inputs may result in response times that extend beyond practical real-time interaction. For example, some conventional solutions for processing large amounts of contextual information require long delays before generating responses. By precomputing stored hidden states and handling queries more efficiently in accordance with the embodiments, the processing system may reduce processing times by orders of magnitude. A user may receive a response in real time because only the query tokens are processed during runtime. This reduction in processing time may improve responsiveness and reduce power consumption on the device and open up new avenues or applications of real-time inference generation using neural network models (e.g., real-time speech enhancement, real-time speech/image processing, etc.).

In some embodiments, the processing system may store context information as a [key, hidden_state] tuple rather than as large groups of vectors. In some embodiments, the hidden state may store a compact representation of context. In some embodiments, this structure may reduce memory footprint, improve storage efficiency, and reduce bandwidth demand during database updates. In some embodiments, the processing system may be configured to support compressed and encrypted storage of information.

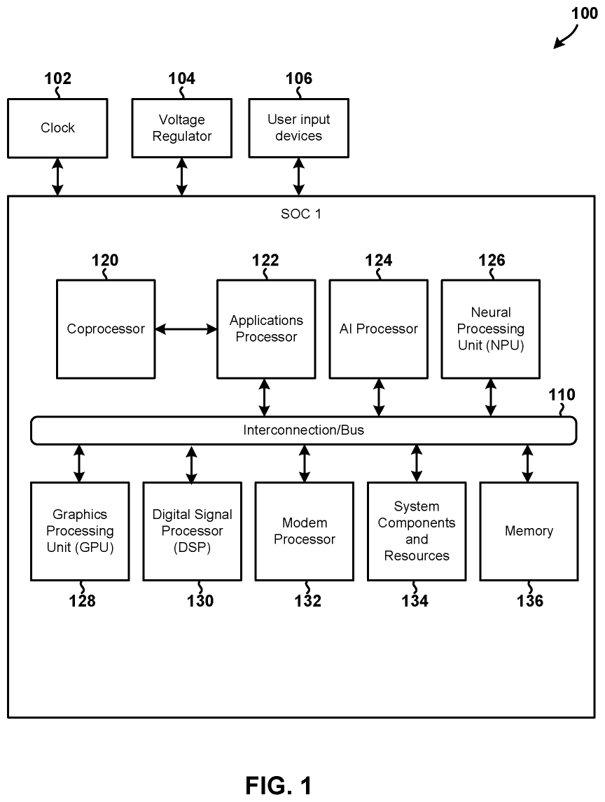

Various embodiments may be implemented in single-processor or multiprocessor computer systems, including a SoC or SiP. FIG. 1 illustrates an example computing system or SoC 100 architecture that may be included in devices implementing the various embodiments.

In the example illustrated in FIG. 1, the SoC 100 includes a clock 102, a voltage regulator 104, and user input devices 106 such as touch-sensitive displays, microphones, and cameras. The SoC 100 integrates processors that include a coprocessor 120, such as a vector coprocessor, an applications processor 122, an AI processor 124, and a neural processing unit (NPU) 126. Additional components include a graphics processing unit (GPU) 128, a digital signal processor (DSP) 130, a modem processor 132, memory 136, and system components and resources 134. The processors and components may connect through an interconnection or bus 110 that may use networks-on-chip (NoCs), reconfigurable logic arrays, or bus architectures such as CoreConnect or AMBA.

In some embodiments, selected processors in the SoC 100, such as the applications processor 122 or modem processor 132, may function as a central processing unit (CPU), a microprocessor unit (MPU), or an arithmetic logic unit (ALU). Each such processor may include one or more arithmetic logic units (ALUs). The SoC 100 may execute software programs and may perform arithmetic, logical, control, and input/output operations as specified by processor-executable instructions. One or more coprocessors 120 may assist the CPU during these operations.

Each processor 120-132 may include one or more cores, and each processor or core may perform operations independently of the others. For example, the SoC 100 may include one processor that executes a first operating system, such as FreeBSD or Linux, and another processor that executes a different operating system, such as OS X.

In some embodiments, processors 120-132 may operate in clusters. A cluster may include heterogeneous cores within a single SoC or distributed nodes spanning multiple SoCs. Each node may include an operating system, a CPU, memory, and storage. The system may divide a computational task among the nodes, and the system may combine partial results to produce a final result faster than on a single processor. Clusters may also offer fault tolerance and resilience to failure due to their distributed nature, as well as improved throughput by distributing tasks across multiple nodes.

The SoC 100 may include system components and resources for sensor data management, wireless transmission, analog-to-digital conversion, and specialized tasks such as AI inference or precomputation of stored hidden states for frequently used input text. These components may include power amplifiers, voltage regulators, oscillators, phase-locked loops, data controllers, memory controllers, and peripheral bridges. The system components may support communication with peripheral devices such as cameras, microphones, external displays, and wireless communication modules.

The SoC 100 may include an input/output module for interfacing with external resources, such as user input devices 106 and wireless transceivers, including Bluetooth or cellular transceivers. These external resources may be shared among processors or cores in the SoC 100.

In addition to the SoC 100, the embodiments may be implemented in other computing systems, including systems with single or multicore processors, multiple processors, or hybrid configurations that integrate different processing technologies.

Recurrent SSM may achieve efficient processing by maintaining compact hidden-state representations rather than storing activations that grow with sequence length.

In an SSM, the network maintains a hidden state that represents tokens processed up to the current time. The hidden state may have a fixed dimensionality that does not increase as the length of the input context grows. In some embodiments, the dimensionality of the hidden state may equal the token embedding dimensionality. In other embodiments, the dimensionality may be larger or smaller, depending on the model design.

An SSM may process an input context sequentially up to a defined point in the sequence. At that point, the model maintains a hidden state that encapsulates the information from the tokens already processed. The hidden state may serve as a fixed-length representation that preserves contextual dependencies without growth in size as additional tokens are processed. The processing system may reuse the stored hidden state as the starting condition for subsequent computations, including continuation of the sequence or processing of new query tokens. By reusing the hidden state in this manner, the system may avoid reprocessing tokens that have already contributed to the model's representation, reduce computational overhead, and improve runtime efficiency on edge devices. These operations may improve computer functionality by reducing memory use and processing demand while maintaining context awareness.

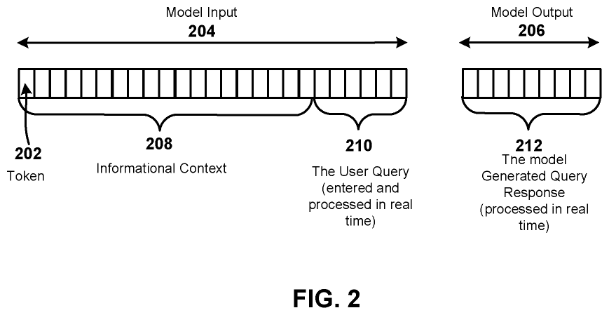

FIG. 2 illustrates a system configured to apply input to an ML model such as a neural network model in the RAG mode, according to some embodiments. FIG. 2 illustrates an input and output token sequence for a neural network model, an example of an LXM, with tokens 202 along a model input timeline 204 and a model output timeline 206. The model input timeline 204 includes an informational context segment 208 and a user query segment 210. The model output timeline 206 includes a query response segment 212.

The context input includes a block of selected information and a user query that relates to that information. New tokens are fed into the network serially, and a weighted representation of the input token is combined with the prior hidden state to update it to the new hidden state. The size of the hidden state does not grow with each new token. Importantly, saving the current hidden state is the same as saving a representation of all tokens processed up to the time of saving.

A processing system may ingest tokens 202 along the model input timeline 204. The system may maintain a hidden state that summarizes the informational context segment 208 and may continue updating the hidden state while processing the user query segment 210. The system may generate tokens on the model output timeline 206, assemble them into the query response segment 212, and present them as the generated answer.

In some embodiments, the system may initialize a recurrent network model implemented as an SSM with a stored hidden state obtained from a pre-computation of hidden states for reusable context data referred to herein as pre-computation or PreCog process. The stored hidden state may represent the informational context segment 208. The system may then process the user query segment 210 without reprocessing the informational context segment 208. These operations may reduce memory traffic, lower computational demand, and decrease latency during query-time operations on an edge device.

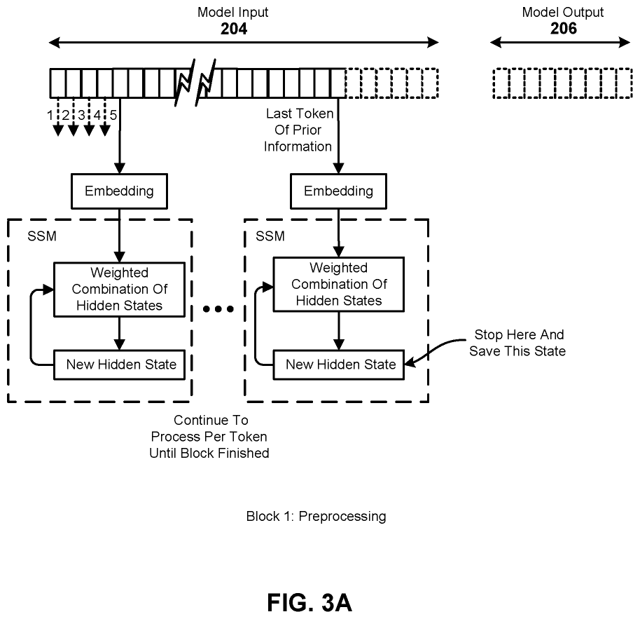

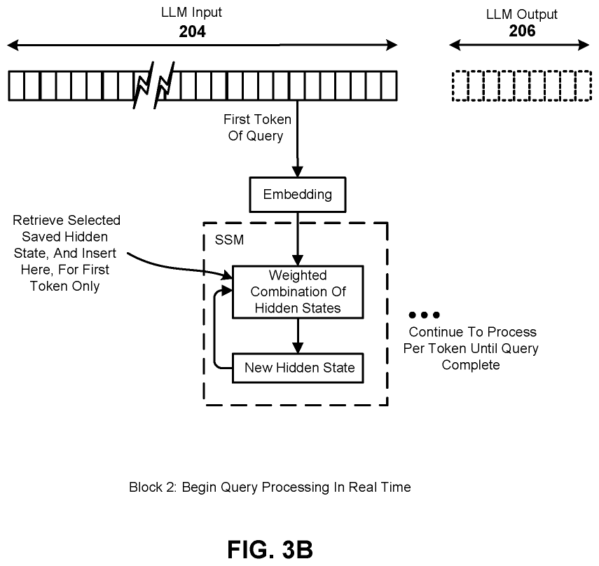

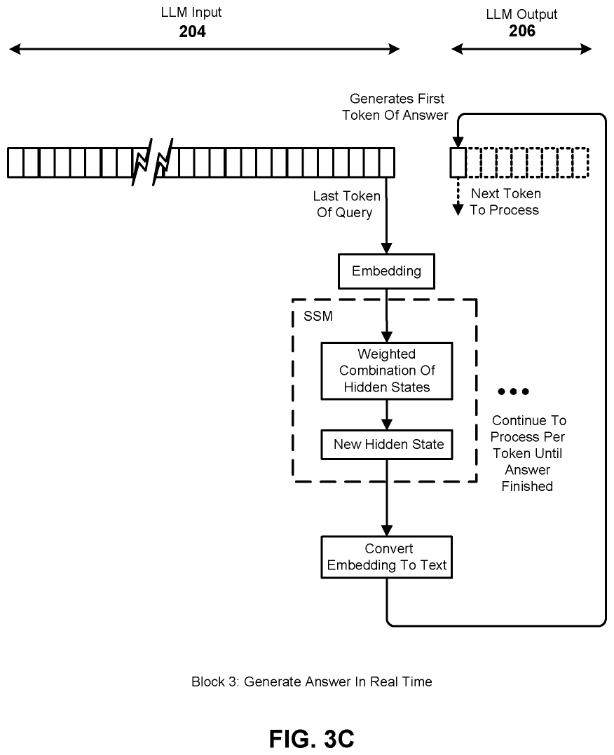

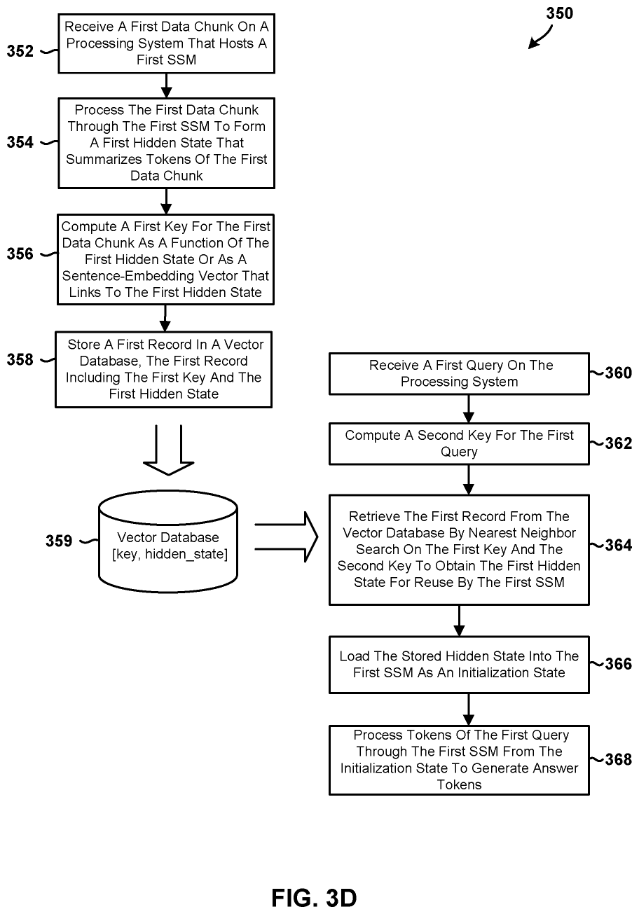

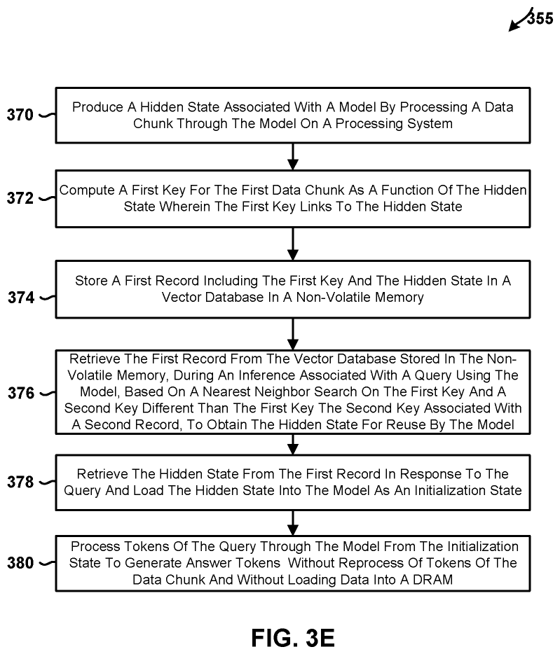

FIGS. 3A-3C illustrate a system that precomputes stored hidden states likely to be reused and stores compact representations. When a body of input exists, such as text blocks used in RAG, the system may precompute each block offline and save the corresponding stored hidden state.

The system may handle new and unknown tokens in real time by continuing from a stored hidden state. When a text block with a stored hidden state contributes to a new query, the system may load the hidden state of that block and continue processing the query from that state. This may avoid a second pass over the known text and may reduce memory access by processing the compact hidden state rather than a long token sequence.

Processing one token in a model like a large language model (LLM) may involve multiplication of an embedding vector by large parameter matrices. On edge devices with limited memory, the system may access those parameters multiple times per token, and repetition may strain memory bandwidth. By precomputing and saving stored hidden states for RAG text blocks, the system may compute each block through the model once. This precomputation may occur offline on another system, such as server GPUs. The system may store the resulting stored hidden states in compact form and may load the state corresponding to a selected RAG text block when needed. Because a RAG text block may exceed the user query in length, this solution may reduce computation and memory access, speed responses, and lower power consumption.

The system illustrated in FIGS. 3A-3C may improve user experience on resource-constrained devices. For example, a device that processes five words per second may require about two minutes to process 600 words of retrieved context for one question. With precomputation, the system may process the retrieved context in advance, allowing the user to wait only for the processing of the question and the generation of the answer. As an example, a 15-word question may take about three seconds. This may apply to spoken or typed input because model processing may outpace speech or typing. Processing speed appears adequate if answer generation proceeds faster than the user is able to read or listen.

In some embodiments, the processing system or edge device may use a Temporal Event-Based Neural Network (TENNs) model, which may have a particularly compact hidden state representation that may reduce processing power requirements and limit reliance on high-speed memory.

In some embodiments, a device may store information as a tuple that includes a key (e.g., retrieval index vector) and a stored hidden state. In some embodiments, the tuple may use non-text numeric representation and may omit source tokens. In some instances, the device may apply access control for the vector database. The device may apply optional encryption at rest such as AES-GCM with a hardware root of trust.

Some embodiments may apply to any LLM, as an example of an LXM, that processes context input tokens serially and benefits from precomputation of contextual information. SSMs may provide advantages, particularly the TENNs variant, an enhanced SSM. Such systems may include a compact internal state representation and may permit the processing system to store and manage data efficiently. TENNs may offer advantages for edge devices. The processing system may maintain a hidden state within a TENNs model that captures prior inputs. This hidden state may permit reuse of previously processed information without repeated resource-intensive operations and may yield faster and more efficient processing in resource-constrained environments.

Unlike other SSM variants and transformer architectures that maintain persistent states such as a key-value (KV) cache, a TENNs block has an internal state that takes the form of a one-dimensional vector with length equal to the model dimension. A Mamba hidden state may have shape (model_dim, coefficients), and a Mamba2 hidden state may have shape (heads, model_dim, coefficients). By contrast, a transformer block KV cache has shape (context length, model_dim). For SSMs such as TENNs and Mamba, the hidden-state dimensionality does not increase with context length, and the hidden state at any time represents the context processed up to that point. For transformers, the dimensionality of persistent states grows with context length and may be inefficient to maintain and update. It may be technically feasible for transformer-based models to perform precomputation via KV-caching. However, this may be prohibitively expensive due to the large sizes of the KV caches and may require considerable optimizations to make this procedure possible. For example, for a 2000-token context and 2048-dimensional embeddings at 32-bit precision, a TENNs hidden state may occupy about 8 KB, whereas a transformer KV cache for the same context may occupy about 16 MB for either the keys or values (and about 32 MB total when both are stored).

SSM networks are versatile and may take forms tailored for applications in audio, vision, and LLMs. An SSM may undergo training in a feedforward configuration and may later be converted to a recurrent configuration. To illustrate the advantages of SSMs generally, and TENNs specifically, over competing LLM architectures, a minimal TENNs network example may be described.

Below, we illustrate a typical SSM. In this model, the vector H̅ represents an internal hidden memory. The vector Ā, along with the vector H̅, combined with the element-wise operator “∘” advances the hidden state. The input vector U is transformed by the matrix B̅ which projects the input (an embedding vector in this case) into the hidden unit's space. Finally, the measurement matrix C̅ projects the hidden state to an output. This output, after passing through the nonlinearity F( ), forms the input to the next layer of the neural network.

$${\overline{H}}_{\{ i , t \}}^{\{ 2048 \times 1 \}} = {\overline{A}}_{i}^{\{ 2048 \times 1 \}} ∘ {\overline{H}}_{\{ i , t - 1 \}}^{\{ 2048 \times 1 \}} + {B}_{i}^{\{ 2048 \times 2048 \}} \cdot {U}_{\{ i , t - 1 \}}^{\{ 2048 \times 1 \}}$$

$${Y}_{i , t}^{2048 \times 1} = {\overline{C}}_{i}^{2048 \times 2048} \cdot {\overline{H}}_{i , t}^{2048 \times 1}$$

$${U}_{i + 1 , t}^{2048 \times 1} = F ( {Y}_{i , t}^{2048 \times 1} )$$

The depth of the network may be arbitrary. As the input progresses through the layers of the network, it effectively sets the state of the H̅ vector, encoding a memory of all the inputs U Note that H̅, Ā, and C̅ are complex numbers. While the specific functions of these matrices are beyond the scope of this disclosure, it is important to note that after a long sequence of inputs U, the matrix H̅, may have been transformed.

This formulation highlights the compactness of the hidden state and the efficient update rule characteristic of SSMs. The ability to advance the hidden state with fixed-dimension operations, regardless of sequence length, may allow TENNs to process long contexts on resource-constrained devices without the memory growth or repeated parameter loads that characterize transformer architectures.

The depth of the network may be arbitrary. As the input progresses through the layers of the network, it effectively sets the state of the H̅ vector to encode a memory of all the inputs U. The matrices H̅, Ā, and C̅ may include complex numbers/values. While the specific functions of these matrices are beyond the scope of this disclosure, it is important to note that after a long sequence of inputs U, the matrix H̅, may have been transformed.

In some embodiments, an SSM may be integrated into a RAG system tailored for edge devices. A conventional RAG system may include a vector database and token encoders and decoders. Upon receiving a query, the system encodes the request into a list of tokens, retrieves relevant text from the vector database, appends the retrieved text to the query, and processes the combined sequence with an LLM.

While RAG is presented as one use case, the embodiments may also be applied within other AI-based systems. In particular, the formation of the hidden state may serve as a short-term or long-term memory. Such memories may provide the basis for durable storage. Embedding these vectors in a sparse, high-dimensional space may reduce the risk of catastrophic forgetting in neural networks.

Some embodiments may include methods of query-time execution on an SSM. Such methods may include receiving a first data chunk on a processing system that hosts a first SSM, processing the first data chunk through the first SSM to form a first hidden state that summarizes tokens of the first data chunk, and storing the first hidden state in memory as a stored hidden state obtained through precomputation that links to a key for the first data chunk. The method may further include receiving a first query on the processing system, retrieving the stored hidden state that links to the key for the first data chunk in response to the first query, loading the stored hidden state into the first SSM as an initialization state, and processing tokens of the first query through the first SSM from the initialization state to generate answer tokens. In some embodiments, processing of the first data chunk may update a per-layer hidden state for each layer of the first SSM in sequence, and the stored hidden state may include a final per-layer hidden state. In some embodiments, the key may include a sentence embedding vector that links to the stored hidden state. In some embodiments, the processing system may be included in an edge device. In some embodiments, storing the first hidden state may include writing a tuple [key, hidden_state] to a vector database. In some embodiments, retrieval may search the vector database with an embedding of the first query to match the key. In some embodiments, loading the stored hidden state may include copying per-layer vectors into on-chip static random access memory (e.g., SRAM). In some embodiments, the generation of answer tokens may proceed by autoregression without reprocessing the tokens of the first data chunk.

FIG. 3D is a process flow diagram that illustrates an example method 350 of offline precog record creation and single-source query-time reuse on an SSM. Method 350 may be performed in a computing device by a processing system that includes a SoC 100 with one or more processors 120-132 and memory 136 described in this application. The applications processor 122 may coordinate record creation and storage in DDR4 or DDR5 memory. The NPU 126 or the DSP 130 may execute an SSM. This configuration aligns with the SoC and method frameworks in FIGS. 1 and 3A-3C and with the detailed description of query-time operations.

In block 352, a processor or compute engine in the processing system may receive a first data chunk on a processing system that hosts a first SSM. In case of text, this may be a document chunk. For example, the applications processor 122 may read a UTF8 text segment from local storage and bound the segment to 256 or 512 tokens to match an offline precompute budget.

In block 354, a processor or compute engine in the processing system may process the first data chunk through the first SSM to form a first hidden state that summarizes tokens of the first data chunk. For example, the NPU 126 may apply the SSM update per token per layer and advance a fixed-length hidden vector without growth in size as context length rises. This may yield a compact representation that a processor may reuse at query time.

In block 356, a processor or compute engine in the processing system may compute a first key for the first data chunk as a function of the first hidden state or as a sentence-embedding vector that links to the first hidden state. For example, the processor may apply a linear projection to the hidden state to produce a 768 dimensional key or compute a 768 dimensional sentence embedding vector with a sentence transformer model and record a link from that vector to the hidden state. This may support text-based retrieval or self-index retrieval.

In block 358, a processor or compute engine in the processing system may store a first record in a vector database 359. The first record may include the first key and the first hidden state. For example, the processor may write the tuple [key, hidden_state] to a non-volatile memory storage for example flash memory, MRAM, ReRAM, or PCM as two contiguous arrays and omit the source tokens. This may reduce bandwidth during updates.

In block 360, a processor in the processing system may receive a first query. For example, the DSP 130 may deliver text decoded from speech or the UI stack may deliver typed text and the applications processor 122 may pass the token list to an embedding or SSM front end.

In block 362, a processor in the processing system may compute a second key for the first query. For example, the processor may run a sentence-transformer to form a 768-dimensional vector or pass the query tokens through the SSM from a neutral initialization to form a query hidden state and project that state to form the second key.

In block 364, a processor in the processing system may retrieve the first record from the vector database 359 by nearest neighbor search on the first key and the second key to obtain the first hidden state for reuse by the first SSM. For example, the processor may compute cosine similarity between the second key and database vectors, select the top match, and read its hidden state payload.

In block 366, a processor in the processing system may load the stored hidden state into the first SSM as an initialization state. For example, the NPU 126 may copy per-layer vectors into on-chip static random-access memory or cache and may set layer registers before the first query token enters the pipeline. This may avoid parameter bursts tied to context replay and may suit systems on resource-constrained edge devices. Any DRAM may be an optional portion of the system.

In block 368, a processor in the processing system may process tokens of the first query through the first SSM from the initialization state to generate answer tokens. These operations may correspond to the flows in FIG. 3C and to method blocks 616-620.

Some embodiments may include methods of compact storage and retrieval of model context. Such methods may include producing a first hidden state by processing a first data chunk through a first SSM on a processing system, computing a first key for the first data chunk as either (i) a sentence embedding vector that links to the first hidden state or (ii) a projection derived from the first hidden state, and storing a tuple [key, hidden_state] in a vector database. The method may further include receiving a first query on the processing system, computing a second key for the first query, and retrieving the tuple from the vector database by nearest neighbor search on the first key and the second key to obtain the first hidden state for reuse by the first SSM. In some embodiments, the projection may include a linear function, and in other embodiments the projection may include a multilayer perceptron with fixed parameters. In some embodiments, the vector database may store each tuple as a non-text representation that omits tokens of the first data chunk. In some embodiments, retrieval of the tuple may trigger loading of the first hidden state into the first SSM as an initialization state for generation. In some embodiments, the processing system may store the vector database in non-volatile memory and may store an active hidden state in on-chip volatile memory (e.g., SRAM).

FIG. 3E illustrates a method of storing a pre-computed hidden state and retrieving the stored hidden state for efficient initialization of a neural network, in response to a query related to a context represented by the hidden state, according to some embodiments, In some implementations, the hidden state may be stored in a tuple-centric manner that stores and retrieves a tuple [key, hidden_state] for reuse on a neural network, for example an SSM. Blocks 370-378 perform substantially the same or similar operations as blocks 354-368.

In some embodiments, when the target corpus is known in advance the processing system may bypass similarity scoring and may select the tuple by its identifier. The processing system may read the stored hidden state for that identifier and may load it as the initialization state. The processing system may next process the user query as described above. The retrieval key remains stored with the tuple to support both direct selection and similarity search in a single database format.

In block 370, a processor in the processing system may produce a first hidden state by processing a first data chunk through a first SSM on the processing system.

In block 372, the processor may compute a first key for the first data chunk as a function of the first hidden state or as a sentence-embedding vector that links to the first hidden state.

In block 374, the processor in the processing system may store a first record including the first key and the hidden state in a non-volatile memory in a vector database. processor in the processing system may store the first hidden state in non-volatile memory as a stored hidden state obtained through precomputation that links to a key for the first data chunk. For example, the processor may persist final per-layer state vectors after the precompute pass and maintain a stable link to the key stored in the vector database which may be stored in a flash memory.

In block 376, the processor may retrieve the first record from the vector database stored in the non-volatile memory, during an inference associated with a query using the model, based on a nearest neighbor search on the first key and a second key different than the first key, the second key associated with a second record, to obtain the hidden state for reuse by the model.

In block 378, the processor may retrieve the hidden state from the first record in response to the query and during inference associated with the query. The processor may load the hidden state into the model as an initialization state. The pre-computed hidden state loaded efficiently as initialization state may render computation efficient by the model to generate an inference leading to an output to a query related to information associated with the hidden state.

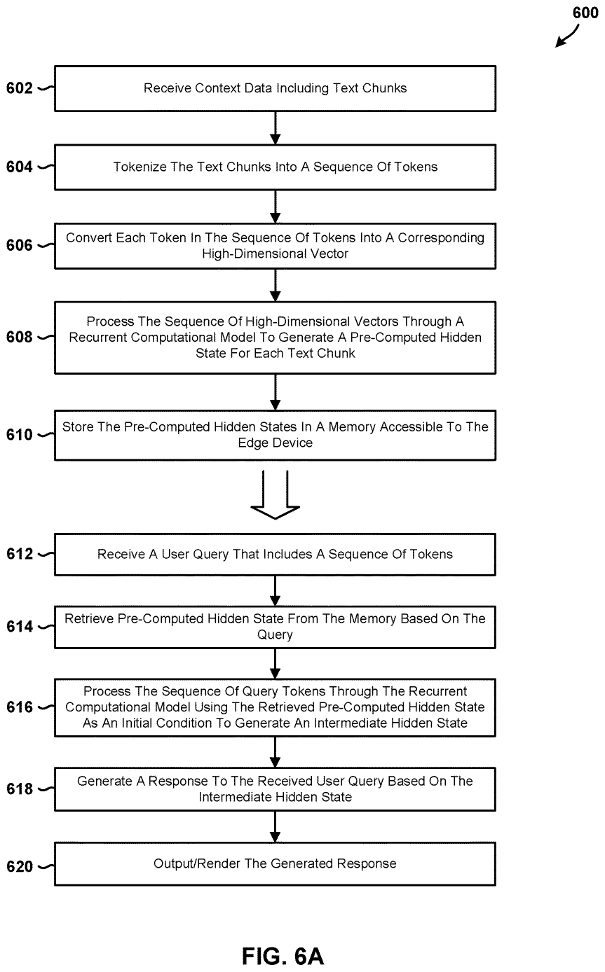

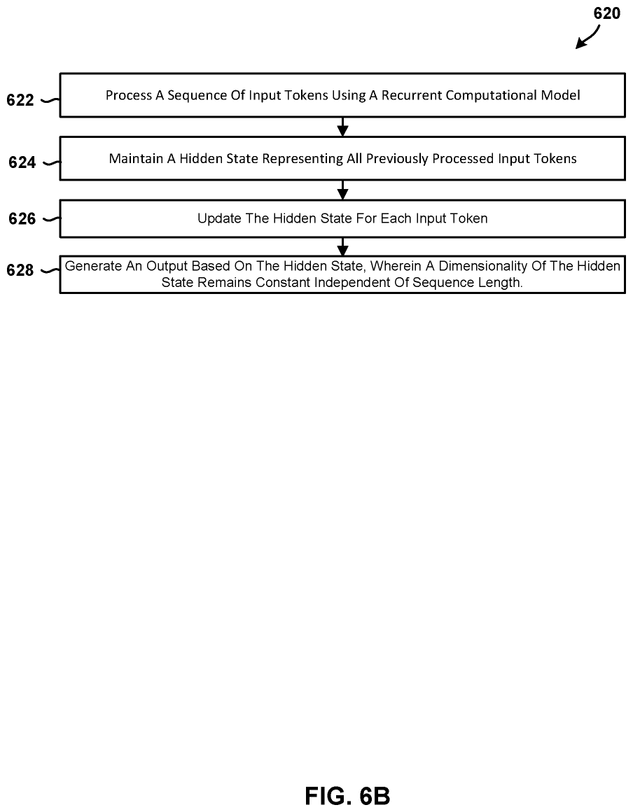

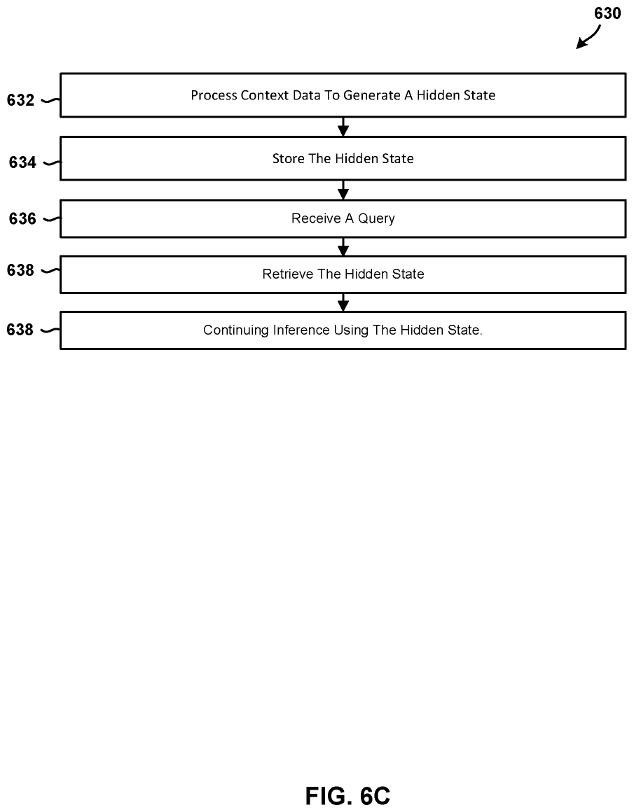

In block 380, a processor in the processing system may process tokens of the query through the model from the initialization state to generate answer tokens and may proceed by autoregression without reprocessing tokens of the data chunk and without loading data into a DRAM associated with the processing system. These operations may correspond substantially to the operations described with reference to FIGS. 3C and 6A, 6B, 6C.

$${\overline{H}}_{\{ i , t )}^{\{ 2048 \times 1 )} = {\overline{A}}_{i}^{\{ 2048 \times 1 )} ∘ {\overline{H}}_{\{ i , t - 1 )}^{\{ 2048 \times 1 )} + {B}_{i}^{\{ 2048 \times 2048 )} \cdot {U}_{\{ i , t - 1 )}^{\{ 2048 \times 1 )} {Y}_{i , t}^{2048 \times 1} = {\overline{C}}_{i}^{2048 \times 2048} \cdot {\overline{H}}_{i , t}^{20 \; 48 \times 1} {U}_{i + 1 , t}^{2048 \times 1} = F ( {Y}_{i , t}^{2048 \times 1} )$$

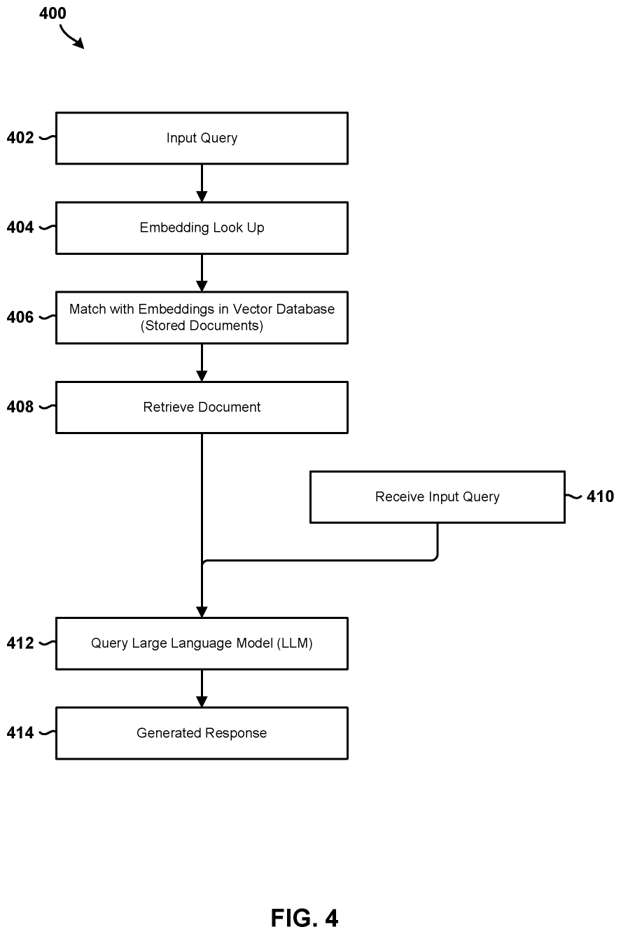

FIG. 4 is a process flow diagram illustrating an example method 400 in a RAG system for edge devices in accordance with some embodiments. Method 400 may be performed in a computing device by a processing system that includes one or more processors, such as processors 120-132 and related components or subsystems described in this application.

In block 402, the processing system may receive an input query in the form of a text string that includes a sequence of words or subwords. For example, the system may receive a user-provided question or command through a user interface such as a text entry field or a voice-to-text input system. This operation may improve usability on edge devices by supporting flexible input modes without reliance on cloud infrastructure.

In block 404, the processing system may transform the text string into a list of numerical vectors. Each word, subword, or portion of the query may be converted into a real-valued or complex-valued vector, producing a list of vectors. The system may apply a linear or nonlinear function to the list to generate a single embedding vector that summarizes the query. For example, the system may generate this embedding by applying a sentence embedding model or by summing the vectors of the individual tokens. This operation may provide a compact representation of the query that may reduce memory access and may prepare the query for efficient matching against stored vectors.

In block 406, the processing system may match the embedding vector against vectors stored in a vector database. The embedding may take the form of a sentence embedding or another representation, and in some embodiments the list of token vectors may be processed using an SSM, with the resulting hidden vector used as the representation. The system may match the hidden vector against analogous vectors derived from document chunks in the vector store. Matching may be performed using cosine similarity or other distance measures, including quasi-metrics that do not strictly adhere to the mathematical definition of a metric but may still serve as practical tools for comparison. For example, the system may compute cosine similarity between the input embedding and stored embeddings to generate a similarity score to identify the closest match. By using embeddings and similarity search, the system may reduce bandwidth compared to transmitting entire documents and may reduce latency by localizing search to compact vectors.

In block 408, the processing system may retrieve a relevant document or data chunk based on the matching process. For example, the processing system may retrieve a paragraph or section from the vector database that is most relevant to the input query based on the similarity score between the input embedding and stored embeddings. In some embodiments, the system may retrieve a stored compact hidden state from a non-volatile memory (e.g., flash memory, MRAM, ReRAM, or PCM) that corresponds to a matched data chunk and may use that stored hidden state for initialization. This operation may avoid reprocessing large volumes of data by narrowing retrieval to compact and relevant material, which may improve runtime efficiency on edge devices with limited memory and/or power.

In block 410, the processing system may receive a follow-up query related to the retrieved content. For example, the system may receive a second question from the user that requests clarification or additional detail regarding the retrieved document. By permitting iterative queries, the system may reuse a stored hidden state or an intermediate hidden state and may avoid recomputing earlier context, which may reduce repeated computation and may improve responsiveness.

In block 412, the processing system may query the LLM using the user query together with the retrieved document or with the retrieved stored hidden state as discussed in method 500 below. For example, the processing system may generate context information based on the retrieved content, combine it with the input query, and provide both to the LLM for processing. This operation may provide the LLM with context-aware input and may reduce redundant processing, which may lower memory access demand and may improve throughput on edge devices.

In block 414, the processing system may receive a response generated by the LLM. For example, the system may receive an answer or explanation that addresses the user's query, where the response is generated using both the input query and the retrieved document as context or using the input query with a retrieved stored hidden state. This operation may provide real-time answers to user queries and may reduce reliance on cloud resources. The method may improve device functionality by lowering power consumption, reducing latency, and delivering responsive query handling on resource-constrained hardware.

Method 400 may improve the operation of a computing device by reducing memory traffic, lowering computational demand, and decreasing latency during query-time operations. By transforming queries into compact embeddings, matching them against stored vectors, retrieving relevant document segments or stored hidden states, and processing those inputs with an LLM in conjunction with the query, the system may avoid redundant computation and large-scale memory transfers that would otherwise burden resource-constrained hardware. These operations may collectively improve device functionality by delivering responsive, context-aware answers in real time, reducing power consumption, and extending the practical use of LLMs to edge devices without reliance on high-speed memory or cloud resources.

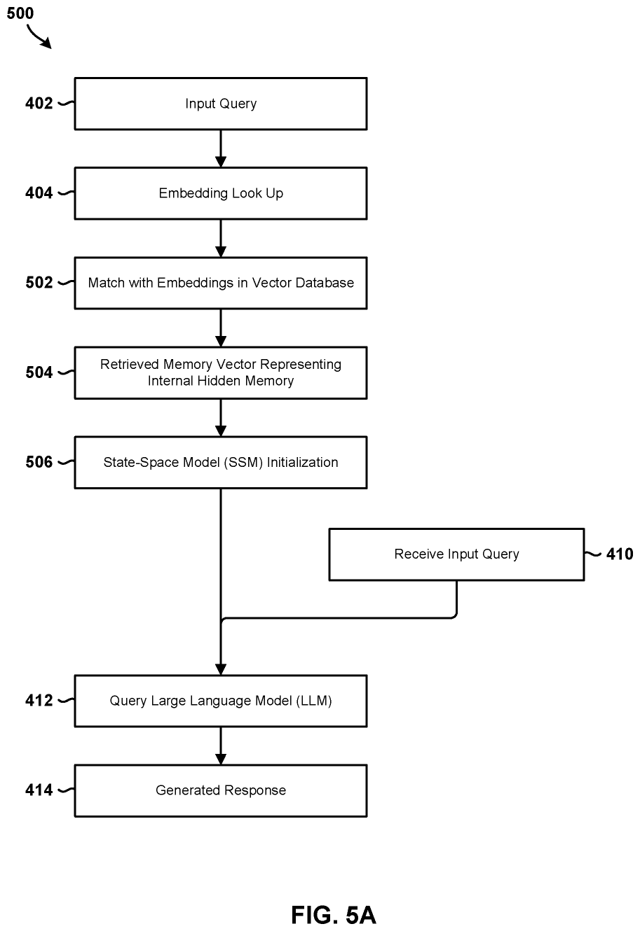

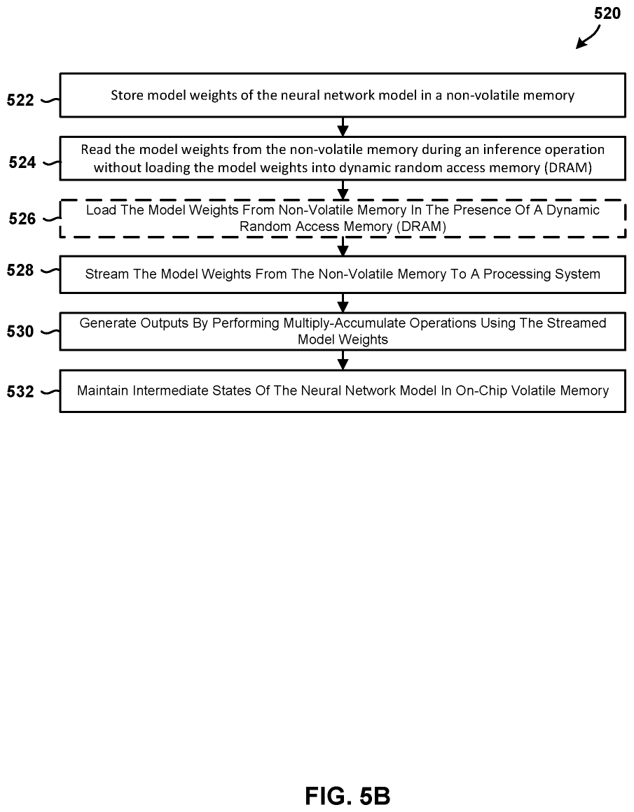

FIG. 5A is a process flow diagram illustrating an example precomputation method 500 for edge devices in accordance with some embodiments. Method 500 may be performed in a computing device by a processing system that includes one or more processors such as processors 120-132 and related components or subsystems described in this application. In blocks 402 and 404, the processing system may perform the operations in like-numbered blocks 402 and 406 described with reference to FIG. 4.

In block 502, the processing system may match the embedding vector derived from the input query against stored hidden state obtained through precomputations stored in a vector database. Unlike block 406, which matches query embeddings against stored document embeddings or raw text, block 502 operates on compact stored hidden state obtained through precomputations. These hidden states encapsulate information extracted from source documents and may remove the need to reprocess or retrieve entire documents. By using precomputed hidden states, the system may avoid reprocessing or retrieving entire documents. These hidden states may also include additional context or background knowledge relevant to the task. For example, the precomputed hidden states may store appliance-specific knowledge or common troubleshooting operations beyond what is found in user manuals. In some embodiments, the hidden states may store domain-specific knowledge for medical devices, vehicle diagnostic procedures, or industrial equipment maintenance guides. The system may perform matching using cosine similarity or other quasi-metric methods that support efficient retrieval without heavy memory use or computation.

In block 504, the processing system may retrieve a stored hidden state obtained through precomputation H̅ that represents the internal memory of the model. This hidden state may include contextual data or background knowledge that enhances understanding of the current task. For example, H̅ may include common knowledge about the operations of household appliances that goes beyond what is included in user manuals. In some embodiments, the hidden state may include common knowledge about vehicle maintenance procedures that goes beyond what is included in owner manuals, medical device operating procedures that incorporate clinical best practices, or industrial equipment safety protocols that integrate regulatory requirements. The background knowledge embedded in H̅ may be acquired by fine-tuning the LLM on external datasets or pre-training the system with broader domain knowledge. This fine-tuning may allow the LLM to provide robust and more informed responses during real-time interactions.

In block 506, the processing system may initialize the SSM. The initialization may include multiple types of input, such as an initialization vector, the input query, and a task-specific prompt. The initialization vector may prime the model with baseline knowledge or context. For example, the initialization vector may prime the model with product-specific context, user preference history, or domain terminology. The input query may include or represent the user's specific request or command. The task-specific prompt may guide the model's behavior by, for example, instructing the LLM on how to interpret the query and tailor its response to the current task so that the output aligns with the desired communication style and task requirements. For example, a task-specific prompt may instruct the model to respond in a troubleshooting format with numbered steps, or to provide a concise summary, or to generate a detailed technical explanation.

In some embodiments, using the above described precomputation process each document may create a memory trace only once. As the input document may have a long token length, this may call for extremely fast processing and have a high memory bandwidth requirement. This may be problematic on power, compute, and memory bandwidth-constrained edge devices. The precomputation process may address this by precomputing hidden states offline and storing the hidden states on non-volatile memory to be accessed during inference. While conventional transformer-based models may use KV-caching, such an approach may be prohibitively expensive due to the large sizes of the KV caches and may call for considerable optimizations to render the procedure achievable.

In some embodiments, as described the precomputed context may significantly reduce the runtime computational load. Whereas conventional models often require processing speeds exceeding 1000 tokens per second to handle complex queries in user-acceptable times, the SSM may reduce this requirement to less than 20 tokens per second during the generative phase. This reduction may be achieved without compromising the model's performance.

$${H}_{2}^{′} = {A}_{2} {H}_{2} + {B}_{2} {Y}_{1}^{′}$$

$${Y}_{{2}^{=}}^{′} {f}_{2} ( {Y}_{1} , {C}_{2} {H}_{2} )$$

The subscript denotes the layer of the network. Here, f2 denotes an arbitrary nonlinear activation function. A typical realization of ƒ could be: f(U, CH)=SiLU(u+LayerNorm(CH)) where we have a residual block with layer normalization.

In some embodiments, the processing system may be configured to operate an SSM in a reverse mode to revert hidden states. Assume that A₁ is an invertible matrix (e.g., a diagonal matrix of full rank). To revert the effects of U on the hidden states, one may exchange the order of output projection with the hidden state update, then invert the hidden state update as follows:

$${Y}_{{1}^{=}}^{′} f ( U , {C}_{1} {H}_{1}^{′} )$$

$${H}_{1} = {A}_{1}^{- 1} {H}_{1}^{′} - {A}_{1}^{- 1} {B}_{1} U$$

$${Y}_{2}^{′} = {f}_{2} ( {Y}_{1}^{′} , {C}_{2} {H}_{2}^{′} )$$

$${H}_{2} = {A}_{2}^{- 1} {H}_{2}^{′} - {A}_{2}^{- 1} {B}_{2} {Y}_{1}^{′}$$

In this process, the output Y′ for each layer must be computed first before reversing the hidden state.

In some embodiments, the processing system may be configured to perform parallel processing during rollback. If the function ƒ operates solely on CH (without residual connections), then in reverse mode, the output projection operations may be performed first for all layers in parallel. Specifically:

$${Y}_{1}^{′} = f ( {C}_{1} {H}_{1}^{′} )$$

$${Y}_{2}^{′} = {f}_{2} ( {C}_{2} {H}_{2}^{′} )$$

and so forth. The outputs y′ may then be cached temporarily and used to revert the hidden states, again in parallel:

$${H}_{1} = {A}_{1}^{- 1} {H}_{1}^{′} - {A}_{1}^{- 1} {B}_{1} U ,$$

$${H}_{2} = {A}_{2}^{- 1} {H}_{2}^{′} - {A}_{2}^{- 1} {B}_{2} {Y}_{1}^{′} ,$$

and so forth. This time-reversal solution may allow the processing system to efficiently roll back hidden states, improve handling of user edits in real-time, and reduce computational overhead on resource-constrained edge devices.

In some embodiments, implementing the precomputation process using storage in non-volatile memory, with each document or source creating a memory trace just once, rather than requiring repeated token-by-token reprocessing may reduce the runtime load and make it practical to have on-device inference using power-, compute-, and/or memory-constrained hardware. Not invoking DRAM and instead storing and retrieving from non-volatile memory (e.g., flash memory, MRAM, ReRAM, or PCM) may further relieve the memory load for resource constrained applications. As an example, an SSM with precomputation in embodiments non invoking DRAM during inference may process fewer than 20 tokens per second during the generative phase and still deliver timely responses, compared to conventional models that often require more than 1000 tokens per second. The relationship between multiply-accumulate operations and model parameters allows efficient scaling. A one-billion-parameter SSM at 20 tokens per second may budget, for example, 20 to 80 GFLOPs per second. The range may depend on kernel structure, weight reuse, count of multiply-accumulate operations per token, or other similar factors.

The precog process may also support real-time text entry. As the user types, the system may update the hidden state incrementally and store snapshots. If the user deletes input, the system may restore the prior hidden state instead of recomputing the entire sequence. When the user completes input, the system has already processed most tokens and may return a response with minimal delay. This reduces latency and provides real-time feedback.

These capabilities extend to scenarios such as situational awareness in unidirectional communications, where compact hidden states may be broadcast instead of entire datasets. Field clients may query the precomputed states locally, gaining timely and precise answers without two-way connectivity. The approach also supports low-cost consumer and industrial devices. For example, appliances or printers may embed an LLM with precog-stored manuals or FAQs, providing interactive guidance without reliance on cloud services and operating for the device's lifetime without backend support.

Method 500 may improve computer functionality by reducing runtime computation, lowering latency, and decreasing power use. By processing context once and reusing compact hidden states, the method supports responsive real-time performance on devices with constrained resources and extends practical deployment of LLMs to edge environments.

In use, process overview, as an example:
1. Text Entry: The user begins typing.
2. Incremental Processing: With each keystroke, the system updates the hidden state and stores snapshots.
3. Deletion Handling: If a user deletes part of the text, the system recovers the prior corresponding stored state and continues processing from that point.
4. Response Generation: Once the user finalizes the input, the system, having already processed the majority of the input, may quickly generate a response.

This method not only reduces the latency experienced by the user but also enhances the overall user experience by providing real-time feedback as they type.

Time-Reversal in Computation: In scenarios where edge devices lack external storage, an alternative approach—time reversal in computation—may be employed to efficiently handle deletions during text input. This technique involves running each layer of the SSM in reverse to roll back the hidden state to its previous condition before the input was deleted.

SSM in Forward Mode: Consider a network with two layers of SSMs and a new input U that updates the network as follows:

$${H}_{1}^{′} = {A}_{1} {H}_{1} + {B}_{1} U$$

$${Y}_{1}^{′} = {f}_{1} ( U , {C}_{1} {H}_{1}^{′} ) ,$$

$${H}_{2}^{′} = {A}_{2} {H}_{2} + {B}_{2} {Y}_{1}^{′}$$

$${Y}_{{2}^{=}}^{′} {f}_{2} ( {Y}_{1} , {C}_{2} {H}_{2} )$$

The subscript denotes the layer of the network. Here, ƒ denotes an arbitrary nonlinear activation function. A typical realization of ƒ could be: ƒ(U, CH)=SiLU(u+LayerNorm(CH)) where we have a residual block with layer normalization.

SSM in Reverse Mode: Assume that A₁ is an invertible matrix (e.g., a diagonal matrix of full rank). To revert the effects of U on the hidden states, one may exchange the order of output projection with the hidden state update, then invert the hidden state update as follows:

$${Y}_{1}^{′} = f ( U , {C}_{1} {H}_{1}^{′} )$$

$${H}_{1} = {A}_{1}^{- 1} {H}_{1}^{′} - {A}_{1}^{- 1} {B}_{1} U$$

$${Y}_{2}^{′} = {f}_{2} ( {Y}_{1}^{′} , {C}_{2} {H}_{2}^{′} )$$

$${H}_{2} = {A}_{2}^{- 1} {H}_{2}^{′} - {A}_{2}^{- 1} {B}_{2} {Y}_{1}^{′}$$

In this process, the output Y′ for each layer must be computed first before reversing the hidden state.

Parallel Processing: If the function ƒ operates solely on CH (without residual connections), then in reverse mode, the output projection operations may be performed first for all layers in parallel. Specifically:

$${Y}_{1}^{′} = f ( {C}_{1} {H}_{1}^{′} )$$

$${Y}_{2}^{′} = {f}_{2} ( {C}_{2} {H}_{2}^{′} )$$

and so forth. The outputs y′ may then be cached temporarily and used to revert the hidden states, again in parallel:

$${H}_{1} = {A}_{1}^{- 1} {H}_{1}^{′} - {A}_{1}^{- 1} {B}_{1} U ,$$

$${H}_{2} = {A}_{2}^{- 1} {H}_{2}^{′} - {A}_{2}^{- 1} {B}_{2} {Y}_{1}^{′} ,$$

and so forth. This time-reversal approach allows for efficient rollback of hidden states, optimizing the processing of user input in real-time while minimizing the computational overhead, particularly in resource-constrained environments.

The following examples illustrate how precognition and time-reversal in computation may be applied to improve real-time text input processing and rollback operations in LLMs deployed on edge devices in accordance with some embodiments.

Situational awareness: One potential use case for this technology is in scenarios involving unidirectional communication, such as between a broadcast tower and a client or in environments where radio-frequency bandwidth is severely limited. Consider the case of shortwave radio, where supporting interactive communication between a client and the cloud is nearly impossible. By utilizing PreCog information, highly compact databases may be encoded and broadcast over long distances. What would be transmitted is the compact hidden state representation along with associated keys.

In the field, clients may engage in rapid, dynamic interactions with an agent powered by PreCog and RAG techniques, allowing them to incrementally extract information on demand. Such a system would be invaluable for broadcasting situational awareness data to first responders, enabling them to interact with an agent and access timely, precise information in the field-without relying on cell towers or bidirectional satellite communication. This technology would also be crucial for coordinating logistics operations in critical and hazardous situations, providing a significant advantage in scenarios where conventional communication methods are unavailable or impractical.

Low-cost machines that tell you how to use them: Humanity is surrounded by a multitude of mechanical devices in the home-dishwashers, washing machines, dryers, doorbells, locks, robot vacuums, refrigerators, automobiles, and microwaves. Some industries have complex audio-visual equipment, industrial printer copiers, and storefronts that should be capable of dialog with users. Each of these devices comes with a user manual or other data source, which often needs to be downloaded, retrieved from storage, or may become lost or damaged. Internet-connected devices face challenges during setup, and owners often need quick, easy-to-understand instructions for enabling specific modes or troubleshooting issues.

Connecting all devices to the cloud not only requires users to be proficient with modern technology but also often involves linking personal information and data (via a phone) to the device. This may be especially inconvenient for occasional visitors, renters, or hotel guests who may be reluctant or lack the technical acumen to connect their devices to every appliance they encounter.

The lightweight PreCog method allows a comprehensive set of contextual information (e.g., an entire user manual, FAQs, hand crafted information, etc.) to be memorized and stored with an extremely small footprint. Additionally, an LLM may be run inside the device with minimal computational resources, adding only a few dollars to the cost while providing immense benefits to the owner. This may also benefit the device manufacturer by simplifying operations and eliminating the need to maintain a cloud service for the device's entire lifespan, which may span decades in some cases.

FIG. 5B is a process flow diagram illustrating an example method 520 for performing inference with a neural network model using non-volatile memory in accordance with some embodiments. Method 520 may be performed in a computing device by a processing system that includes one or more processors, such as processors 120-132 and related components or subsystems described in this application. For example, the applications processor 122 may orchestrate data movement and control flow, the NPU 126 may execute the neural network model, and the DSP 130 may handle tokenization or audio input/output where applicable. Method 520 illustrates a flow that supports inference operations by reading weights directly from non-volatile storage and maintaining intermediate computational states in on-chip memory, which may reduce power consumption and system complexity compared to architectures that rely on DRAM for weight storage during inference.

In block 522, a processor in the processing system may store model weights of the neural network model in a non-volatile memory. The non-volatile memory may include flash memory, magnetoresistive RAM (MRAM), resistive RAM (ReRAM), or phase-change memory (PCM). The model weights may include layer parameters, bias values, normalization coefficients, and embedding tables. For example, the processing system may store a one-billion-parameter SSM in non-volatile memory (e.g., flash memory), where the weights persist without power and remain available for inference operations after device startup. The non-volatile memory may be co-packaged with the compute engine in a stacked or chiplet design, which may reduce interconnect length and improve data transfer efficiency. In some embodiments, the processing system may store multiple models on a single flash chip, allowing the device to switch between models without requiring external storage or network access.

In block 524, a processor in the processing system may read the model weights from the non-volatile memory during an inference operation without loading the model weights into dynamic random-access memory (DRAM). This approach bypasses the conventional DRAM-based memory hierarchy in which weights are first transferred from non-volatile storage to DRAM before computation. The processing system may access the non-volatile memory through a serial interface such as UFS with MIPI M-Phy, which may achieve 4.2 gigabytes per second per serial lane. The sequential access patterns of SSM inference match the predictable weight read patterns, making flash storage viable since random access is not required. For example, the processing system may read weights layer by layer in a predetermined sequence, allowing the flash controller to prefetch data efficiently. By eliminating DRAM, the processing system may reduce power consumption from 1.5 to 5 watts (typical for LPDDR controllers) to 80 to 160 milliwatts (typical for flash controllers at maximum throughput).

In block 526, optionally, a processor in the processing system may load the model weights from the non-volatile memory in the presence of dynamic random-access memory (DRAM). This block represents an alternative or supplementary path where weights may or may not be optionally transferred to DRAM under certain conditions or configurations. For example, the processing system may load weights into DRAM when DRAM is available and the application requires higher bandwidth than flash storage can provide, or when the model architecture includes components that benefit from random access patterns. In some embodiments, the processing system may use a hybrid approach in which frequently accessed weights reside in DRAM while less frequently accessed weights are streamed from flash storage. This alternative path may support backward compatibility with existing software stacks or may be used during development and debugging phases.

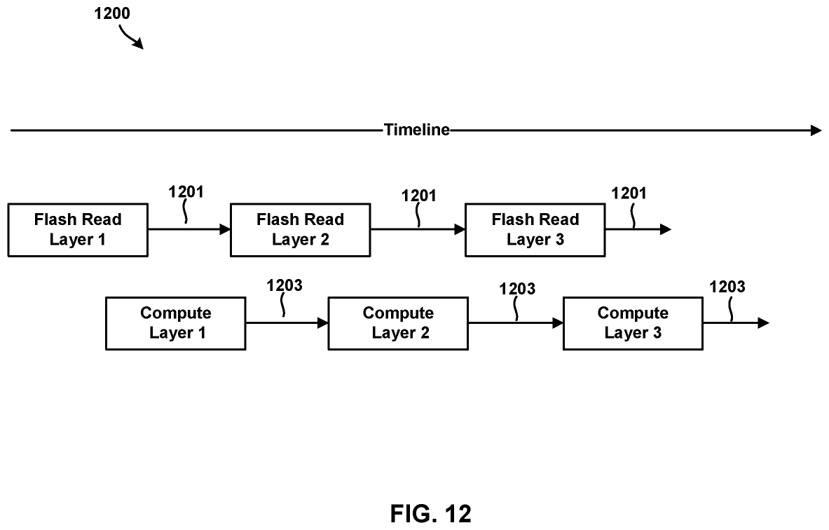

In block 528, a processor in the processing system may stream the model weights from the non-volatile memory to the processing system. The streaming operation transfers weight data in a sequential manner that supports continuous computation without requiring complete weight sets to reside in volatile memory simultaneously. The processing system may stream weights layer by layer in a pipelined fashion, reading weights for a subsequent layer while computation proceeds on the current layer. For example, as illustrated in FIG. 12, the processing system may overlap flash read operations for layer N+1 with compute operations for layer N, which may hide memory access latency behind computation time. The streaming approach may reduce on-chip memory requirements because only the weights for the current layer need to be buffered at any given time. In some embodiments, the processing system may use multiple flash lanes in parallel to achieve the bandwidth required for real-time inference.

In block 530, a processor in the processing system may generate outputs by performing multiply-accumulate (MAC) operations using the streamed model weights. The MAC operations apply the streamed weights to input data to produce inference results as part of neural network layer computations. The processing system may perform approximately one MAC operation per weight per token. For example, for a one-billion-parameter model processing ten tokens per second, the processing system may perform approximately ten giga-operations per second (10 GOPS). For a one-billion-parameter model processing twenty tokens per second, the processing system may perform approximately twenty giga-operations per second (20 GOPS). Such a workload may be manageable for edge devices with moderate processing capabilities, such as those with ARM A-class processors, because SSM inference is heavy on memory read but light on compute compared to regular compute workloads. The processing system may execute the MAC operations on a neural processing unit, a digital signal processor, or a graphics processing unit of the edge device.

In block 532, a processor in the processing system may maintain intermediate states of the neural network model in on-chip volatile memory. The on-chip volatile memory may include static random-access memory (SRAM), a register file, or a scratchpad memory. The intermediate states may include hidden state vectors that are maintained between processing steps and updated as each token is processed. For a SSM, the hidden state may have a fixed length that does not grow with context length. For example, a TENNs model with a 2048-element hidden state at 16-bit precision may require approximately 4 kilobytes per layer, and a model with 24 layers may require approximately 96 kilobytes of on-chip SRAM for the complete hidden state. This is substantially smaller than the 8 to 16 megabytes required for a transformer key-value cache with equivalent context length. The processing system may selectively write intermediate states back to non-volatile memory (e.g., flash memory) for persistence across power cycles or for rollback during interactive editing sessions.

Method 520 may improve computer functionality by reducing power consumption, simplifying memory architecture, and extending operational lifetime. By reading weights directly from flash storage and maintaining intermediate states in on-chip SRAM, the processing system may eliminate the need for DRAM controllers, which are a dominant power sink in conventional systems. The flash-based architecture may also reduce system footprint because non-volatile memory (e.g., flash memory) is six to eighteen times more compact in area than DRAM. The processing system may algorithmically spread write operations among multiple memory blocks to maximize flash endurance, which may extend the operational lifetime of the device beyond typical usage scenarios.

In some embodiments, the hidden state may use one vector per layer. With a 2048-element state at FP16, the size may be 4 KB per layer. With 24 layers, the per-model state may be 96 KB. A transformer KV cache for 2000 tokens and 2048-dimensional FP16 vectors may be about 8 MB for keys or 8 MB for values or 16 MB in total.

In some embodiments, the processing system may pre-read a known corpus such as a book or a manual and may store one stored hidden state that summarizes the corpus. The processing system may process tokens of the corpus through the SSM once to produce a final per-layer state. The processing system may compute a retrieval index vector for the corpus by a sentence-embedding model or by a projection of the hidden state. The processing system may store a tuple that includes an identifier for the corpus, the retrieval index vector, and the stored hidden state in a vector database located in dynamic random-access memory. The processing system may omit storage of source tokens. The processing system may protect the tuple by access control and, where used, encryption at rest. The tuple uses non-text numeric representation.

During query-time operation the processing system may receive a user query and a selection of a corpus identifier. The processing system may retrieve the tuple by the identifier and may load the stored hidden state into on-chip static random-access memory by direct memory access, one vector per layer of the SSM. The processing system may process the query tokens from that initialization state and may generate answer tokens. The processing system may present the answer on a display or as audio by the text-to-speech module already described for the voice loop. The processing system may switch to a different corpus by loading the stored hidden state of another tuple. The processing system may complete the switch by DMA with no replay of the corpus.

In some embodiments, the processing system may include a fusion module configured to combine intermediate state data generated from multiple sources. In some implementations, the fusion module may operate on hidden states rather than raw input tokens. The system may process a plurality of input data streams, each associated with a corresponding hidden state, and combines the hidden states to generate a unified representation. At least one of the hidden states may comprise a precomputed hidden state retrieved from a memory. For example, when the processing system needs information from more than one corpus the processing system may retrieve multiple stored hidden states and may form a combined hidden state by a fusion function. The fusion function may compute a weighted sum per layer or may use a learned mapper per layer as already described for multi-source fusion. The fused state may serve as the initialization state for the same query-time path.

FIG. 6A is a process flow diagram illustrating a more detailed method 600 of executing an LLM on the edge device in accordance with some embodiments. With reference to FIGS. 1-6, method 600 may be performed by a processing system that includes one or more components or subsystems described in this application, such as processors 120-132 of the SoC 100. The operations in method 600 may be executed by a processing system configured with software or firmware to perform some or all of the operations. To cover the range of configurations described the term “processing system” refers to hardware capable of executing the method.

In block 602, the processing system may receive context data that includes text chunks. For example, the processing system may retrieve the context data from a local memory, a remote database, or from real-time user inputs. In some embodiments, the context data may be preloaded into the memory of the edge device, such as preprocessed documents, user history, or application-specific information. The context data may also come from external sources, such as connected cloud servers, APIs, or sensor inputs. For example, in an autonomous vehicle system, the context data may include navigation maps, sensor data, and traffic reports, all provided in chunks for efficient processing.

In block 604, the processing system may tokenize the text chunks into a sequence of tokens. For example, the processing system may divide the text chunks into smaller, discrete units such as words, subwords, or characters, as discussed.

In block 606, the processing system may convert each token in the sequence of tokens into a corresponding high dimensional vector. For example, the processing system may use an embedding layer within a neural network architecture to transform each token into a dense vector representation. As discussed, the embedding layer may map discrete tokens to continuous high dimensional vectors so that each vector captures semantic information about the token based on its usage and relationships to other tokens.

In block 608, the processing system may process the sequence of high dimensional vectors through a recurrent computational model to generate a stored hidden state obtained through precomputation for each text chunk. The stored hidden state obtained through precomputation may include a compact representation of all tokens processed up to that point/token.

In some embodiments, the recurrent computational model may be an SSM. In some embodiments, the SSM may be a TENNs.

In some embodiments, processing the sequence of high dimensional vectors in block 608 may include updating a fixed-length hidden state vector for each token in the sequence of tokens. The fixed-length hidden state vector may maintain a constant dimensionality during the processing of each token.

In some embodiments, the processing system may be configured to pre-process the context data and store stored hidden state obtained through precomputations in the memory for later retrieval during real-time query processing. For example, the processing system may analyze large volumes of context data in advance to generate and store the corresponding hidden state obtained through precomputations. Such preprocessing may reduce the need for the system to perform complex calculations at the time of a query. When a real-time query is received, the processing system may simply retrieve the relevant stored hidden state obtained through precomputation directly from memory.

In block 610, the processing system may store the stored hidden state obtained through precomputations in a memory accessible to the edge device. The stored hidden state obtained through precomputations may be stored in the memory in a compressed format that reduces the data size while retaining sufficient information to represent the corresponding text chunk. In some embodiments, the stored hidden state obtained through precomputation may be stored in a non-volatile or volatile memory (e.g., flash memory, MRAM, ReRAM, or PCM) of the edge device and be read, during inference, directly from the non-volatile memory without loading on to a DRAM even if present. In some embodiments, the hidden states may be read directly from the non-volatile memory with the option of loading on to a DRAM if the situation presented (e.g., available resources in abundance like power, bandwidth, etc.), and the option can be switchable between on and off based a user preference. In some embodiments, the stored hidden state obtained through precomputation may include information that allows for the processing of query tokens without requiring reprocessing of the corresponding text chunk. In some embodiments, the processing system may be configured to store the weights of the SSM in in non-volatile or static memory and store the stored hidden state obtained through precomputations in non-volatile or static memory, to be read directly during inference using the model, with the option of using volatile memory like DDR4/DDR5 SDRAM, as the situation presented itself.

The stored hidden state obtained through precomputation may encapsulate the contextual representation of the processed text chunk, acting as a snapshot of the model's understanding at that point. By storing this intermediate state, the system may load the hidden state from memory and continue processing without re-analyzing the text in real-time. This allows for efficient retrieval and integration with new input, such as user queries, and reduces computational overhead for the edge device when generating responses.

In block 612, the processing system may receive a user query that includes a sequence of query tokens. For example, the processing system may obtain input from a user through a user interface, such as a text-based input interface or a speech recognition system. The processing system may then process the input to break down the user's query into individual tokens that may be used in conjunction with the stored hidden state obtained through precomputations to generate a response to the query in real-time or near real-time.

In block 614, the processing system may retrieve a stored hidden state obtained through precomputation from memory based on context data relevant to the received user query. For example, the processing system may use a statistical retrieval method or a relevance model to evaluate the content of the query tokens and determine which stored hidden state obtained through precomputation most closely aligns with the context of the query. This may include comparing the query tokens to stored context data, identifying relevant matches, and selecting the corresponding hidden state that encapsulates the most appropriate contextual information.

In some embodiments, retrieving the stored hidden state obtained through precomputation from the memory in block 614 may include determining the relevant context for the user query using a statistical retrieval method based on the content of the query tokens and selecting the stored hidden state obtained through precomputation corresponding to the determined context. For example, the processing system may analyze the query tokens and compare them to representations of the stored hidden state obtained through precomputations stored in memory to identify the hidden state that best matches the context of the query based on the content of the tokens. The selected most relevant hidden state may be used as the starting point for processing the new query.

In block 616, the processing system may process the sequence of query tokens through the recurrent computational model using the retrieved stored hidden state obtained through precomputation as an initial condition to generate an intermediate hidden state. For example, the processor may load the stored hidden state obtained through precomputation into memory and use it as a starting point for evaluating the query tokens. As each query token is processed, the recurrent computational model may update the intermediate hidden state based on the information contained in the token and the pre-existing context from the precomputed state. This allows the system to efficiently handle new input without reprocessing the entire context.

In block 618, the processing system may generate a response to the received user query based on the intermediate hidden state. For example, the processing system may use the intermediate hidden state as the foundation for producing a series of output tokens that collectively form the response.

In some embodiments, generating the response in block 618 may include creating a sequence of response tokens. The processing system may generate the initial response token based on the intermediate hidden state and an initial token. The processing system may generate each subsequent token based on its preceding token and the intermediate hidden state. The processing system may repeatedly perform these operations until the full sequence of tokens is assembled, compiled, and/or used to generate the output.

In block 620, the processing system may output/render the generated response, such as by sending the generated response to an output interface of the edge device for display or audio output.

FIG. 6B is a process flow diagram illustrating an example method 620 of processing a sequence of input tokens using a recurrent computational model in accordance with some embodiments. Method 620 may be performed in a computing device by a processing system that includes one or more processors, such as processors 120-132 and related components or subsystems described in this application. The computing device may include a non-volatile memory storing model weights, a compute engine, on-chip volatile memory, and a controller configured to read and stream weights from the non-volatile memory without loading the weights into dynamic random-access memory and to generate outputs. Method 620 illustrates how a recurrent computational model maintains a fixed-length hidden state that evolves as tokens are processed, enabling efficient sequence processing without the memory growth associated with other architectures. This approach may reduce memory consumption and support deployment on edge devices with limited resources.

In block 622, the processing system may process a sequence of input tokens using a recurrent computational model. For example, the processing system may receive tokens from text entry or voice input and may process them through a SSM or other recurrent architecture that handles sequence data. The processing system may store model weights of the neural network model in a non-volatile memory and may read the model weights from the non-volatile memory during an inference operation without loading the model weights into dynamic random-access memory (DRAM). The processing system may stream the model weights from the non-volatile memory to the compute engine and may generate outputs by performing multiply-accumulate operations using the streamed model weights. In some embodiments, the non-volatile memory may include flash memory, MRAM, ReRAM, or PCM. In some embodiments, reading the model weights may include sequentially accessing memory locations corresponding to layers of the neural network model. In some embodiments, streaming and multiply-accumulate operations may occur concurrently. For example, the processing system may read weights for a subsequent layer from flash storage while performing multiply-accumulate operations on the current layer, as illustrated in FIG. 12.

In block 624, the processing system may maintain a hidden state representing all previously processed input tokens. The hidden state may serve as a compact representation that captures contextual information from the tokens already processed without increasing in size as additional tokens are received. The processing system may maintain intermediate states of the neural network model in on-chip volatile memory. The on-chip volatile memory may include static random-access memory (SRAM), a register file, or a scratchpad memory. For example, the processing system may store the hidden state vectors in on-chip SRAM between processing steps, where the hidden state serves as a compressed representation of all tokens processed up to the current point. In some embodiments, the hidden state may enable resuming processing without reprocessing prior tokens. For example, the processing system may pre-process context data to generate a hidden state, store the hidden state, and later retrieve the hidden state to continue inference using the hidden state without reprocessing the context data. In some embodiments, the hidden state may be stored as a tuple that includes a key and the hidden state, where the key may include an embedding vector.

In block 626, the processing system may update the hidden state for each input token. As each new token is processed, the recurrent computational model may modify the hidden state based on the information contained in the token and the pre-existing context from previously processed tokens. The processing system may perform the update by applying the model weights to the current token embedding and combining the result with the existing hidden state. For example, the processing system may apply the SSM update rule, in which the hidden state vector is advanced by an element-wise product with a state transition vector and a projection of the input token embedding, as described with reference to the SSM formulation in this application. In some embodiments, the processing system may receive a query after pre-processing context data and may update the hidden state for each query token from an initialization state derived from the pre-processed context data. In some embodiments, the processing system may write intermediate states to non-volatile memory. In some embodiments, write operations may be distributed among multiple memory blocks to manage endurance of the non-volatile memory.

In block 628, the processing system may generate an output based on the hidden state, wherein a dimensionality of the hidden state remains constant and compact independent of sequence length. The fixed dimensionality of the hidden state allows the system to process sequences of varying lengths while maintaining consistent memory requirements. For example, a TENNs model with a 2048-element hidden state at 16-bit precision may require approximately 4 kilobytes per layer regardless of whether the input sequence contains 100 tokens or 10,000 tokens. The processing system may generate the output by projecting the hidden state through an output layer to produce a probability distribution over candidate next tokens. The processing system may select or sample from that distribution and may append a token to extend the output sequence. In some embodiments, the neural network model may include a language model, a speech model, a vision model, or a multimodal model. In some embodiments, memory accesses during inference may be predominantly predictable read operations. In some embodiments, the non-volatile memory may be accessed via a serial interface such as UFS with MIPI M-Phy. In some embodiments, multiple models may be stored in the non-volatile memory and switched without DRAM. In some embodiments, the processing system may perform inference without loading model weights into DRAM prior to inference.

Method 620 may improve the operation of a computing device by reducing memory traffic, lowering computational demand, and decreasing power consumption during sequence processing. By maintaining a fixed-length hidden state in on-chip volatile memory and reading model weights directly from non-volatile memory without loading them into DRAM, the processing system may eliminate the need for DRAM controllers and may reduce system footprint. The recurrent computational model may process sequences of arbitrary length while maintaining constant memory requirements for the hidden state, which may enable deployment on edge devices with constrained resources. A non-transitory computer-readable medium may store instructions that configure the processing system to perform inference using weights stored in non-volatile memory, stream weights without loading into DRAM, perform computations using the streamed weights, and maintain intermediate states in on-chip volatile memory.

FIG. 6C is a process flow diagram illustrating an example method 630 for accelerating inference of a neural network model in accordance with some embodiments. Method 630 may be performed in a computing device by a processing system that includes one or more processors, such as processors 120-132 and related components or subsystems described in this application. The computing device may include a non-volatile memory storing model weights, a compute engine, on-chip volatile memory, and a controller configured to read and stream weights from the non-volatile memory without loading the weights into dynamic random-access memory and to generate outputs. Method 630 illustrates how pre-processing context data and storing hidden states may accelerate inference by allowing the processing system to retrieve and reuse hidden states during query-time operations without reprocessing previously processed context data.

In block 632, the processing system may pre-process context data to generate a hidden state. The context data may include document chunks, text segments, audio segments, or other input sequences that are processed through a SSM or other recurrent computational model. The processing system may tokenize the context data into a sequence of tokens, convert each token into a high-dimensional vector using an embedding layer, and process the sequence of vectors through the recurrent computational model to produce the hidden state. The hidden state may represent a compact summary of the processed context data. For example, the processing system may pre-process a user manual, a set of frequently asked questions, or a collection of technical documents by processing each document chunk through the SSM to generate a corresponding hidden state. The processing system may store model weights of the neural network model in a non-volatile memory and may read the model weights from the non-volatile memory during the pre-processing operation without loading the model weights into dynamic random-access memory (DRAM). The processing system may stream the model weights from the non-volatile memory to the compute engine and may generate the hidden state by performing multiply-accumulate operations using the streamed model weights. In some embodiments, the pre-processing may occur offline on the edge device or on a separate system such as a server. In some embodiments, the hidden state may be a compressed representation of tokens of the context data. In some embodiments, the dimensionality of the hidden state may remain constant independent of the length of the context data.

In block 634, the processing system may store the hidden state. The hidden state may be stored in memory as a tuple that includes a key and the hidden state, where the key may comprise an embedding vector or other retrieval index. The stored hidden state may serve as a compressed representation of the tokens from the context data. For example, the processing system may compute a sentence-embedding vector for the context data and may store the tuple [key, hidden_state] in a vector database. The processing system may maintain intermediate states of the neural network model in on-chip volatile memory during the pre-processing operation. The on-chip volatile memory may include static random-access memory (SRAM), a register file, or a scratchpad memory. In some embodiments, the processing system may store the hidden state in non-volatile memory for persistence across power cycles. In some embodiments, the processing system may store multiple hidden states corresponding to multiple document chunks, each associated with a different key. In some embodiments, the processing system may store the hidden state in a compressed format that reduces data size while retaining sufficient information to represent the corresponding context data. In some embodiments, the processing system may write the hidden state to non-volatile memory, and write operations may be distributed among multiple memory blocks to manage endurance of the non-volatile memory.

In block 636, the processing system may receive a query. The query may be received as a sequence of tokens from a user interface, voice input processed through a voice-to-text algorithm, or other input mechanism. For example, the processing system may receive a typed question from a user through a text entry field or may receive a spoken question through a microphone and a speech recognition system. The processing system may tokenize the query and may convert the query tokens into numerical vectors using an embedding layer. In some embodiments, the processing system may compute a query key by applying the same function used to compute the key for the stored hidden state, such as a sentence-embedding model or a linear projection.

In block 638, the processing system may retrieve the hidden state and may continue inference using the hidden state. The retrieval operation may locate the previously stored hidden state based on the received query, which may involve matching a query key against stored keys in a vector database using nearest neighbor search, cosine similarity, or other distance measures. The processing system may load the retrieved hidden state into the recurrent computational model as an initialization state. For example, the processing system may copy per-layer vectors of the retrieved hidden state into on-chip static random-access memory (SRAM) and may set layer registers before the first query token enters the processing pipeline. The processing system may then process the query tokens through the recurrent computational model from the initialization state to generate answer tokens. The processing system may update the hidden state for each query token and may generate an output based on the updated hidden state. The retrieval and reuse of the stored hidden state avoids reprocessing the context data during query-time operations, which may reduce computational overhead and improve response latency on edge devices. For example, a device that processes five words per second may require about two minutes to process 600 words of retrieved context, but with the stored hidden state the device may process only the query tokens and generate a response in seconds. In some embodiments, the processing system may read model weights from the non-volatile memory during inference without loading the model weights into DRAM. In some embodiments, the processing system may stream the model weights from the non-volatile memory to the compute engine and may generate outputs by performing multiply-accumulate operations using the streamed model weights. In other embodiments, DRAM may be present but is not utilized for storing model weights during inference. In some embodiments, streaming and multiply-accumulate operations may occur concurrently, as illustrated in FIG. 12. In some embodiments, memory accesses during inference may be predominantly predictable read operations. In some embodiments, the non-volatile memory may be accessed via a serial interface such as UFS with MIPI M-Phy. In some embodiments, the neural network model may include a language model, a speech model, a vision model, or a multimodal model. In some embodiments, multiple models may be stored in the non-volatile memory and switched without DRAM or without loading model weights into dynamic random access memory (DRAM) prior to inference. In other embodiments, DRAM may be present but is not utilized for storing model weights during inference.

Method 630 may improve the operation of a computing device by accelerating inference through the reuse of pre-processed hidden states. By pre-processing context data offline and storing compact hidden states for later retrieval, the processing system may eliminate redundant computation during query-time operations. The processing system may read model weights directly from non-volatile memory without loading them into DRAM, may maintain intermediate states in on-chip volatile memory, and may generate outputs by performing multiply-accumulate operations using streamed model weights. In other embodiments, DRAM may be present but not utilized for storing model weights during inference. These operations may collectively reduce memory traffic, lower computational demand, decrease power consumption, and improve response latency on edge devices with constrained resources. A non-transitory computer-readable medium may store instructions that configure the processing system to pre-process context data to generate hidden states, store the hidden states, retrieve the hidden states to resume inference, and perform inference using a recurrent model with a fixed-size hidden state.

In some embodiments, the processing system may implement functionality to combine multiple stored hidden state obtained through precomputations from different information sources.

In some embodiments, the processing system may implement a single-source retrieval component by selecting one information source from the knowledge base, loading the associated stored hidden state obtained through precomputation, and initializing the SSM with that hidden state. This operation may improve memory efficiency compared to transformer architectures, but it may encounter limitations when queries require information from multiple sources.

When the processing system implements single-source retrieval, computing one token through an LLM may involve multiplying the embedding-dimension vector by all parameters in the network. Because network connections are dense, the processing system may load the complete parameter set for each token. Edge devices often lack memory capacity to store the parameters in full, so the processing system may reload them for every token. With billions of parameters, this repeated reloading may create a throughput bottleneck.

When the processing system processes queries that require synthesis of information from multiple sources, single-source retrieval may present architectural constraints that limit performance.

In some embodiments, the processing system may retrieve and use one hidden state from the most relevant chunk, but it may not generate a complete response when the query depends on multiple chunks. Real-world queries often require synthesis across several sections of documents or across different knowledge sources. For example, when the processing system processes a query about troubleshooting refrigerator temperature issues, it may need to combine information from chunks that address temperature settings, diagnostic procedures, and maintenance requirements. A single-chunk approach may force users to submit multiple sequential queries or accept incomplete responses.

When the processing system processes queries that require comparison, correlation, or analysis across multiple sources, single-source retrieval may produce incomplete responses. For example, when the processing system processes a query such as “Compare energy efficiency settings across different operating modes” or “What are the safety considerations when using multiple appliance features simultaneously,” a response derived from one chunk may not provide complete context.

When the processing system operates in single-chunk retrieval mode, it may generate responses that are technically correct but contextually incomplete because they exclude information from other sources. This limitation may result in partial answers that may mislead a user or require additional queries to obtain complete context.

In some embodiments, the processing system may implement a multi-source hidden state fusion system to overcome the limitations of single-source retrieval. The processing system may combine multiple stored hidden state obtained through precomputations from different information sources in a precog-enabled configuration. By doing so, the processing system may generate multi-source responses while maintaining computational and memory efficiency suitable for edge deployment.

In some embodiments, the processing system may extend single-source retrieval by implementing a multi-source hidden state fusion system that preserves efficiency while supporting synthesis across multiple sources. The processing system may precompute hidden states for information sources associated with a document and may store those hidden states for later retrieval. The processing system may process each block of known text through the LLM network once, including offline processing on a server-class processor such as a GPU. The processing system may then save each stored hidden state obtained through precomputation in compact form and may load the hidden state only when needed. When needed, the processing system may load the hidden state for the selected RAG chunk rather than the entire document. Because RAG chunks are typically larger than the user query, this approach may reduce compute and memory operations, accelerate response time, and reduce power consumption.

In some embodiments, the processing system may implement the multi-source hidden state fusion system by applying a mathematical fusion algorithm at the hidden state level. The processing system may combine multiple precomputed contextual representations without reprocessing the original information sources. The multi-source system may include multiple stages, such as multi-source retrieval, relevance scoring, and hidden state fusion.

In some embodiments, the processing system may implement a multi-source hidden state fusion system that processes queries requiring synthesis across multiple sources. Instead of retrieving one hidden state, the processing system may retrieve multiple hidden states based on query-source relevance metrics. The processing system may combine the retrieved hidden states using mathematical fusion techniques to create a unified starting state for the SSM. From this unified state, the processing system may process the query and may generate a response that synthesizes information across multiple sources.

In some embodiments, the processing system may implement the combination of multiple stored hidden state obtained through precomputations, each associated with a different information source, through a hidden state fusion algorithm. The algorithm may combine the hidden states using configurable mathematical operations that preserve SSM properties. The processing system may further implement query-adaptive multi-retrieval with intelligent source selection to determine the number of hidden states to combine based on query characteristics. The processing system may also implement an edge-optimized architecture that supports memory-efficient processing by combining hidden states without simultaneously loading all sources.

In some embodiments, the processing system may retrieve multiple information sources based on query-chunk relevance scores. The processing system may calculate the relevance scores using keyword matching, semantic similarity from a vector search, and question-answer relationship evaluation. After retrieval, the processing system may combine the associated stored hidden state obtained through precomputations through weighted averaging.

In some embodiments, the processing system may compute the fused hidden state according to the following formula:

$$Combined\_Hidden \_Sate = \sum ( weight\_i \times hidden\_state \_i ) ,$$

In some embodiments, the processing system may dynamically calculate the weights based on query chunk relevance scores. The processing system may further implement query adaptive k selection to determine the number of chunks to retrieve and combine based on query complexity metrics. The processing system may also implement a memory efficient streaming combination by processing the hidden states sequentially or in small batches to reduce memory footprint during fusion.

In some embodiments, the processing system may implement the combination of multiple stored hidden state obtained through precomputations, each associated with a different information source, as a multi-stage retrieval and fusion process. The multi-stage system may extend the precog architecture described above to process multiple information sources in parallel.

In some embodiments, the processing system may extend the precog architecture by implementing a multi-source hidden state fusion system that maintains computational efficiency while supporting multi-source synthesis. The processing system may execute a mathematical fusion algorithm at the hidden state level, combining multiple precomputed contextual representations without reprocessing the original information sources. The system architecture may include multiple processing stages such as multi-source retrieval, relevance scoring, and layer-wise hidden state fusion.

In some embodiments, the processing system may implement the combination of multiple stored hidden state obtained through precomputations, each associated with a different information source, as a multi-stage retrieval and fusion process. This process may extend the precog architecture described above so that the processing system handles multiple information sources at the same time.

In some embodiments, the processing system may extend the precog architecture by implementing a multi-source hidden state fusion system that preserves computational efficiency while supporting synthesis of information from multiple sources. In these embodiments, the processing system may apply a mathematical fusion algorithm at the hidden state level. The algorithm may combine multiple precomputed contextual representations without reprocessing the original information sources. The processing system may implement the multi-source fusion system through multiple stages that include multi-source retrieval, relevance scoring, and layer-wise hidden state fusion. Further details of these stages are described below.

In some embodiments, the processing system may implement a multi-source retrieval phase. The processing system may process a user query through one or more encoding models to generate a query representation in a high-dimensional space. The processing system may perform retrieval operations using indexing methods and similarity metrics to identify the top-k relevant sources. The value of k may be determined based on configurable criteria such as query characteristics, available resources, or application requirements. Each retrieved source may include an associated stored hidden state obtained through precomputation generated during precog processing and stored in a format compatible with the model architecture.

In some embodiments, the processing system may implement a relevance scoring process. The processing system may combine outputs of multiple scoring mechanisms using a configurable weighting scheme. The processing system may apply lexical matching algorithms to measure exact term relevance, may apply neural re-ranking models to evaluate semantic relationships, and may apply vector similarity measures such as cosine similarity to evaluate semantic closeness. The processing system may adjust the weighting of these scoring methods in a configurable manner to balance different relevance criteria. By combining multiple metrics rather than a single metric, the processing system may improve accuracy of source selection.

In some embodiments, the processing system may implement a layer-wise hidden state fusion process. The processing system may apply a mathematical combination algorithm that preserves the mathematical properties of the SSM while supporting synthesis of information from multiple sources. The processing system may combine hidden state representations from multiple sources using relevance-based weighting schemes. The processing system may apply consistent fusion parameters across layers so that dimensional consistency is maintained throughout the network. The processing system may perform the fusion independently at each model layer, which may allow the SSM to preserve mathematical integrity while synthesizing information across multiple sources.

In some embodiments, the processing system may implement a multi-source hidden state fusion system configured to execute a RAG process that uses multiple information sources as described herein. When the processing system retrieves information that has already been precomputed into hidden states, the system may reduce the time required to generate responses. The user may then wait only for the query tokens to be processed and for the response tokens to be generated.

For example, the processing system may process a fifteen-word query in approximately three seconds. This response time may be substantially shorter than the time required for a system that does not rely on stored hidden state obtained through precomputations, where processing may extend into tens of seconds or longer. As such, the processing system may therefore provide response times that remain below the threshold of user perception.

In some embodiments, the processing system may process tokens faster than a user may enter them through speech or typed text. As a result, the user may not perceive delay during input (i.e., there is no user-perceivable delay). Similarly, the processing system may generate response tokens faster than a user is able to read or listen to them, which may provide a seamless user experience. In this configuration, processing wait times may be negligible from the perspective of the user, even on edge devices with constrained resources.

In some implementations, the multi-source systems and methods described herein, configured to combine multiple different information sources, may be specifically adapted to the proprietary TENNs SSM systems, creating synergistic advantages unavailable to systems using standard transformers. In some embodiments, the systems thus configured may open new use cases, employments, and/or markets in healthcare, legal, engineering, and scientific applications requiring comprehensive information analysis.

In some embodiments, the processing system may implement a multi-source hidden state fusion system that combines information from multiple sources while preserving the efficiency advantages of precog processing. When the processing system executes a TENNs model, the system may maintain a memory footprint on the order of 8 KB per hidden state, compared to approximately 8 MB for transformer architectures. This 1000-fold reduction in memory size may be preserved even when the processing system combines hidden states from multiple sources. The compact representation may allow the processing system to store and retrieve hidden states using standard memory such as DDR4 or DDR5 SDRAM, rather than relying on high-speed memory components. By doing so, the processing system may support deployment on cost-effective edge devices while maintaining offline operation and delivering performance suited for enterprise-grade applications.

In some embodiments, the processing system may implement a configurable multi-stage scoring process when combining multiple stored hidden state obtained through precomputations. The processing system may calculate relevance scores using methods such as cross-encoder evaluation, cosine similarity, and BM25Plus. In some implementations, the processing system may apply domain-specific optimization or expert-defined weight configurations to achieve performance tailored to the application. The processing system may also monitor weight assignments to avoid incorrect allocation of weights across hidden states. Incorrect weight assignment may lead the processing system to select irrelevant or contradictory chunks, which may result in generation of responses that appear confident but are factually incorrect.

In some embodiments, the processing system may execute a generation model that requires specialized training to process fused hidden states. The training may prepare the generation model to combine information from multiple hidden states and to generate responses that attribute and balance content from different information sources. Standard training of language models often focuses on single-context generation, which may not prepare the processing system to operate effectively in multi-source contexts created through hidden state fusion. Without specialized training, the generation model may not be adequate to handle complex multi-source information environments, and the processing system may not generate coherent responses that correctly integrate information from multiple sources.

In some embodiments, the processing system may implement a method for executing an LLM on an edge device by representing multi-source system prompts with multiple initial hidden states of a recurrent network. The initial hidden states may be tuned during training so that multiple task-specific system prompts from different sources may prime the recurrent network for downstream tasks that require synthesis of information across multiple sources.

In some embodiments, the processing system may configure the recurrent network to ingest multiple system prompts and to produce multiple hidden states that represent the different contextual sources. During inference, the processing system may initialize the recurrent network with multiple precomputed internal states that are combined through weighted fusion, without re-ingesting the system prompts.

In some embodiments, the processing system may configure the initial hidden states to remain trainable during a fine-tuning stage for multi-source downstream tasks. The fusion weights may be optimized end-to-end so that the processing system improves the effectiveness of multi-source information synthesis.

In some embodiments, the processing system may initialize the internal states from multiple random vectors or zero vectors. During training, the processing system may adapt these initial vectors to learn multi-source representations without explicitly constructing multi-source system prompts.

In some embodiments, the processing system may implement a method for executing an LLM on an edge device with multi-chunk fusion using self-keys. Each hidden state may be configured as auto-keying so that the hidden state forms its own key for efficient retrieval.

In some embodiments, the processing system may implement a matching mechanism to compute similarity measures between the hidden state of the input query and multiple stored hidden state obtained through precomputations associated with different chunks. The similarity measures may include dot products, hand-crafted similarity measures, learned similarity measures, or hybrid combinations of these approaches.

In some embodiments, the processing system may mathematically fuse multiple selected hidden states using a weighted combination. The processing system may calculate the weights based on the similarity measures.

In some embodiments, the processing system may implement query-adaptive weight calculation. The query-adaptive weight calculation may automatically increase the contribution of the most relevant chunks based on real-time relevance analysis.

In some embodiments, the processing system may implement a method for executing an LLM on an edge device with multi-chunk fusion that includes integration with a microphone and a voice-to-text algorithm. The processing system may process spoken queries through the voice-to-text algorithm and may synthesize information across multiple sources to generate a response.

In some embodiments, the processing system may operate in conjunction with one or more feedback devices. The feedback devices may include synthetic voice output, a visual display, a tactile display, or another auditory interface. The processing system may generate responses that incorporate information from multiple sources and may deliver the responses to the user through these feedback devices.

In some embodiments, the processing system may provide real-time processing capabilities that support interactive multi-source query handling. The processing system may generate responses suitable for conversational interfaces and accessibility applications that require information synthesis across multiple knowledge sources.

In some embodiments, the processing system may implement a method for executing an LLM on an edge device with multi-chunk fusion that includes integration with a microphone and a voice-to-text algorithm. The processing system may process spoken queries through the voice-to-text algorithm and may synthesize information across multiple sources to generate a response. The processing system may also operate in conjunction with feedback devices such as synthetic voice output, a visual display, a tactile display, or another auditory interface. The processing system may generate responses that incorporate information from multiple sources and may deliver the responses through one or more of the feedback devices. In some embodiments, the processing system may provide real-time processing that supports interactive query handling. The processing system may generate responses suitable for conversational interfaces and accessibility applications that require synthesis across multiple knowledge sources.

In some embodiments, as described in example implementations below, the processing system executing a multi-source precog method may achieve performance improvements compared to a single-source implementation or transformer-based alternatives. The processing system may maintain efficient token generation rates while avoiding reprocessing of entire document collections for each query. The memory footprint may increase sub-linearly with the number of sources combined, preserving orders of magnitude advantage over transformer models that require complete model loading for equivalent multi-document processing.

In some embodiments, the processing system may also provide advantages compared to alternative methods for combining multiple information sources. In one alternative, a system may attempt to process multiple retrieved chunks through the complete LLM pipeline at query time. Such a method may abandon the precomputation benefits of precog by concatenating multiple information sources with the user query and processing the entire sequence through the SSM from initialization. This approach may require reloading billions of parameters for each token across multiple chunks, thereby increasing processing time from seconds to minutes and consuming memory bandwidth beyond the limits of edge devices.

In some embodiments, alternative methods for combining multiple hidden states associated with different information sources may involve offloading multi-chunk queries to cloud infrastructure. In such an alternative, the processing system on the edge device may transmit the query and related context to a cloud server for analysis, while continuing to execute single-chunk retrieval locally. A cloud server may perform multi-chunk reprocessing, transformer-based multi-document analysis, and complex attention operations without memory constraints.

Although such offloading may leverage abundant cloud resources, it may undermine the advantages of edge deployment. Network communication introduces latency, often on the order of 100 to 500 milliseconds, which may degrade responsiveness for interactive use cases. The multi-source precog systems described herein provide advantages over this approach by retaining computation on the edge device. By fusing stored hidden state obtained through precomputations locally, the processing system may preserve precog efficiency and avoid latency penalties while generating multi-source responses with quality comparable to cloud-based analysis.

In some embodiments, the processing system may operate the multi-source architecture on cost-effective standard-performance memory such as DDR4 or DDR5 SDRAM, rather than high-bandwidth memory components. This configuration may permit deployment of the processing system on edge devices with constrained resources while maintaining efficient query processing.

In some embodiments, the processing system may address limitations of single-source precomputation implementations while maintaining the computational advantages of precog processing. A single-source configuration may require sequential queries or may provide incomplete responses when the requested information spans multiple sources. By contrast, the processing system executing a multi-source fusion system may synthesize information from multiple sources in a single query cycle. The processing system may preserve the mathematical properties of the SSM when combining multiple hidden states so that the computational behavior of multi-source fusion remains consistent with single-source processing.

In some embodiments, the processing system may implement adaptive weight calculation during fusion. The processing system may emphasize the most relevant sources based on real-time relevance analysis rather than requiring manual selection or sequential refinement. This adaptive weighting may allow the processing system to process queries that require comparison, correlation, or analysis across multiple domains. The processing system may provide balanced responses while maintaining processing efficiency suited for deployment on edge devices.

In some embodiments, an edge device may execute an SSM for RAG to provide on-device natural language responses. The processing system may receive tokens from text entry or voice input, embed the tokens, and retrieve one or more stored hidden state obtained through precomputations from memory using a key. A fused hidden state may be formed when multiple sources are relevant. The SSM may initialize from the hidden state, advance across the query tokens, and form output tokens. The device may present the output tokens on a display or may render them as audio through a speaker.

These operations may improve the performance of the device by, for example, reducing memory traffic, latency, and power use. Compact hidden states may replace large context sequences and allow the device to operate within standard memory limits. Measurements described in this specification show examples of reduced footprint and faster response time compared to transformer-based caches. The same path may extend to voice interaction, multi-source fusion, or interactive editing through rollback of hidden states, all while maintaining low latency.

The disclosed arrangements may be realized as methods, systems, or storage media. A method may include receiving a query, embedding tokens, retrieving and initializing with a hidden state, advancing the SSM across query tokens, and providing the output through the device interface. A system may include a SoC, memory, an SSM with fixed-length hidden state, and output interfaces such as a display or speaker. A storage medium may store instructions that configure the processing system to perform these steps. Inputs may include text or speech or other tokens, outputs may include visual or audio or tactile presentation, and operation order or combinations may vary while remaining consistent with these teachings.

In some embodiments, the disclosed subject matter may be realized in any suitable form, including methods performed by a processing system, systems that integrate hardware and software components, computer-readable media that store instructions to configure such systems, or devices that present inputs and outputs through visual, audio, or tactile interfaces, with variations in order, combination, or implementation all considered within the scope of this disclosure.

In some embodiments, the disclosed subject matter may be applied to different technical purposes within defined fields of technology. For example, the processing system may be configured for on-device natural language processing to support text query response, for speech interaction to process audio input and generate spoken output, for medical monitoring to analyze physiological signals such as heart rate or respiration, or for video analysis to process image or video streams for detection or classification tasks. In each case, the technical effect may include reduced memory traffic, lower latency, and decreased power consumption during sequence processing, which may enable real-time responses on devices with constrained resources. The same subject matter may also extend to other domains where compact hidden states and efficient sequence handling improve the operation of a computing device.

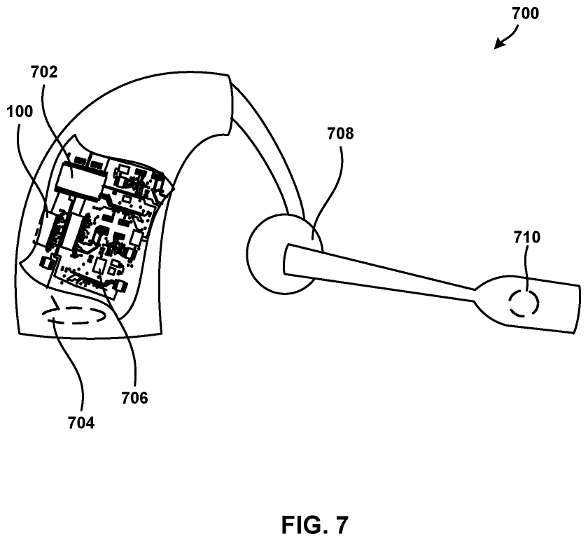

FIG. 7 is a component block diagram of an edge device in the form of a headset 700 suitable for use with various embodiments. With reference to FIGS. 1-7, various embodiments may be implemented on a variety of edge devices, an example of which is illustrated in FIG. 7 as a wearable computing device in the form of a headset 700. A headset 700 may include a SoC 100 coupled to memory 702 (e.g., DDR4/DDR5 SDRAM, etc.), an antenna 704, a wireless transceiver 706, a speaker 708, and a microphone 710, any or all of which may be coupled to each other and/or to one or more processors 120-132 in the SoC 100. The memory 702 may include standard-performance memory, high-performance memory, volatile memory, non-volatile memory, dynamic memory, static memory, or any combination thereof (e.g., static memory and standard-performance volatile memory, etc.). The headset 700 may include flash storage accessible through a serial interface such as UFS with MIPI M-Phy for storing model weights. In some embodiments, the headset 700 may operate without DRAM by reading model weights directly from flash storage and maintaining intermediate computational states in on-chip SRAM within the SoC 100. The flash-based architecture may support the compact form factor of a wearable device such as the headset 700 because non-volatile memory (e.g., flash memory) may be more compact in area than DRAM and uses serial interfaces with a smaller footprint compared to parallel DRAM interfaces. The headset 700 may support on-device natural language processing through the microphone 710 and speaker 708. For example, the processing system may process spoken queries received through the microphone 710 using a voice-to-text algorithm, retrieve a precomputed hidden state from memory, process the query tokens through a SSM initialized with the retrieved hidden state, generate answer tokens, and render the response as audio through the speaker 708. The precomputed hidden states may be stored in non-volatile memory (e.g., flash memory) and loaded into on-chip SRAM during query-time operations. In some embodiments, the headset 700 may store multiple models or multiple precomputed hidden states in non-volatile memory (e.g., flash memory) and may switch between models or contexts without requiring DRAM.

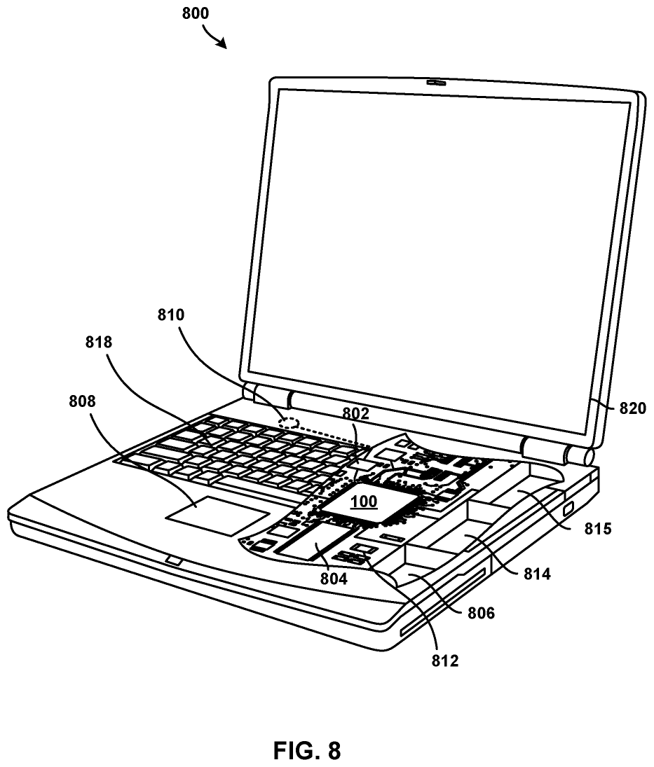

FIG. 8 is a component block diagram of an edge device 800 suitable for use with various embodiments. With reference to FIGS. 1-8, various embodiments may be implemented on a variety of edge devices, an example of which is illustrated in FIG. 8 in the form of a laptop computer 800. A laptop 800 may include a SoC 100 and/or a processor 802 coupled to a memory 804, which may include standard-performance memory, high-performance memory, volatile memory, non-volatile memory, dynamic memory, static memory, or any combination thereof. For example, memory 804 may include dynamic random-access memory (DRAM) for volatile storage and non-volatile memory such as flash or solid-state storage, such as a Non-Volatile Memory Express (NVMe) solid-state drive (SSD) 806. The laptop 800 may include multiple antennas 810 designed to support various wireless communication standards, including Wi-Fi 6/6E, 5G cellular connectivity, and Bluetooth. These antennas are connected to a wireless data link and a cellular transceiver 812, both of which are coupled to the processor 802. In addition, the laptop 800 may include a precision touchpad 808 that supports multi-touch gestures and other modern input/output peripherals, such as a backlit keyboard 818 and a high-resolution display 820 (e.g., 4K OLED or Mini-LED). The laptop 800 may also include biometric sensors for authentication, such as a fingerprint reader or facial recognition, all of which are integrated and controlled by the processor 802. The laptop 800 may include flash storage accessible through a serial interface such as UFS with MIPI M-Phy for storing model weights. In some embodiments, the laptop 800 may operate without DRAM for LLM inference by reading model weights directly from flash storage or from the solid-state drive 806 and maintaining intermediate computational states in on-chip SRAM within the SoC 100. The laptop 800 may support on-device natural language processing through the keyboard 818, the touchpad 808, and the display 820. For example, the processing system may receive typed queries through the keyboard 818, retrieve a precomputed hidden state from memory, process the query tokens through a SSM initialized with the retrieved hidden state, generate answer tokens, and render the response on the display 820. In some embodiments, the laptop 800 may store multiple models or multiple precomputed hidden states in flash storage or the solid-state drive 806 and may switch between models or contexts without requiring DRAM for weight storage.

The accompanying drawings, which are incorporated herein and constitute part of this specification, illustrate exemplary aspects of the invention and, together with the general description given above and the detailed description given below, serve to explain the features of the invention.

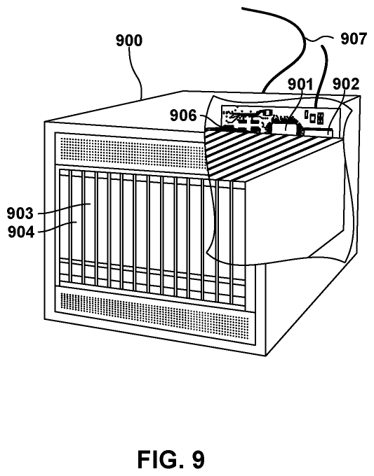

All or portions of some embodiments may be implemented in the cloud or on a variety of commercially available computing devices, such as the server device 900 illustrated in FIG. 9. The server device 900 may include one or more processors 901 (e.g., multi-core processor, etc.) coupled to volatile memory 902, such as RAM, and a large capacity nonvolatile memory, such as a solid-state drive (SSD) 903. The server device 900 may also include additional storage interfaces, such as USB ports and NVMe slots, coupled to the processor 901. The server device 900 may include network access ports 906 coupled to the processor 901 that allow data connections through a network interface card (NIC) 904 and a communication network 907 (e.g., an Internet Protocol (IP) network) connected to other network elements. The server device 900 may perform offline precomputation of hidden states for document chunks, corpora, or other context data. The server device 900 may process large volumes of context data through a SSM to generate stored hidden states and may transfer the stored hidden states to edge devices for use during query-time operations. For example, the server device 900 may precompute hidden states for user manuals, frequently asked questions, or technical documentation and may distribute the precomputed hidden states to edge devices such as the headset 700 or the laptop computer 800 through the communication network 907. The server device 900 may also host training and fine-tuning operations for SSMs. The server device 900 may train model weights and may transfer the trained weights to edge devices for storage in non-volatile memory (e.g., flash memory). By performing computationally intensive training and precomputation on the server device 900, the edge devices may focus on query-time inference operations using the optional-DRAM (indicated by the dashed lines) flash-based architecture described herein. In some embodiments, the server device 900 may store model weights in the solid-state drive 903 and may perform inference operations using DRAM-based or GPU-accelerated architectures. The server device 900 may complement edge devices by handling queries that exceed the computational capacity of the edge device or by providing updated hidden states and model weights through the communication network 907.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc., could be used to achieve a desired result or a specific outcome. It should also be understood that the descriptions herein do not preclude the integration or adaptation of different embodiments of the methods, blocks, operations, etc., from producing a modified or alternative result or solution. The presentation of individual methods, blocks, operations, etc., should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Servers often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

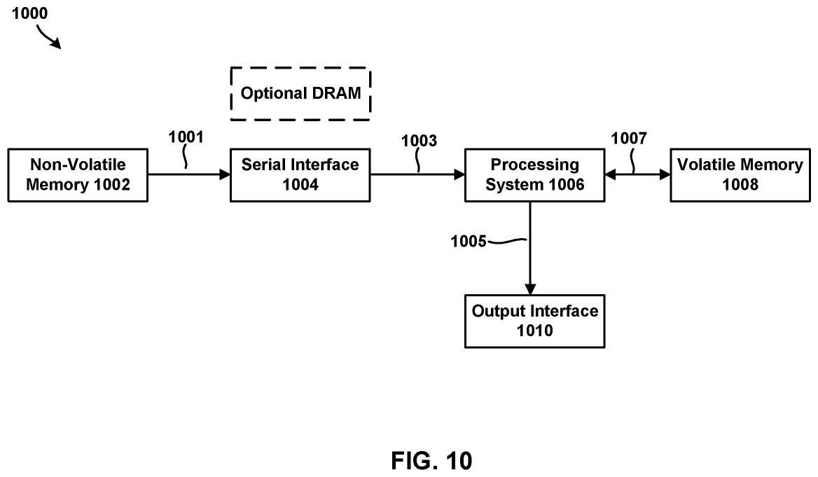

FIG. 10 is a block diagram illustrating a system 1000 configured for direct-from-non-volatile-memory neural network model inference without loading model weights into dynamic random-access memory prior to inference in accordance with some embodiments. The system 1000 may include a non-volatile memory 1002, a serial interface 1004, a processing system 1006, an on-chip volatile memory 1008, and an output interface 1010. The non-volatile memory 1002 may include flash memory, magnetoresistive RAM (MRAM), resistive RAM (ReRAM), phase-change memory (PCM), or other non-volatile storage technologies. The on-chip volatile memory 1008 may include static random-access memory (SRAM), registers, or scratchpad memory. The system 1000 may read model parameters from the non-volatile memory 1002 without first transferring the model weights to dynamic random-access memory, while maintaining intermediate states in the on-chip volatile memory 1008. This configuration may support reduced power consumption and simplified memory architecture compared to systems that load model weights into dynamic random-access memory prior to inference.

The non-volatile memory 1002 may store model weights of a neural network model persistently. The model weights may include layer parameters, bias values, normalization coefficients, and embedding tables for a SSM or other recurrent computational model. The non-volatile memory 1002 may include flash memory such as NAND flash with up to four bits per cell, or may include other non-volatile memory technologies such as MRAM, ReRAM, or PCM. In some embodiments, the non-volatile memory 1002 may store a one-billion-parameter model or multiple models on a single chip, allowing the system to switch between models without requiring external storage or network access. The non-volatile memory 1002 may be co-packaged with the processing system 1006 in a stacked or chiplet design, which may reduce interconnect length and improve data transfer efficiency. In some embodiments, the non-volatile memory 1002 may also store precomputed hidden states for document chunks, corpora, or other context data used in retrieval-augmented generation. The non-volatile memory 1002 may provide data 1001 to the serial interface 1004.

The serial interface 1004 may receive data from the non-volatile memory 1002 and may provide data 1003 to the processing system 1006. The serial interface 1004 may conform to the JEDEC Universal Flash Storage (UFS) standard and may use MIPI M-Phy as the physical layer. In some embodiments, the serial interface 1004 may achieve 4.2 gigabytes per second per serial lane, and the non-volatile memory 1002 may support four lanes or eight lanes for increased aggregate bandwidth. The serial interface 1004 may consume approximately 50 to 160 milliwatts at maximum throughput, which is substantially less than the 1.5 to 5 watts consumed by DRAM controllers in conventional architectures. The serial interface 1004 may support streaming weights over the serial interface concurrently with multiply-accumulate operations performed by the processing system 1006. The serial interface 1004 may support sequential data transfer patterns that match the predictable weight read patterns of SSM inference, where greater than ninety-nine percent of memory operations are predictable read operations and random access is not required. For example, the serial interface 1004 may transfer model weights layer by layer in a predetermined sequence, allowing the non-volatile memory controller to prefetch data efficiently.

The processing system 1006 may receive the streamed model weights through the serial interface 1004 and may perform inference operations without first transferring the weights to DRAM. The processing system 1006 may include a compute engine that performs multiply-accumulate (MAC) operations using the received weights. The processing system 1006 may perform approximately one MAC operation per weight per token. For example, for a one-billion-parameter model processing ten tokens per second, the processing system 1006 may perform approximately ten giga-operations per second (10 GOPS). For a one-billion-parameter model processing twenty tokens per second, the processing system 1006 may perform approximately twenty giga-operations per second (20 GOPS). Such workloads may be manageable for edge devices with moderate processing capabilities, such as those with ARM A-class processors, because SSM inference is heavy on memory read but light on compute compared to regular compute workloads. The processing system 1006 may stream weights layer by layer in a pipelined fashion, reading weights for a subsequent layer while computation proceeds on the current layer. For example, as illustrated in FIG. 12, the processing system 1006 may overlap non-volatile memory read operations for layer N+1 with compute operations for layer N, which may hide memory access latency behind computation time. The processing system 1006 may include a neural processing unit, a digital signal processor, or a graphics processing unit. The processing system 1006 may provide data 1007 to the on-chip volatile memory 1008 and may provide data 1005 to the output interface 1010.

The on-chip volatile memory 1008 may temporarily store intermediate computational states during inference operations. The on-chip volatile memory 1008 may include static random-access memory (SRAM), registers, or scratchpad memory. The intermediate states may include hidden state vectors that are maintained between processing steps and updated as each token is processed. For a SSM, the hidden state may have a fixed length that does not grow with context length. For example, a TENNs model with a 2048-element hidden state at 16-bit precision may require approximately 4 kilobytes per layer, and a model with 24 layers may require approximately 96 kilobytes of on-chip volatile memory for the complete hidden state. This is substantially smaller than the 8 to 16 megabytes required for a transformer key-value cache with equivalent context length. The bidirectional connection between the processing system 1006 and the on-chip volatile memory 1008 may indicate that the processing system 1006 may both read from and write to the on-chip volatile memory 1008 during operation. The processing system 1006 may read a stored hidden state from the on-chip volatile memory 1008 to resume processing from a precomputed state, and may write updated hidden states to the on-chip volatile memory 1008 as each token is processed. In some embodiments, the processing system 1006 may selectively write intermediate states back to the non-volatile memory 1002 for persistence across power cycles or for rollback during interactive editing sessions. In some embodiments, the processing system 1006 may transfer at least a portion of the intermediate states from the on-chip volatile memory 1008 to the non-volatile memory 1002 when storage capacity of the on-chip volatile memory 1008 is insufficient to hold all intermediate states or when intermediate states are to be preserved for later use. Write operations may be distributed among multiple memory blocks to manage endurance of the non-volatile memory 1002.

The output interface 1010 may present generated outputs such as response tokens. The output interface 1010 may include a display, a speaker, a tactile display, or another interface for rendering the generated response to a user. For example, the output interface 1010 may render text on a display screen, convert generated tokens to speech through a text-to-speech module, or provide tactile feedback. The processing system 1006 may provide data 1005 to the output interface 1010 as answer tokens are generated.

The system 1000 may illustrate a two-component architecture comprising the non-volatile memory 1002 and the processing system 1006 with integrated on-chip volatile memory 1008. This two-component design may represent a minimum configuration for SSM inference, in contrast to conventional architectures that load model weights into DRAM prior to inference and require separate compute, DRAM, and non-volatile memory components. By reading model weights directly from non-volatile memory without first transferring them to DRAM, the system 1000 may eliminate the DRAM controller that consumes significant power in conventional systems, thereby reducing memory bandwidth requirements, power consumption, and system complexity. Non-volatile memory such as flash may be six to eighteen times more compact in area than DRAM, and the serial interface 1004 may have a smaller footprint compared to parallel DRAM interfaces. The system 1000 may therefore achieve a footprint that is 0.025 to 0.1 times the footprint of a conventional DRAM-based system. The system 1000 may achieve total power consumption under 250 milliwatts, compared to conventional systems that cannot operate below 1.5 to 2.0 watts due to the DRAM controller alone. The system 1000 may algorithmically spread write operations among multiple memory blocks to maximize non-volatile memory endurance, which may extend the operational lifetime of the device beyond typical usage scenarios.

In some embodiments, the system 1000 may support precomputation and query-time operations for retrieval-augmented generation. The processing system 1006 may pre-process context data to generate hidden states, store the hidden states in the on-chip volatile memory 1008 or the non-volatile memory 1002, and later retrieve the hidden states to continue inference without reprocessing the context data. The processing system 1006 may receive a query, retrieve a stored hidden state, load the stored hidden state into the on-chip volatile memory 1008 as an initialization state, and process query tokens through the recurrent computational model from the initialization state to generate answer tokens. In some embodiments, the processing system 1006 may retrieve multiple stored hidden states and may form a fused hidden state by applying a fusion function across the retrieved hidden states. The fused hidden state may serve as the initialization state for multi-source query processing. In some embodiments, the hidden state may be stored as a tuple that includes a key and the hidden state, where the key may comprise an embedding vector or other retrieval index.

The neural network model executed by the system 1000 may include a language model, a speech model, a vision model, a multimodal model, or other neural network architectures that benefit from the optional-DRAM inference approach. For example, the system 1000 may execute models for denoising, automatic speech recognition (ASR), text-to-speech (TTS), radar signal processing, communications signal processing, or audio feature extraction. A non-transitory computer-readable medium may store instructions that configure the processing system 1006 to perform inference using weights stored in the non-volatile memory 1002, stream weights through the serial interface 1004 without loading into DRAM, perform multiply-accumulate computations using the streamed weights concurrently with streaming operations, and maintain intermediate states in the on-chip volatile memory 1008.

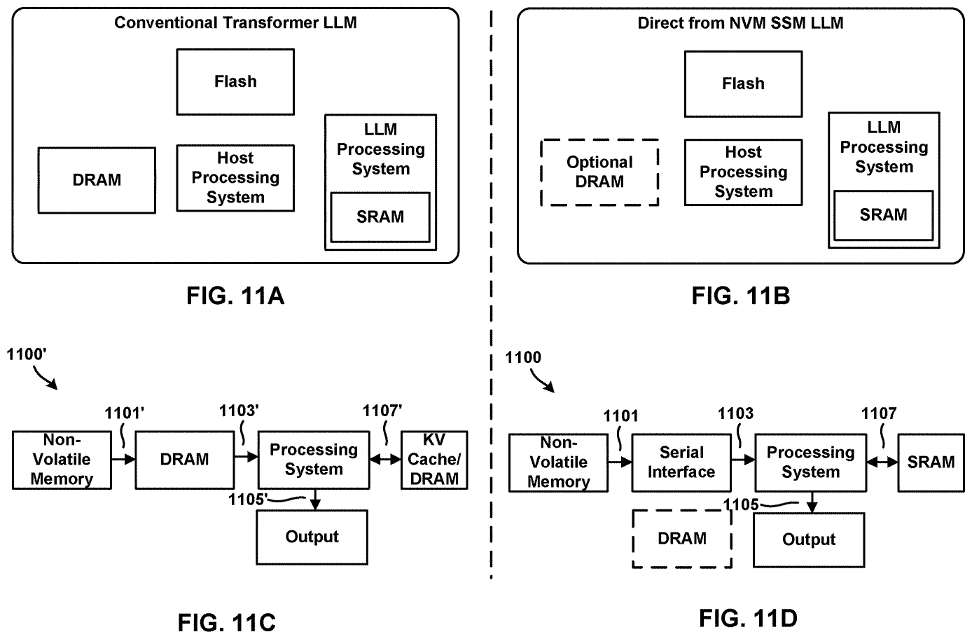

FIGS. 11A-11D show a comparison of conventional systems with systems configured to perform direct-from-non-volatile memory inference, according to some embodiments.

FIGS. 11A and 11B illustrate a comparison between a conventional computing system architecture and a computing system configured in accordance with some embodiments described herein.

FIG. 11A illustrates a conventional architecture in accordance with some embodiments. In this architecture, model weights stored in non-volatile memory may be, in a first operation, transferred from the non-volatile memory to dynamic random-access memory (DRAM). For example, the non-volatile memory may include flash memory, MRAM, ReRAM, PCM, or other non-volatile storage technologies, and the DRAM may include DDR4 SDRAM or DDR5 SDRAM. In a second operation, the model weights may be read from DRAM by a compute engine, such as a host processing system or an LLM processing system. In a third operation, the compute engine may perform inference operations using the model weights, and intermediate states may be maintained in DRAM or auxiliary memory such as on-chip SRAM within the LLM processing system. This conventional sequence may require multiple memory transfers, including a transfer from non-volatile memory to DRAM and subsequent access from DRAM to the compute engine, which may result in increased memory bandwidth usage and power consumption. For example, DRAM controllers may consume 1.5 to 5 watts, which may represent a dominant power sink in the system. The conventional architecture may also require parallel DRAM interfaces that increase system footprint compared to serial interfaces used with non-volatile memory.

FIG. 11B illustrates a computing system configured according to some embodiments described herein. In this architecture, in a first operation, model weights stored in non-volatile memory may be streamed directly from the non-volatile memory to the compute engine without loading the model weights into DRAM. For example, the non-volatile memory may include flash memory, MRAM, ReRAM, or PCM, and the model weights may be streamed through a serial interface such as UFS with MIPI M-Phy. In a second operation, the compute engine may perform multiply-accumulate operations using the streamed model weights. The compute engine may perform approximately one multiply-accumulate operation per weight per token. In a third operation, intermediate states may be maintained in on-chip volatile memory. The on-chip volatile memory may include static random-access memory (SRAM), registers, or scratchpad memory. For a SSM, the intermediate states may include hidden state vectors that have a fixed length that does not grow with context length. The DRAM component present in the conventional architecture of FIG. 11A may be omitted or may not be utilized for storing model weights during inference. As a result, the number of memory transfer operations may be reduced, and the computing system may operate with lower power consumption and reduced hardware footprint. For example, non-volatile memory controllers such as flash controllers may consume approximately 50 to 160 milliwatts at maximum throughput, compared to 1.5 to 5 watts for DRAM controllers. The computing system of FIG. 11B may achieve a footprint that is 0.025 to 0.1 times the footprint of the conventional system of FIG. 11A because non-volatile memory such as flash may be six to eighteen times more compact in area than DRAM and may use serial interfaces with a smaller footprint compared to parallel DRAM interfaces. In some embodiments, streaming and multiply-accumulate operations may occur concurrently, as illustrated in FIG. 12. In some embodiments, memory accesses during inference may be predominantly predictable read operations. In some embodiments, the non-volatile memory may be co-packaged with the compute engine in a stacked or chiplet design.

FIGS. 11C and 11D illustrate a comparison of data flow processes in a conventional system and a system configured according to some embodiments described herein.

FIG. 11C illustrates a data flow process in a conventional transformer-based neural network model architecture that uses dynamic random-access memory in accordance with some embodiments. In a first operation 1101′, model weights and data may be transferred from non-volatile memory to DRAM. The non-volatile memory may include flash memory, MRAM, ReRAM, PCM, or other non-volatile storage technologies. The DRAM may serve as an intermediate storage location that holds the model weights during inference operations. In a second operation 1103′, the DRAM may provide the model weights to a processing system. The processing system may perform inference computations using the weights loaded from DRAM. The processing system may execute the transformer model layers and may generate outputs based on the input tokens and the loaded model parameters. In a third operation 1105′, the processing system may generate output that represents the inference results. The output may include generated tokens or other inference products produced by the transformer model during operation. In a fourth operation, the processing system may communicate with a KV cache stored in DRAM 1107′. The KV cache may store key-value pairs that the transformer architecture maintains during inference. The processing system may both read from and write to the KV cache during inference operations. The KV cache may grow with context length in transformer architectures, which may increase memory requirements as longer sequences are processed. The conventional architecture of FIG. 11C illustrates an approach where DRAM may be required both for loading model weights and for maintaining the KV cache during transformer-based inference. This configuration may contrast with the architecture described in FIG. 11D, which may eliminate DRAM by reading weights directly from non-volatile memory and maintaining compact hidden states in on-chip volatile memory.

FIG. 11D illustrates a data flow process in a system configured for direct-from-non-volatile-memory neural network model inference in accordance with some embodiments. In a first operation, model weights stored in non-volatile memory may be provided to a serial interface 1101. The non-volatile memory may include flash memory, MRAM, ReRAM, PCM, or other non-volatile storage technologies. The serial interface 1101 may conform to standards such as UFS with MIPI M-Phy or other serial protocols. In a second operation, the serial interface 1101 may transfer the model weights to a processing system 1103 without first loading the model weights into DRAM. The processing system 1103 may receive the streamed model weights and may perform inference operations, such as multiply-accumulate (MAC) operations, using the received weights. The processing system 1103 may perform approximately one MAC operation per weight per token. In some embodiments, streaming and multiply-accumulate operations may occur concurrently, such that model weights may be consumed by the processing system 1103 as they are received from the non-volatile memory. In a third operation, the processing system 1103 may generate an output 1105 that represents the inference results, such as response tokens or other generated data. In a fourth operation, the processing system 1103 may exchange data with an on-chip volatile memory, such as SRAM 1107. The on-chip volatile memory may include static random-access memory (SRAM), registers, or scratchpad memory. The processing system 1103 may both read from and write to the on-chip volatile memory during operation. The on-chip volatile memory may store intermediate computational states, such as hidden state vectors, which are maintained between processing steps and updated as each token is processed. For a recurrent computational model such as a SSM, the hidden state may have a fixed length that does not grow with context length. This may contrast with the KV cache of FIG. 11C, which may grow with context length and may require substantially more memory. For example, a SSM hidden state may occupy approximately 4 kilobytes per layer, whereas a transformer KV cache for equivalent context may occupy 8 to 16 megabytes.

The architecture of FIG. 11D may omit DRAM from the inference path. By reading model weights directly from non-volatile memory through the serial interface 1101 without first transferring them to DRAM, the system may eliminate the DRAM controller that consumes significant power in conventional systems. The serial interface 1101 may include interfaces such as UFS with MIPI M-Phy that support efficient data transfer from non-volatile memory. The arrangement of components in FIG. 11D may enable SSM inference operations where model weights are streamed from non-volatile storage and intermediate hidden states are maintained in on-chip volatile memory without requiring external dynamic random-access memory. This configuration may reduce power consumption, memory bandwidth requirements, and system complexity compared to the conventional architecture of FIG. 11C. In some embodiments, the processing system 1103 may selectively write intermediate states back to the non-volatile memory for persistence across power cycles. In some embodiments, write operations may be distributed among multiple memory blocks to manage endurance of the non-volatile memory. In some embodiments, the neural network model may include a language model, a speech model, a vision model, a multimodal model, or other neural network architectures. In some embodiments, multiple models may be stored in the non-volatile memory and switched without DRAM.

FIG. 12 is a sequence diagram illustrating parallel pipelined execution of non-volatile memory read and compute operations across multiple layers of a neural network model in accordance with some embodiments. FIG. 12 illustrates a sequence of operations in which model weight streaming from non-volatile memory and computation by a compute engine may occur concurrently. In conventional systems, model weights may be loaded entirely into DRAM before inference begins, and the compute engine may access the weights from DRAM during each layer computation. This conventional approach may require the full model to reside in DRAM, which may increase power consumption and system footprint. In contrast, the pipelined architecture illustrated in FIG. 12 may stream model weights directly from non-volatile memory to the compute engine without first loading the weights into DRAM, and may overlap streaming operations with computation operations to hide memory access latency behind computation time.

In a first operation, a controller may initiate streaming of model weights corresponding to a first portion of the neural network model from the non-volatile memory. The first portion may correspond to a first layer of the neural network model. For example, the controller may read weights for layer 1 of a SSM from flash storage through a serial interface such as UFS with MIPI M-Phy. The serial interface may transfer the weights in a sequential pattern that matches the predictable read patterns of SSM inference. The controller may prefetch the weights for the first layer while the compute engine prepares for inference.

In a second operation, the compute engine may receive the streamed model weights and may perform multiply-accumulate (MAC) operations to generate partial outputs for the first portion of the neural network model. For example, the compute engine may apply the streamed weights for layer 1 to the input token embeddings and may update the hidden state for that layer. The compute engine may perform approximately one MAC operation per weight per token. The partial outputs may include updated hidden state vectors that are stored in on-chip volatile memory, such as static random-access memory (SRAM), registers, or scratchpad memory.

In a third operation, while the compute engine is performing multiply-accumulate operations for the first portion, the controller may stream model weights corresponding to a second portion of the neural network model from the non-volatile memory. The second portion may correspond to a second layer of the neural network model. This overlap between streaming and computation is indicated by overlap period 1201 in FIG. 12. For example, the controller may read weights for layer 2 from the non-volatile memory while the compute engine completes MAC operations for layer 1. By overlapping these operations, the system may avoid idle periods in which either the serial interface or the compute engine would otherwise be waiting.

In a fourth operation, the compute engine may process the second portion of the neural network model using the subsequently streamed model weights. The compute engine may apply the weights for layer 2 to the intermediate hidden state produced by layer 1 and may generate updated partial outputs. While the compute engine processes layer 2, the controller may begin streaming weights for a third layer, as indicated by overlap period 1203 in FIG. 12.

This sequence may continue for successive portions or layers of the neural network model, such that streaming operations and computation operations are overlapped in time. For example, for a model with 24 layers, the controller may stream weights for layer N+1 while the compute engine processes layer N, maintaining continuous utilization of both the serial interface and the compute engine throughout the inference operation.

The overlapping of streaming and computation operations may enable efficient utilization of memory bandwidth and compute resources. The compute engine may consume model weights as they are streamed, thereby avoiding the need to store the full set of model weights in on-chip volatile memory or DRAM. In a conventional system, the compute engine may need to wait for the full model to be loaded into DRAM before beginning inference, which may introduce startup latency and may require DRAM controllers that consume 1.5 to 5 watts. In the pipelined architecture of FIG. 12, the system may begin inference as soon as the first layer weights are available, and the non-volatile memory controller may consume approximately 50 to 160 milliwatts at maximum throughput.

Intermediate states generated during each portion of processing may be stored in on-chip volatile memory and may be updated sequentially as inference progresses through the neural network model. For a SSM, the intermediate states may include hidden state vectors that have a fixed length that does not grow with context length. For example, a TENNs model with a 2048-element hidden state at 16-bit precision may require approximately 4 kilobytes per layer of on-chip volatile memory for the hidden state, regardless of the length of the input sequence. The on-chip volatile memory may include SRAM, registers, or scratchpad memory. Because only the weights for the current layer and the intermediate states need to reside in on-chip memory at any given time, the pipelined architecture may reduce on-chip memory requirements compared to architectures that buffer multiple layers of weights simultaneously.

In some embodiments, the processing system may use multiple serial lanes in parallel to achieve the bandwidth required for real-time inference. For example, the non-volatile memory may support four lanes or eight lanes, each achieving 4.2 gigabytes per second, for an aggregate bandwidth sufficient to stream weights for a one-billion-parameter model at ten to twenty tokens per second. In some embodiments, the neural network model may include a language model, a speech model, a vision model, a multimodal model, or other neural network architectures. In some embodiments, the non-volatile memory may include flash memory, MRAM, ReRAM, PCM, or other non-volatile storage technologies. In some embodiments, the processing system may selectively write intermediate states back to the non-volatile memory for persistence across power cycles, and write operations may be distributed among multiple memory blocks to manage endurance of the non-volatile memory. In some embodiments, the controller may maintain a write count associated with each memory block and may select a target memory block for each write operation based on the write count. In some implementations, the write distribution may be performed irrespective of whether the intermediate state data exceeds a capacity of the on-chip volatile memory

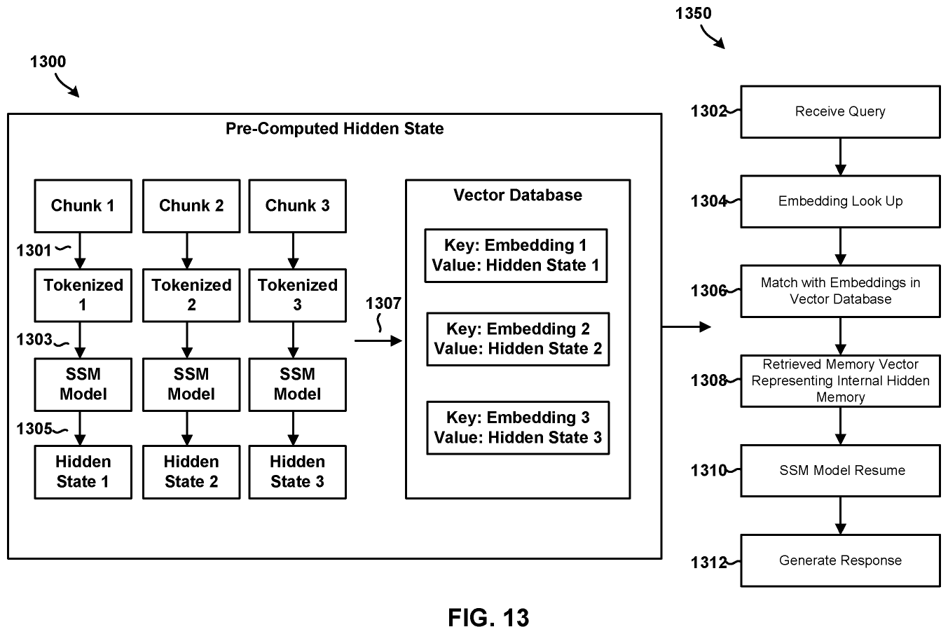

FIG. 13 is a system diagram integrated with a process flow diagram illustrating a pre-computed hidden state architecture integrated with a vector database and used for retrieval-augmented generation in accordance with some embodiments. FIG. 13 illustrates a system 1300 and method 1350 for accelerating inference of a neural network model using precomputed hidden states. The left side of FIG. 13 illustrates a precomputation system 1300 that processes document chunks into hidden states and stores them in a vector database 1307. The right side of FIG. 13 illustrates a query processing flow 1350 that retrieves a stored hidden state and uses it to resume inference without reprocessing the original document chunks.

The system 1300 illustrated on the left side of FIG. 13 may be substantially similar in structure and/or function to the SoC 100 described with reference to FIG. 1, the headset 700 described with reference to FIG. 7, the laptop computer 800 described with reference to FIG. 8, the system 1000 described with reference to FIG. 10, and the system described with reference to FIGS. 11B and 11D. The query processing flow 1350 illustrated on the right side of FIG. 13 may be substantially similar in structure and/or function to method 350 described with reference to FIG. 3D, method 355 described with reference to FIG. 3E, method 400 described with reference to FIG. 4, method 500 described with reference to FIG. 5A, method 520 described with reference to FIG. 5B, method 600 described with reference to FIG. 6A, method 620 described with reference to FIG. 6B, and method 630 described with reference to FIG. 6C. The query processing flow of FIG. 13 may be implemented in any of the systems described with reference to FIGS. 1, 7, 8, 10, 11B, and 11D. The system of FIG. 13 may be used to perform any of the methods described with reference to FIGS. 3D, 3E, 4, 5A, 5B, 6A, 6B, and 6C.

In the precomputation system 1300, context data may be received (for example in RAG mode) and segmented into one or more data chunks, such as Chunk 1, Chunk 2, and Chunk 3. Each data chunk may include a sequence of tokens representing a portion of input data. For example, the data chunks may correspond to sections of a user manual, paragraphs of a technical document, or segments of a frequently asked questions list.

In operation 1301, each data chunk may be provided to a tokenize operation to produce a tokenized representation. For example, Chunk 1 may be tokenized to produce Tokenized 1, Chunk 2 may be tokenized to produce Tokenized 2, and Chunk 3 may be tokenized to produce Tokenized 3. As an example, the tokenize operation may divide each data chunk into discrete units such as words, subwords, or characters and may convert each unit into a numerical representation.

In operation 1303, each tokenized output may be provided as input to a machine learning model (for example, an SSM) to be processed by the model. In some implementations, separate SSM model instances may parallely process the tokenized data for each chunk. The processing system may store model weights of the neural network model in a non-volatile memory and may read the model weights from the non-volatile memory during the processing operation without loading the model weights into dynamic random-access memory (DRAM). The processing system may stream the model weights from the non-volatile memory to a compute engine and may perform multiply-accumulate operations using the streamed model weights. In some embodiments, the SSM may be a TENNs model or another recurrent computational model.

In operation 1305, the SSM models may process the tokenized inputs to generate hidden states, producing, in the example in FIG. 13, Hidden State 1, Hidden State 2, and Hidden State 3. Each hidden state may represent a compact summary of the corresponding data chunk. The hidden state may have a fixed length that does not grow with the length of the data chunk. For example, a TENNs model with a 2048-element hidden state at 16-bit precision may require approximately 4 kilobytes per layer regardless of the number of tokens in the data chunk.

In operation 1307, the hidden states may be stored in a vector database 1307. The vector database may maintain key-value pairs where each key corresponds to an embedding, and each value corresponds to a hidden state. For example, the vector database may store entries including Key: Embedding 1 with Value: Hidden State 1, Key: Embedding 2 with Value: Hidden State 2, and Key: Embedding 3 with Value: Hidden State 3. Each entry may be stored as a tuple [key, hidden_state] where the key may comprise a sentence-embedding vector or other retrieval index. The vector database may be stored in memory accessible to the processing system, for example a non-volatile memory such as flash, MRAM, ReRAM, PCM, and/or the like. In some embodiments, the vector database 1307 may omit storage of source tokens, storing only the key and the hidden state in non-text numeric representation.

On the right side of FIG. 13, the query processing flow 1350 begins with receiving a query at 1302 that may be received by the system 1300. The query may be received as a sequence of tokens from a user interface, voice input processed through a voice-to-text algorithm, or other input mechanism. For example, the processing system may receive a typed question from a user through a text entry field or may receive a spoken question through a microphone and a speech recognition system.

In operation 1304, the query may proceed to an embedding look up, which may generate an embedding representation of the query. The processing system may convert the query tokens into numerical vectors using an embedding layer and may compute a query key by applying the same function used to compute the keys for the stored hidden states, such as a sentence-embedding model or a linear projection.

In operation 1306, the system may perform a match with embeddings in vector database 1307 to identify relevant stored embeddings. The matching operation may include computing one or more similarity metrics such as cosine similarity, nearest neighbor search, or other distance measures between the query representation and the stored keys in the vector database. The processing system may select the stored key that most closely matches the query key based on the similarity score. In some instances, a predefined threshold may be used to determine the close matches.

In operation 1308, based on the matching operation, the system may retrieve from the vector database a memory vector representing an internal hidden memory. The retrieved hidden state may correspond to the hidden state associated with the selected key. For example, if the query relates to content in Chunk 2, the system may retrieve Hidden State 2 from the vector database 1307.

In operation 1310, the retrieved hidden state may be used to initialize the model, for example, the SSM model or invoke the model to resume processing the retrieved hidden state. The SSM model may resume and continue processing from the retrieved state without reprocessing the original document chunks. The processing system may load the retrieved hidden state into on-chip volatile memory, such as static random-access memory (SRAM), registers, or scratchpad memory, as an initialization state. For example, the processing system may copy per-layer vectors of the retrieved hidden state into on-chip SRAM and may set layer registers before the first query token enters the processing pipeline. The processing system may then process the query tokens through the recurrent computational model from the initialization state.

In operation 1312, the system may generate a response to the query by generating answer tokens based on the retrieved hidden state and the query tokens. The processing system may update the hidden state for each query token and may generate an output based on the updated hidden state. The processing system may generate the output by projecting the hidden state through an output layer to produce a probability distribution over candidate next tokens, selecting or sampling from that distribution, and appending a token to extend the output sequence. The generated response may be presented through a display, a speaker, or another output interface.

By storing and reusing hidden states, the system may avoid reprocessing previously processed data, may reduce memory access operations, and may improve inference efficiency, particularly in resource-constrained computing systems. The processing system may read model weights directly from non-volatile memory without loading them into DRAM, may maintain intermediate states in on-chip volatile memory, and may generate outputs by performing multiply-accumulate operations using streamed model weights. In some embodiments, streaming and multiply-accumulate operations may occur concurrently, as illustrated in FIG. 12. In some embodiments, the neural network model may include a language model, a speech model, a vision model, a multimodal model, or other neural network architectures. In some embodiments, multiple models may be stored in the non-volatile memory and switched without DRAM. A non-transitory computer-readable medium may store instructions that configure the processing system to perform the precomputation, storage, retrieval, and inference operations described with reference to FIG. 13.

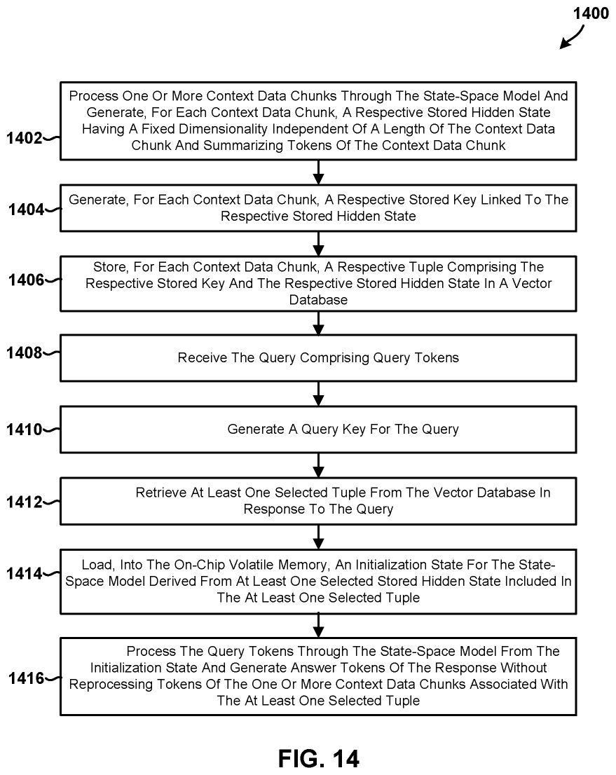

FIG. 14 is a process flow diagram illustrating an example method 1400 for generating a response to a query by reusing precomputed hidden states of a state-space model (SSM) in accordance with some embodiments. Method 1400 may be performed in a computing device by a processing system that includes on-chip volatile memory and one or more processors, such as processors 120-132 and related components or subsystems described in this application. In some embodiments, the processing system may include an applications processor that coordinates tokenization, vector-database access, record management, and control flow, together with an NPU, DSP, GPU, CPU, or other compute engine that executes recurrence operations, projection operations, similarity computations, and output-generation operations of the SSM. In some embodiments, the processing system may store model weights in non-volatile memory, may store tuples in a vector database accessible to the processing system, and may maintain an active hidden state, an intermediate hidden state, or both in SRAM, a register file, cache, or scratchpad memory during precomputation operations and query-time operations. As examples, method 1400 may be executed on an edge device, a laptop computer, a wearable device, a server, or another computing system described in this application.

In some embodiments, the processing system may store model weights of the state-space model in non-volatile memory, may stream the model weights from the non-volatile memory to a compute engine during processing of the one or more context data chunks and during processing of the query tokens without loading the model weights into dynamic random-access memory (DRAM), and may store intermediate state data generated during processing of the one or more context data chunks and during processing of the query tokens in the on-chip volatile memory. For example, a controller of the processing system may read the model weights layer by layer from flash memory, MRAM, ReRAM, PCM, or another non-volatile memory and may deliver the model weights over a serial interface to an NPU, DSP, GPU, CPU, AI processor, or other compute engine while maintaining evolving per-layer hidden-state vectors in SRAM, a register file, or a scratchpad memory, thereby allowing the processing system to execute both precomputation and query-time inference without a DRAM-based weight-loading path.

In some embodiments, the processing system may sequentially access address ranges corresponding to layers of the state-space model over a serial interface comprising UFS with MIPI M-Phy, may overlap streaming of model weights for a subsequent layer with multiply-accumulate operations for a current layer, and may discard model weights for the current layer after completing the multiply-accumulate operations for the current layer. For example, the processing system may prefetch weights for layer N+1 while a compute engine consumes weights for layer N, such that transfer latency is hidden behind computation and only weights for an active layer and, in some implementations, a next layer buffer are held in the processing system at a given time.

In block 1402, the processing system may process one or more context data chunks through the state-space model and generate, for each context data chunk, a respective stored hidden state having a fixed dimensionality independent of the length of the context data chunk and summarizing tokens of the context data chunk. For example, the processing system may segment context data into one or more data chunks, document chunks, text chunks, or multimodal chunks, tokenize each context data chunk into words, subwords, characters, bytes, image patches, audio frames, or other token units, convert the token units into numerical vectors, and process the numerical vectors through one or more layers of the SSM so that each token updates a per-layer hidden state in sequence until final per-layer state vectors are obtained for the context data chunk. In some embodiments, the respective stored hidden state may be a stored hidden state obtained through precomputation and may include one vector per layer, one tensor per layer, one head-wise state tensor, or another fixed-size internal state representation used by the SSM. In some embodiments, the processing system may process the context data chunks on the computing device or on a separate precomputation system and may store the respective stored hidden state in floating-point, quantized, compressed, sparsified, or otherwise encoded form. The respective stored hidden state may serve as a compact representation of the corresponding context data chunk and may preserve contextual information in a form that can later be reused during query-time operations without replaying tokens of that context data chunk. In some embodiments, the processing system may read model weights from non-volatile memory, stream the model weights to a compute engine over a serial interface, and maintain the evolving per-layer hidden state in the on-chip volatile memory while generating the respective stored hidden state.

In block 1404, the processing system may generate, for each context data chunk, a respective stored key linked to the respective stored hidden state. For example, the processing system may compute the respective stored key as a sentence-embedding vector for the context data chunk, as a projection derived from the respective stored hidden state, as an output of a linear transformation, as an output of a multilayer perceptron having fixed parameters, or as a composite retrieval index that includes a semantic vector together with one or more metadata fields such as a corpus identifier, document identifier, chunk identifier, modality identifier, model identifier, source identifier, tenant identifier, or position index. In some embodiments, the processing system may normalize, quantize, hash, whiten, compress, or reduce the dimensionality of the respective stored key before storing the respective stored key in the vector database. In some embodiments, the respective stored key may correspond to the key of a tuple [key, hidden_state] and may be represented as a 128-dimensional, 256-dimensional, 384-dimensional, 768-dimensional, 1024-dimensional, or other vector selected for a retrieval index implementation.

In some embodiments, the processing system may generate, for each context data chunk, the respective stored key as at least one of a sentence-embedding vector for the context data chunk, a linear projection of the respective stored hidden state, or an output of a multilayer perceptron having fixed parameters and receiving the respective stored hidden state as input, and may generate the query key by applying the same key-generation function to the query. For example, the processing system may execute a sentence-embedding model over the context data chunk to generate the respective stored key, may alternatively apply a trained projection matrix or fixed multilayer perceptron to one or more vectors of the respective stored hidden state to generate the respective stored key, and may apply the same embedding model, projection, or multilayer perceptron to the query so that the respective stored key and the query key occupy a common retrieval space.

In block 1406, the processing system may store, for each context data chunk, a respective tuple comprising the respective stored key and the respective stored hidden state in a vector database. For example, the processing system may write, for each context data chunk, a record in the vector database that stores a tuple [key, hidden_state] together with optional metadata including a corpus identifier, document identifier, chunk identifier, chunk boundaries, position index, dimensionality, precision format, compression mode, checksum, freshness information, version information, access-control data, and encryption data, and may organize stored keys using an approximate-nearest-neighbor index, graph-based index, inverted-file index, product-quantized index, tree-based index, hash-based index, or other vector-database structure. In some embodiments, the vector database may reside in flash memory, MRAM, ReRAM, PCM, solid-state storage, DRAM, SRAM, or a hybrid memory hierarchy accessible to the processing system. In some embodiments, the respective tuple may omit source tokens of the context data chunk and may store only the respective stored key and the respective stored hidden state in non-text numeric representation. In some embodiments, the processing system may encrypt the respective tuple at rest, may authenticate access to the respective tuple, and may associate the respective tuple with an SSM version so that the respective stored hidden state remains linked to the model instance that generated it.

In some embodiments, the processing system may store, for each context data chunk, only the respective stored key and the respective stored hidden state in non-text numeric representation in the vector database stored in non-volatile memory and may omit tokens of the context data chunk from the vector database. For example, the processing system may persist a payload comprising a key array and a hidden-state array as fixed-length or variable-length numeric fields in a tuple record, while maintaining optional addressing, versioning, or access metadata in a separate index, header, or side table, thereby allowing the vector database to retain a compact machine-usable representation of the context data chunk without retaining source-token text in the tuple payload.

In some embodiments, the processing system may perform the processing of the one or more context data chunks during a precomputation interval preceding receipt of the query. For example, the processing system may execute the precomputation interval during device provisioning, during a background maintenance interval, while a device is charging or otherwise idle, or on a separate server system before transferring resulting tuples to the computing device, such that subsequent query-time operations may begin from stored hidden states rather than from raw source tokens.

In block 1408, the processing system may receive the query comprising query tokens. For example, the processing system may receive the query from a text-entry interface, a microphone coupled to a speech-recognition subsystem, a camera or optical-character-recognition subsystem, a remote application programming interface, a sensor-processing pipeline, or another software or hardware input path, may tokenize the query according to a tokenization scheme used by the SSM, and may place the query tokens in a buffer accessible to the one or more processors and the on-chip volatile memory. In some embodiments, the query may be a first query associated with a current session and may include text tokens, subword tokens, byte tokens, audio tokens, image tokens, multimodal tokens, control tokens, delimiter tokens, or task tokens. In some embodiments, the processing system may associate the query with session metadata, user-profile data, locale data, access rights, a selected corpus identifier, a latency class, a decoding policy, or an output-mode indication before continuing with query-time operations. In some embodiments, receipt of the query may initiate a runtime portion of method 1400 in which one stored hidden state or multiple stored hidden states are selected for reuse.

In block 1410, the processing system may generate a query key for the query. For example, the processing system may compute the query key by applying to the query the same key-generation function used for the respective stored key, including a sentence-embedding model, a linear projection, a multilayer perceptron, or an SSM pass from a neutral, learned, or zero initialization state followed by a projection, and may optionally normalize the query key by length normalization, mean-centering, whitening, quantization, or L2 normalization. In some embodiments, the query key may correspond to the second key used for retrieval in other portions of this application and may include a semantic vector alone or a composite representation that further includes a corpus identifier, modality tag, task identifier, temporal-context tag, user scope, or security scope. In some embodiments, the processing system may generate the query key from text alone, from text plus speech features, from text plus image features, or from any other modality combination represented by the query. Generating the query key may place the query in the same retrieval space as the stored keys so that the processing system may search the vector database by comparing compact representations instead of replaying the source context data chunks.

In block 1412, the processing system may retrieve at least one selected tuple from the vector database in response to the query. For example, the processing system may compare the query key against stored keys in the vector database using cosine similarity, dot product, Euclidean distance, maximum-inner-product search, lexical-semantic hybrid scoring, or another relevance function, may optionally filter candidate tuples by corpus identifier, document identifier, modality, timestamp, access-control metadata, model version, or user scope, and may select a top-ranked tuple or a top-k set of tuples satisfying a threshold or ranking criterion. In some embodiments, the at least one selected tuple may correspond to a selected record in the vector database and may include one selected tuple for single-source reuse or a plurality of selected tuples for multi-source reuse. In some embodiments, when a target corpus, source document, or chunk identifier is known in advance, the processing system may bypass similarity scoring and may retrieve the at least one selected tuple by exact identifier lookup while retaining the stored key in the same vector-database format for similarity-based retrieval in other cases. In some embodiments, the processing system may read tuple payloads and associated metadata from non-volatile memory into a working buffer for subsequent loading into the SSM. Selecting the at least one selected tuple may narrow query-time processing to context representations that are relevant to the query and may support reuse of one stored hidden state or multiple stored hidden states.

In some embodiments, the processing system may retrieve the at least one selected tuple by comparing the query key to stored keys in the vector database using at least one of nearest-neighbor search or cosine similarity and selecting the at least one selected tuple according to a similarity score. For example, the processing system may submit the query key to a vector index, may compute cosine similarity, dot-product similarity, or another nearest-neighbor score between the query key and stored keys, may rank candidate tuples according to the resulting scores, and may select a highest-ranked tuple or a top-k set of tuples that satisfies a threshold or ranking criterion.

In some embodiments, the processing system may receive a corpus identifier associated with the query and may select the at least one selected tuple according to the corpus identifier while retaining the respective stored key in the vector database for similarity-based retrieval. For example, when a target corpus, document set, product family, tenant, or knowledge domain is known in advance, the processing system may constrain candidate tuples to records tagged with the corpus identifier or may directly select a tuple mapped to the corpus identifier, while preserving the respective stored key in the same tuple format to support later nearest-neighbor or cosine-similarity retrieval across one or more corpora.

In some embodiments, the processing system may retrieve a plurality of selected tuples from the vector database, may determine a relevance score for each selected tuple from the query key, and may combine a plurality of selected stored hidden states from the plurality of selected tuples into a fused hidden state by at least one of a weighted sum or a learned mapper applied per layer, the fused hidden state serving as the initialization state. For example, the processing system may select a top-k set of tuples, may normalize corresponding relevance scores into fusion weights, and may apply the weighted sum or learned mapper independently to each layer or state component so that the fused hidden state preserves the dimensional structure expected by the state-space model while incorporating information from multiple sources.

In block 1414, the processing system may load, into the on-chip volatile memory, an initialization state for the state-space model derived from at least one selected stored hidden state included in the at least one selected tuple. For example, the processing system may read the at least one selected stored hidden state from the at least one selected tuple, may decompress or dequantize the at least one selected stored hidden state when stored in compressed, FP8, INT8, INT4, or another reduced-precision format, and may copy one or more per-layer vectors of the at least one selected stored hidden state into SRAM, a register file, cache, or scratchpad memory by direct memory access or controller-managed burst transfers before a first query token enters an SSM pipeline. In some embodiments, when one selected tuple is retrieved, the initialization state may be the retrieved stored hidden state itself. In some embodiments, when multiple selected tuples are retrieved, the processing system may derive a combined hidden state from the corresponding stored hidden states by weighted combination, layer-wise gating, averaging, concatenation followed by projection, learned mapping, or another fusion operation and may use the combined hidden state as the initialization state. In some embodiments, the processing system may also load auxiliary state data including recurrent coefficients, layer norms, head states, routing weights, masks, or other state values used by the SSM implementation. Loading the initialization state into the on-chip volatile memory may permit the SSM to resume processing from a state that already summarizes selected context while reducing memory bandwidth, latency, and repeated context replay.

In some embodiments, the processing system may transfer, by direct memory access, per-layer vectors of the at least one selected stored hidden state into the on-chip volatile memory and may assign the per-layer vectors to layer registers before processing a first query token from the query. For example, the processing system may read the at least one selected stored hidden state from the vector database, may decompress or dequantize the per-layer vectors when stored in compressed or reduced-precision form, may move the per-layer vectors by DMA into SRAM, cache, or scratchpad memory, and may load corresponding layer registers or state buffers before the first query token enters an SSM pipeline so that query-time processing resumes from the selected context without replaying the associated context data chunk.

In block 1416, the processing system may process the query tokens through the state-space model from the initialization state and generate answer tokens of the response without reprocessing tokens of the one or more context data chunks associated with the at least one selected tuple. For example, the processing system may convert each query token into an embedding vector, may process the embedding vector through the SSM beginning from the initialization state, may update an intermediate hidden state for each query token and for each layer while maintaining active state data in the on-chip volatile memory, and may project an output vector to logits over candidate next tokens and select or sample a next token by greedy selection, beam search, top-k sampling, nucleus sampling, temperature-based sampling, constrained decoding, or another decoding rule. In some embodiments, the SSM may resume query-time operations from the initialization state and may continue autoregressive generation of answer tokens until the processing system detects an end-of-sequence token, a stop string, a response-length threshold, a confidence threshold, or a user interruption. In some embodiments, the processing system may read model weights directly from non-volatile memory during the processing of the query tokens, may stream the model weights to a compute engine over a serial interface without loading the model weights into DRAM, and may overlap transfer of model weights for a subsequent layer with computation for a current layer while maintaining the intermediate hidden state in the on-chip volatile memory. Beginning from the initialization state may allow the processing system to generate the response with the benefit of selected precomputed model context while omitting a second pass over the context data chunks associated with the at least one selected tuple. In some embodiments, the answer tokens may be rendered as text, speech, control commands, visual annotations, multimodal output, or another machine-consumable or user-consumable output.

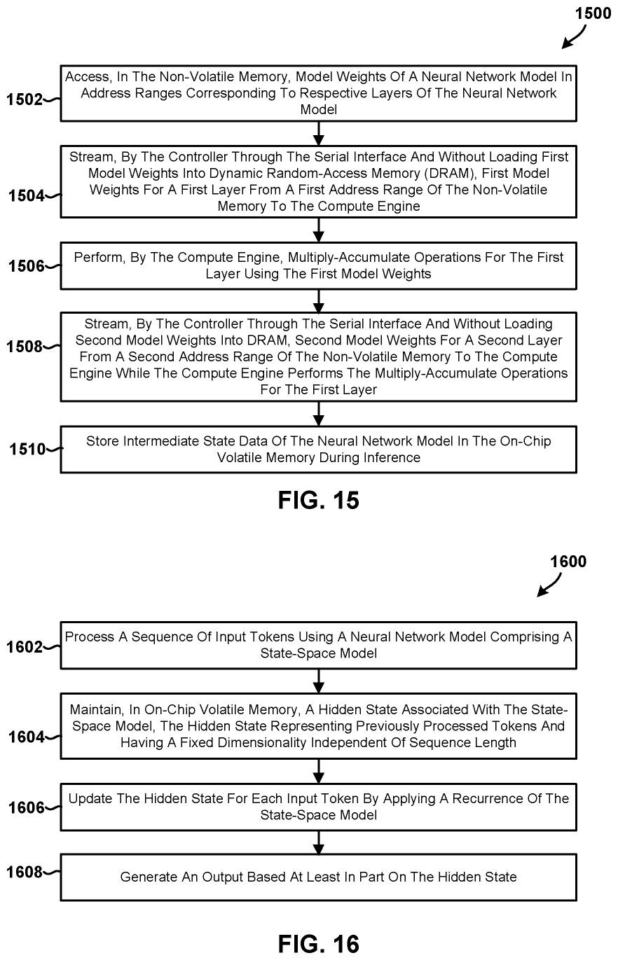

FIG. 15 is a process flow diagram illustrating an example method for performing neural network inference by streaming model weights directly from non-volatile memory to a compute engine without using DRAM. Method 1500 may be performed in a computing device by a processing system that includes on-chip volatile memory and one or more processors, such as processors 120-132 and related components or subsystems described in this application.

In block 1502, the processing system may access, in the non-volatile memory, model weights of a neural network model in address ranges corresponding to respective layers of the neural network model. For example, the controller may maintain a layer map that associates each layer identifier with a base address, length, format indicator, checksum, and version field, and may issue read commands that traverse flash pages, MRAM rows, ReRAM blocks, PCM regions, or other physical storage locations in an order corresponding to execution of the layers. In some embodiments, the address ranges may be contiguous, partially contiguous, tiled, interleaved, compressed, or otherwise organized to support sequential reads, prefetching, or wear management. Organizing the model weights by layer in this manner allows the processing system to fetch only the weights needed for an active layer rather than staging an entire model in working memory.

In some embodiments, the processing system may implement the non-volatile memory as flash memory, magnetoresistive random-access memory (MRAM), resistive random-access memory (ReRAM), phase-change memory (PCM), or another persistent storage technology that supports repeated read access to the model weights. For example, a mobile device or edge appliance may store the model weights in managed NAND flash, while a lower-latency implementation may store at least a portion of the model weights in MRAM, ReRAM, or PCM to reduce access latency for frequently used layers or submodels

In block 1504, the processing system may stream, by the controller through the serial interface and without loading first model weights into dynamic random-access memory (DRAM), first model weights for a first layer from a first address range of the non-volatile memory to the compute engine. For example, the controller may issue a burst read over a UFS, PCIe, SPI, or other serial link, may place arriving weight words into a FIFO, ring buffer, SRAM buffer, or register interface visible to the compute engine, and may transfer the first model weights by DMA or controller-managed writes directly to the compute path for the first layer without creating a DRAM-resident copy. In some embodiments, the first model weights may be provided in floating-point, block-floating-point, INT8, INT4, ternary, sparse, compressed, or packed form and may be decompressed or unpacked on arrival. Streaming the first model weights directly from the non-volatile memory may reduce DRAM traffic, reduce standby memory footprint, and permit execution on devices having limited DRAM capacity.

In block 1506, the processing system may perform, by the compute engine, multiply-accumulate operations for the first layer using the first model weights. For example, the compute engine may read input activations, token embeddings, recurrent state vectors, or other input data from on-chip volatile memory, may multiply the input data by the first model weights, may accumulate partial sums across channels, heads, kernels, or matrix tiles, and may write output activations or intermediate state data back to SRAM, a register file, or a scratchpad memory. In some embodiments, the first layer may be a convolutional layer, linear projection layer, embedding layer, recurrent layer, mixture-of-experts routing layer, normalization-associated projection layer, or another layer type that uses repeated weight-activation products. This computation advances inference for the active layer while keeping the working set small enough to remain predominantly on chip.

In block 1508, the processing system may stream, by the controller through the serial interface and without loading second model weights into DRAM, second model weights for a second layer from a second address range of the non-volatile memory to the compute engine while the compute engine performs the multiply-accumulate operations for the first layer. For example, the controller may prefetch the second model weights into a second buffer while a first buffer feeds the compute engine with the first model weights, and may use double buffering, ping-pong buffering, or another overlapped transfer scheme so that data movement for the second layer proceeds concurrently with computation for the first layer. In some embodiments, the controller may pace the transfer according to a watermark, consumption rate, or available on-chip storage and may stall, reorder, or split transfers when a layer spans multiple address ranges. Overlapping transfer and computation in this manner may hide at least part of the memory-access latency for later layers and may increase effective inference throughput.

In some embodiments, the processing system may configure the serial interface to conform to a Universal Flash Storage (UFS) standard using MIPI M-Phy and may cause the controller to sequentially access the address ranges in a predetermined order that permits prefetching model weights for a subsequent layer. For example, the controller may issue read requests for weight blocks of layer N+1 while layer Nis executing, may maintain a schedule that follows the topological order of layers in the neural network model, and may align address-range boundaries to transfer units supported by the UFS controller so that the prefetch stream remains predictable.

In some embodiments, the processing system may, after completing computation for a given layer, release a buffered copy of model weights for the given layer and repeat the streaming and performing for one or more subsequent layers of the neural network model without loading weights of the one or more subsequent layers into DRAM. For example, once the compute engine has consumed the buffered weight tiles for layer N and the corresponding output activations have been committed to on-chip volatile memory, the controller may invalidate or overwrite the weight buffer for layer N and may reuse that storage for layer N+1 or a later layer so that only a limited number of active-layer weight buffers are retained at a given time.

In block 1510, the processing system may store intermediate state data of the neural network model in the on-chip volatile memory during inference. For example, the processing system may retain activations, hidden-state vectors, partial sums, normalization statistics, gating values, residual values, token embeddings, routing scores, or layer outputs in SRAM, a register file, local cache, or scratchpad memory while the model advances through successive layers. In some embodiments, the intermediate state data may be stored in full precision or reduced precision and may be overwritten, reused, checkpointed, or selectively persisted according to layer boundaries, error-recovery policies, or editing operations. Maintaining the intermediate state data on chip may reduce off-chip traffic and may permit resumed or incremental inference without reconstructing recent state from source inputs.

In some embodiments, the processing system may implement the on-chip volatile memory as static random-access memory (SRAM), a register file, a scratchpad memory, a local cache, or a combination thereof. For example, the processing system may maintain per-layer activations in SRAM, may hold small vector fragments or scalar accumulators in registers, and may use a scratchpad memory for software-managed staging of intermediate state data that is reused across operations within a layer.

In some embodiments, the processing system may selectively write at least a portion of the intermediate state data to the non-volatile memory, may distribute write operations across memory blocks of the non-volatile memory, may track write counts for the memory blocks, and may select a target memory block for a write operation based on the write counts. For example, the controller may persist checkpoints, resumable hidden states, partial outputs, or recovery metadata to different erase blocks or physical pages according to a wear-leveling policy, may increment per-block write counters in a mapping table, and may choose a less-worn block for a subsequent write so that repeated inference or editing operations do not prematurely exhaust the endurance of a subset of storage blocks.

In some embodiments, the processing system may, after performing inference with a first machine learning model whose model weights are stored in a first portion of the non-volatile memory, switch to a second machine learning model whose model weights are stored in a second portion of the non-volatile memory by streaming weights of the second machine learning model through the serial interface to the compute engine without loading the weights of the second machine learning model into DRAM. For example, the processing system may transition from a speech model to a language model, from a small language model to a larger language model, or from a first tenant-specific model to a second tenant-specific model by updating a model descriptor and a set of layer-address mappings while continuing to use the same controller, serial interface, and compute engine datapath.

In some embodiments, the processing system may, after completing computation for a given layer, release a buffered copy of model weights for the given layer and repeat the streaming and performing for one or more subsequent layers of the neural network model without loading weights of the one or more subsequent layers into DRAM. For example, once the compute engine has consumed the buffered weight tiles for layer N and the corresponding output activations have been committed to on-chip volatile memory, the controller may invalidate or overwrite the weight buffer for layer N and may reuse that storage for layer N+1 or a later layer so that only a limited number of active-layer weight buffers are retained at a given time.

FIG. 16 is a process flow diagram illustrating an example method for performing neural network inference using a state-space model with a fixed-size hidden state that represents prior inputs. Method 1600 may be performed in a computing device by a processing system that includes on-chip volatile memory and one or more processors, such as processors 120-132 and related components or subsystems described in this application.

In block 1602, the processing system may process a sequence of input tokens using a neural network model comprising a state-space model. For example, the processing system may tokenize text into subword tokens, bytes, or characters, may tokenize audio into frames or learned acoustic units, may tokenize images into patches or visual tokens, and may convert the tokens into embeddings that are provided to one or more layers of the state-space model executed by an NPU, DSP, GPU, CPU, or other compute engine. In some embodiments, the sequence of input tokens may represent a prompt, a document chunk, a control sequence, a sensor trace, or a multimodal input stream.

In some embodiments, the processing system may implement the state-space model as a Temporal Event-Based Neural Network (TENNs) model. For example, the TENNs model may maintain a recurrent state that is updated for each token or event according to learned transition parameters and input-dependent updates, while still preserving a fixed-dimensional hidden-state representation in on-chip volatile memory.

In block 1604, the processing system may maintain, in on-chip volatile memory, a hidden state associated with the state-space model, the hidden state representing previously processed tokens and having a fixed dimensionality independent of sequence length. For example, the processing system may maintain one or more per-layer state vectors, matrices, or tensors in SRAM, a register file, or a scratchpad memory, with the shape of the hidden state being determined by model architecture parameters rather than by the number of previously processed tokens. In some embodiments, the hidden state may be stored in FP32, FP16, BF16, INT8, INT4, or another representation and may include coefficients, channel states, head-specific states, or other recurrent values used by the state-space model. Maintaining a fixed-dimensional hidden state in this manner permits the processing system to preserve information about earlier tokens without allowing state size to grow linearly with sequence length.

In some embodiments, the processing system may use the hidden state to resume processing using the state-space model without reprocessing one or more previously processed tokens. For example, after a pause, interruption, mode switch, or handoff between software components, the processing system may reload the hidden state from on-chip volatile memory or from a persisted checkpoint and may continue processing subsequent tokens from that hidden state rather than replaying a previously processed prefix of the sequence.

In block 1606, the processing system may update the hidden state for each input token by applying a recurrence of the state-space model. For example, for each new token embedding, the compute engine may apply state-transition coefficients, input-projection coefficients, gating functions, normalization operations, convolutional operations, or other recurrence components to the current hidden state to generate a next hidden state, and may repeat that update across layers and across tokens in sequence order. In some embodiments, the recurrence may be linear, affine, gated, selective, convolution-augmented, continuous-time-inspired, or otherwise parameterized according to the chosen state-space model implementation.

In block 1608, the processing system may generate an output based at least in part on the hidden state. For example, the processing system may apply an output projection head, decoder head, classifier head, regressor head, control-policy head, or another readout function to the hidden state or to a layer output derived from the hidden state to generate logits, token probabilities, classification scores, control values, or other output data. In some embodiments, the output may be a next token, a sequence of tokens, a class label, a ranking score, an anomaly score, a control signal, or another machine-consumable or user-consumable result. Generating the output from the hidden state allows the processing system to use the compact recurrent representation of prior tokens when producing the result.

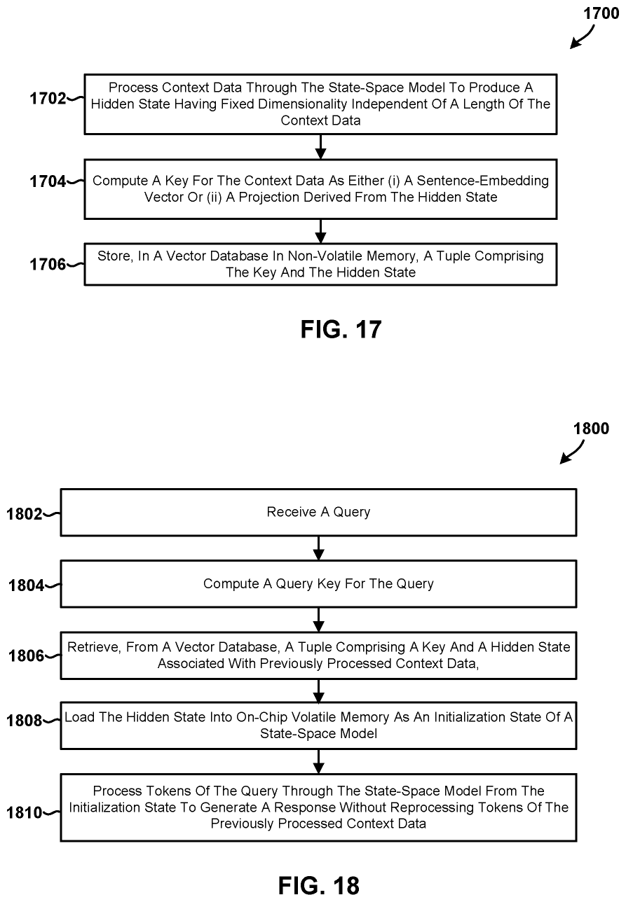

FIG. 17 is a process flow diagram illustrating an example method for generating and storing reusable hidden-state representations of context data in a vector database. Method 1700 may be performed in a computing device by a processing system that includes on-chip volatile memory and one or more processors, such as processors 120-132 and related components or subsystems described in this application.

In block 1702, the processing system may process context data through the state-space model to produce a hidden state having fixed dimensionality independent of a length of the context data. For example, the processing system may segment a document, conversation transcript, code file, knowledge-base entry, image-caption pair, or multimodal record into a context item or chunk, may tokenize that context item, and may run the resulting tokens through the state-space model so that a final hidden state, or a set of per-layer final hidden states, summarizes the processed context item in a fixed-size recurrent representation. In some embodiments, the context data may be chunked according to token count, semantic boundary, section boundary, punctuation, timing boundary, or a sliding-window policy.

In block 1704, the processing system may compute a key for the context data as either a sentence-embedding vector or a projection derived from the hidden state. For example, the processing system may execute a sentence-embedding model over the context data to generate a semantic vector, or may apply a linear projection, learned projection head, or multilayer perceptron to the hidden state to generate a lower-dimensional retrieval vector linked to the hidden state. In some embodiments, the key may additionally include metadata such as a corpus identifier, document identifier, chunk identifier, modality tag, or version tag. Computing the key in this manner places the context data into a retrieval space that can later be matched against query-derived keys.

In block 1706, the processing system may store, in a vector database in non-volatile memory, a tuple comprising the key and the hidden state. For example, the processing system may write a tuple record that includes the key, the hidden state, and optional metadata fields to a flash-backed vector database, MRAM-backed vector database, ReRAM-backed vector database, PCM-backed vector database, or hybrid memory structure, and may update an index that supports similarity-based or identifier-based retrieval of the tuple. In some embodiments, the hidden state may be stored as one vector per layer, as a packed tensor, or as a quantized or compressed payload that preserves the state shape expected by the state-space model.

In some embodiments, the processing system may store the tuple as a non-text numeric representation that omits tokens of the context data. For example, the tuple payload may include numeric arrays representing the key and the hidden state while excluding raw source tokens, token IDs, or token text from the stored tuple, thereby reducing storage footprint and allowing the vector database to function as a compact reusable-context store rather than as a duplicate text repository.

FIG. 18 is a process flow diagram illustrating an example method for generating a response to a query by retrieving and reusing a stored hidden state without reprocessing prior context. Method 1800 may be performed in a computing device by a processing system that includes on-chip volatile memory and one or more processors, such as processors 120-132 and related components or subsystems described in this application.

In block 1802, the processing system may receive a query. For example, the processing system may receive the query from a local text-entry interface, a speech-recognition front end, an application programming interface, a sensor-processing pipeline, an OCR subsystem, or another local or remote input path, and may tokenize or otherwise encode the query into a query representation suitable for subsequent key generation and inference. In some embodiments, the processing system may perform the method in an edge computing device such as a mobile phone, tablet, wearable device, appliance, embedded controller, vehicle subsystem, camera, or local gateway.

In block 1804, the processing system may compute a query key for the query. For example, the processing system may apply a sentence-embedding model, a projection head, a multilayer perceptron, or another key-generation function to the query so as to place the query into the same retrieval space as keys associated with previously processed context data. In some embodiments, the query key may further incorporate a corpus identifier, task tag, user scope, modality indicator, or temporal context indicator to constrain or refine later tuple selection.

In block 1806, the processing system may retrieve, from a vector database, a tuple comprising a key and a hidden state associated with previously processed context data. For example, the processing system may submit the query key to a vector index, may evaluate similarity between the query key and stored keys, may apply metadata filters, and may retrieve a top-ranked tuple or another selected tuple whose associated hidden state corresponds to context data deemed relevant to the query. In some embodiments, the tuple may be stored locally on the edge computing device, remotely on a companion device or server, or across a distributed memory hierarchy with the hidden-state payload delivered back to the querying device. Retrieving the tuple in this manner allows the processing system to recover a reusable recurrent summary of prior context without replaying the prior context tokens.

In some embodiments, the processing system may retrieve the tuple by performing nearest-neighbor search or cosine-similarity matching between the query key and the key of the tuple. For example, the processing system may compute cosine similarity, dot-product similarity, Euclidean distance, or another vector-comparison score, may rank candidate tuples according to the resulting score values, and may choose a highest-ranked tuple or a tuple satisfying a threshold condition for use in subsequent initialization.

In block 1808, the processing system may load the hidden state into on-chip volatile memory as an initialization state of a state-space model. For example, the processing system may read the hidden-state payload from the retrieved tuple, may decompress, dequantize, or unpack the payload if needed, and may copy one or more per-layer vectors of the hidden state into SRAM, registers, local cache, or scratchpad memory before beginning query-time inference. In some embodiments, the initialization state may include one or more auxiliary vectors, coefficients, masks, or layer-specific state components expected by the particular state-space model implementation. Loading the hidden state into on-chip volatile memory permits the state-space model to begin from a state that already reflects the retrieved context.

In block 1810, the processing system may process tokens of the query through the state-space model from the initialization state to generate a response without reprocessing tokens of the previously processed context data. For example, the processing system may sequentially update the initialization state with each query token, may compute output logits or output features at each decoding position, and may emit one or more response tokens, control values, or other outputs while preserving the context information carried by the initialization state. In some embodiments, the processing system may perform greedy decoding, beam search, top-k sampling, nucleus sampling, constrained decoding, or another generation technique to form the response. Beginning from the initialization state may reduce latency and energy consumption because the processing system avoids re-running the state-space model over the previously processed context data.

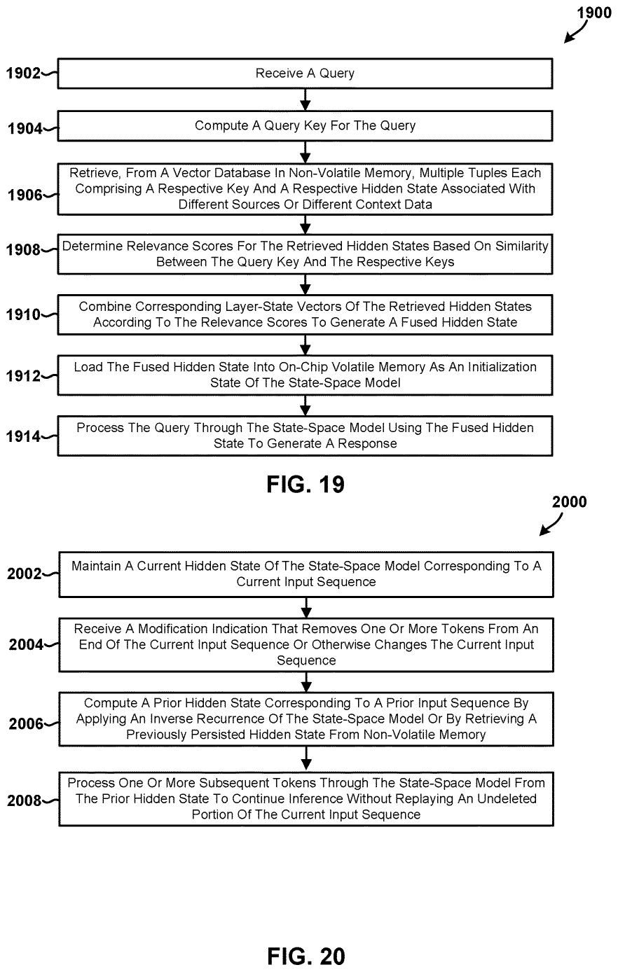

FIG. 19 is a process flow diagram illustrating an example method for generating a response using a fused hidden state derived from multiple stored hidden states. Method 1900 may be performed in a computing device by a processing system that includes on-chip volatile memory and one or more processors, such as processors 120-132 and related components or subsystems described in this application.

In block 1902, the processing system may receive a query. For example, the processing system may receive a natural-language question, command, search request, multimodal prompt, or structured request that is expected to draw from more than one source or more than one context item, and may tokenize or encode the query for key generation and later inference.

In block 1904, the processing system may compute a query key for the query. For example, the processing system may apply a sentence-embedding model, projection function, or another retrieval-key generator to the query to obtain a vector representation that is comparable with keys stored in the vector database for different sources or different context data.

In block 1906, the processing system may retrieve, from a vector database in non-volatile memory, multiple tuples each comprising a respective key and a respective hidden state associated with different sources or different context data. For example, the processing system may execute a top-k similarity search, a filtered similarity search, or a hybrid search that combines metadata filters with vector scoring, and may retrieve tuples associated with different documents, different corpora, different knowledge-base shards, different users, different time periods, or different modality-specific stores. In some embodiments, the processing system may fetch the tuple metadata first and may fetch the corresponding hidden-state payloads only for selected candidates. Retrieving multiple tuples in this manner enables the processing system to form an initialization state that reflects more than one relevant source.

In some embodiments, the different sources may comprise different documents or different corpora. For example, the processing system may retrieve a first tuple associated with a first document or first corpus and a second tuple associated with a second document or second corpus, and may subsequently combine the corresponding hidden states so that the response can draw on both sources during inference.

In block 1908, the processing system may determine relevance scores for the retrieved hidden states based on similarity between the query key and the respective keys. For example, the processing system may compute cosine similarity, dot-product similarity, Euclidean-distance-derived scores, learned reranking scores, or another relevance metric, and may optionally normalize the resulting scores by a softmax function, temperature scaling, clipping rule, thresholding rule, or rank-based normalization procedure. In some embodiments, the relevance scores may further depend on recency, corpus priority, access permissions, source confidence, or other metadata associated with the tuples.

In block 1910, the processing system may combine corresponding layer-state vectors of the retrieved hidden states according to the relevance scores to generate a fused hidden state. For example, for each layer of the state-space model, the processing system may align the corresponding state vectors of the retrieved hidden states, may weight the corresponding state vectors according to the relevance scores, and may combine the weighted vectors by summation, averaging, concatenation followed by projection, gating, or a learned mapper that produces a fused vector having the dimensionality expected by that layer of the state-space model. Combining the hidden states in this manner allows the processing system to encode information from multiple relevant sources into a single initialization state that remains compatible with the original model architecture.

In some embodiments, the processing system may combine the corresponding layer-state vectors by computing a weighted sum of corresponding layer-state vectors according to the relevance scores. For example, after normalizing the relevance scores, the processing system may multiply each layer-state vector by a corresponding weight and may sum the weighted vectors componentwise to produce a fused layer-state vector for that layer.

In block 1912, the processing system may load the fused hidden state into on-chip volatile memory as an initialization state of the state-space model. For example, the processing system may write per-layer fused vectors into SRAM, registers, a scratchpad memory, or a local cache and may prepare the compute engine to begin inference from those fused vectors without first replaying the source context associated with the retrieved tuples.

In block 1914, the processing system may process the query through the state-space model using the fused hidden state to generate a response. For example, the processing system may update the fused hidden state with successive query tokens, may generate output logits or other output signals, and may produce a response that reflects information integrated from the multiple retrieved sources. In some embodiments, the response may comprise natural-language text, a ranking, a recommendation, a classification, a control output, or another result format.

FIG. 20 is a process flow diagram illustrating an example method for updating inference after input modification by reverting to a prior hidden state without replaying unchanged. Method 2000 may be performed in a computing device by a processing system that includes on-chip volatile memory and one or more processors, such as processors 120-132 and related components or subsystems described in this application.

In block 2002, the processing system may maintain a current hidden state of the state-space model corresponding to a current input sequence. For example, while a user types, edits, dictates, or otherwise builds an input sequence, the processing system may update and retain one or more per-layer recurrent state vectors in SRAM, registers, or a scratchpad memory so that the current hidden state reflects the processed prefix of the current input sequence at a given time.

In some embodiments, the processing system may maintain the current hidden state in on-chip volatile memory. For example, the current hidden state may be retained in SRAM, registers, a scratchpad memory, or local cache during active editing or active inference so that the processing system may rapidly update, roll back, or resume the state without first retrieving it from off-chip memory.

In block 2004, the processing system may receive a modification indication that removes one or more tokens from an end of the current input sequence or otherwise changes the current input sequence. For example, the modification indication may correspond to a backspace event, deletion event, insertion event, replacement event, cursor movement followed by edit, branch selection, revision command, or another editing operation received from a user interface, editing engine, application program, or remote client. In some embodiments, the processing system may identify a target prefix or a revised token boundary associated with the modification indication before determining how inference should be resumed.

In block 2006, the processing system may compute a prior hidden state corresponding to a prior input sequence by applying an inverse recurrence of the state-space model or by retrieving a previously persisted hidden state from non-volatile memory. For example, when the state-space model supports an inverse or partially invertible recurrence, the processing system may iteratively reverse one or more update operations associated with removed tokens to recover the prior hidden state, or, when checkpoints are available, the processing system may locate a checkpoint corresponding to a retained prefix of the current input sequence and may restore the prior hidden state from the checkpoint. In some embodiments, the processing system may select between inverse-recurrence rollback and checkpoint retrieval based on edit size, latency budget, checkpoint spacing, numerical stability, or model configuration. Determining the prior hidden state in this manner may allow the processing system to resume inference from a state associated with an unmodified prefix rather than replaying the entire current input sequence from the beginning.

In some embodiments, the previously persisted hidden state may comprise a checkpoint stored in the non-volatile memory for a prefix of the current input sequence. For example, the processing system may periodically store checkpoints at token-count intervals, semantic boundaries, edit boundaries, or latency-driven intervals, and may restore the checkpoint nearest to, but not beyond, the retained prefix of the current input sequence when resuming inference after an edit.

In block 2008, the processing system may process one or more subsequent tokens through the state-space model from the prior hidden state to continue inference without replaying an undeleted portion of the current input sequence. For example, after restoring the prior hidden state associated with the retained prefix, the processing system may process revised tokens, inserted tokens, or subsequent continuation tokens and may generate updated outputs that reflect the modified input sequence while preserving computation already represented in the prior hidden state. Continuing inference from the prior hidden state may reduce latency for edited or corrected inputs and may avoid repeating computation for an undeleted prefix that remains valid.

Some embodiments may include methods performed by a processing system including a controller, a compute engine, an on-chip volatile memory, and a non-volatile memory, the method including storing model weights associated with a neural network model in the non-volatile memory, streaming, by the controller, the model weights from the non-volatile memory over a serial interface to the compute engine without loading the model weights into dynamic random access memory (DRAM), performing, by the compute engine, multiply-accumulate operations using the model weights, and storing intermediate state data associated with the neural network model in the on-chip volatile memory. In some embodiments, the non-volatile memory may include at least one of flash memory, MRAM, ReRAM, or PCM. 3. In some embodiments, the on-chip volatile memory may include at least one of SRAM, a register file, or a scratchpad memory. In some embodiments, the streaming may include sequentially accessing address ranges corresponding to layers. In some embodiments, the streaming and multiply-accumulate operations may be performed concurrently. In some embodiments, the serial interface may include a high-speed serial interface. In some embodiments, the method may include selectively writing at least a portion of the intermediate state data to the non-volatile memory. In some embodiments, writing may include distributing write operations across memory blocks. In some embodiments, the method may include tracking a write count for each memory block. In some embodiments, the neural network model may include a language, speech, vision, or multimodal model.

Some embodiments may include methods for performing inference using a neural network model, the method including processing a sequence of input tokens using the neural network model, maintaining a hidden state associated with the neural network model, the hidden state representing previously processed tokens, updating the hidden state for each input token from the sequence of input tokens, and generating an output based on the hidden state, wherein the hidden state has a fixed dimensionality independent of sequence length. In some embodiments, the neural network model may include a state-space model. In some embodiments, the hidden state may be stored in on-chip volatile memory. In some embodiments, the updating may include applying a recurrence. In some embodiments, the hidden state may involve resuming processing using the neural network model without reprocessing tokens. In some embodiments, the hidden state may occupy a fixed memory footprint.

Some embodiments may include methods for accelerating inference of a neural network model, the method including processing a context data associated with a feature to generate a hidden state associated with the neural network model, storing the hidden state in a memory, receiving an input query, the input query associated with the feature, retrieving the hidden state, and continuing inference using the neural network model and using the hidden state as an initial state. In some embodiments, the hidden state may be stored as a tuple including a key and the hidden state. In some embodiments, the key may include an embedding vector. In some embodiments, the hidden state may represent a compressed representation. In some embodiments, retrieving may avoid reprocessing context data. In some embodiments, the hidden state may be generated offline. In some embodiments, the hidden state may be used as an initial condition. In some embodiments, streaming and computation may be overlapped in a pipelined manner.

Some embodiments may include methods for performing inference using a neural network model, the methods including retrieving multiple hidden states associated with the neural network model, determining relevance scores, combining the hidden states to generate a fused hidden state, and performing inference using the fused hidden state. In some embodiments, combining may include computing a weighted sum. In some embodiments, a relevance score is determined using an embedding. In some embodiments, hidden states may correspond to different sources.

Some embodiments may include methods for modifying an inference associated with a neural network model, the methods including maintaining a hidden state associated with the neural network model, receiving a modification indication related to the hidden state, computing a prior hidden state associated with the neural network model by reversing update operations, and continuing inference using the neural network model based on the prior hidden state. In some embodiments, reversing update operations may include applying an inverse recurrence. In some embodiments, the modification indication may include an indication associated with removing tokens.

Some embodiments may include methods for storing and retrieving intermediate state data, the methods including generating a hidden state associated with a machine learning model, generating a key, storing a tuple including the key and the hidden state, receiving an input query, matching the input query to the key, retrieving the hidden state associated with the machine learning model. In some embodiments, the key may includes an embedding vector. In some embodiments, the hidden state may represent compressed data.

Some embodiments may include methods for executing a neural network model, the methods including streaming weights associated with a first portion of the neural network model, performing a computation associated with the first portion of the neural network model, streaming weights associated with a second portion of the neural network model, the second portion different than the first portion and the streaming performed at least partly during the computation associated with a first portion of the neural network model, and performing a computation associated with the second portion of the neural network model. In some embodiments, the portions may correspond to layers.

Some embodiments may include methods for generating a response to an input query, the methods including receiving the input query, generating a query representation, retrieving a hidden state associated with a model, initializing the model using the hidden state, and generating the response. In some embodiments, retrieving may include accessing tuples.

Some embodiments may include methods for performing inference of a neural network model, the methods including streaming weights for a layer associated with the neural network model, processing the layer associated with the neural network model, discarding the weights for the layer associated with the neural network model, and repeating for one or more subsequent layers associated with the neural network model other than the layer associated with the neural network model.

Some embodiments may include methods for operating a processing system, the methods including storing weights associated with a plurality of machine learning models, performing an inference using a first machine learning model from the plurality of machine learning models, switching to a second machine learning model from the plurality of machine learning models without loading weights associated with the second machine learning model into DRAM, and performing an inference using the second model.

Some embodiments may include a system for performing inference with a neural network model, including: a controller, a compute engine, an on-chip volatile memory, a non-volatile memory, and a serial interface coupling the non-volatile memory to the controller and the compute engine, in which the non-volatile memory is configured to store model weights associated with the neural network model, in which the controller is configured to stream the model weights from the non-volatile memory over the serial interface during an inference operation without first loading the model weights into dynamic random access memory (DRAM), in which the compute engine is configured to perform multiply-accumulate operations on input data using the streamed model weights to generate output data, and in which the on-chip volatile memory is configured to store intermediate state data generated during the inference operation.

Some embodiments may include a method for accelerating inference of a neural network model on a processing system, the method including: processing context data through the neural network model to generate a hidden state that summarizes the context data, storing the hidden state in association with a key in a memory, receiving an input query associated with the context data, generating a query representation for the input query, retrieving the hidden state from the memory based on the query representation and the key, loading the hidden state into the neural network model as an initialization state, and processing query tokens of the input query through the neural network model from the initialization state to generate a response without reprocessing tokens of the context data.

Some embodiments may include a method for performing inference using a fused hidden state of a neural network model on a processing system, the method including: receiving an input query, retrieving, from a memory, multiple hidden states associated with the neural network model and respectively corresponding to different context data, determining relevance scores for the multiple hidden states with respect to the input query, combining at least two of the multiple hidden states based on the relevance scores to generate a fused hidden state, loading the fused hidden state into the neural network model as an initialization state, and processing query tokens of the input query through the neural network model from the initialization state to generate a response.

Some embodiments may include a method for modifying inference of a neural network model on a processing system, the method including: processing tokens of an input sequence through the neural network model while maintaining a hidden state that is updated for the tokens, receiving a modification indication identifying at least one token of the input sequence, computing a prior hidden state by reversing one or more update operations corresponding to the at least one token, and continuing inference from the prior hidden state to generate a revised output without reprocessing all tokens of the input sequence.

Some embodiments may include a method for storing and retrieving intermediate state data for a machine learning model on a processing system, the method including: processing a data chunk through the machine learning model to generate a hidden state associated with the data chunk, generating a key associated with the hidden state, storing a tuple including the key and the hidden state in a memory, receiving an input query, generating a query key associated with the input query, matching the query key to the key, retrieving the hidden state from the tuple, and loading the hidden state into the machine learning model for processing the input query.

Some embodiments may include a method for generating a response to an input query with a neural network model on a processing system, the method including: receiving the input query, generating a query representation for the input query, retrieving, from a memory storing tuples of keys and hidden states, a hidden state associated with model context based on the query representation, loading the hidden state into the neural network model as an initialization state, and processing tokens of the input query through the neural network model from the initialization state to generate the response.

Some embodiments may include a system for accelerating inference of a neural network model, including: one or more processors, and a memory storing instructions that, when executed by the one or more processors, cause the one or more processors to: process context data through the neural network model to generate a hidden state that summarizes the context data, store the hidden state in association with a key in the memory, receive an input query associated with the context data, generate a query representation for the input query, retrieve the hidden state from the memory based on the query representation and the key, load the hidden state into the neural network model as an initialization state, and process query tokens of the input query through the neural network model from the initialization state to generate a response without reprocessing tokens of the context data.

Some embodiments may include a system for performing inference using a fused hidden state of a neural network model, including: one or more processors, and a memory storing instructions that, when executed by the one or more processors, cause the one or more processors to: receive an input query, retrieve, from a memory, multiple hidden states associated with the neural network model and respectively corresponding to different context data, determine relevance scores for the multiple hidden states with respect to the input query, combine at least two of the multiple hidden states based on the relevance scores to generate a fused hidden state, load the fused hidden state into the neural network model as an initialization state, and process query tokens of the input query through the neural network model from the initialization state to generate a response.

Some embodiments may include a system for modifying inference of a neural network model, including: one or more processors, and a memory storing instructions that, when executed by the one or more processors, cause the one or more processors to: process tokens of an input sequence through the neural network model while maintaining a hidden state that is updated for the tokens, receive a modification indication identifying at least one token of the input sequence, compute a prior hidden state by reversing one or more update operations corresponding to the at least one token, and continue inference from the prior hidden state to generate a revised output without reprocessing all tokens of the input sequence.

Implementation examples are described in the following paragraphs. Although several implementation examples are described as example methods, other implementation examples may take the form of a computing device or data processing apparatus. The computing device or data processing apparatus may include a processing system coupled to a memory. The memory may store instructions that, upon execution by the processing system, cause the computing device or data processing apparatus to perform operations of the methods described in the following implementation examples. Further implementation examples may take the form of a computer program product comprising instructions that, upon execution by one or more processors of a computing device, cause the computing device to perform those operations. Further implementation examples may take the form of a computer-readable storage medium having stored thereon such instructions.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross-point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, SoC components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art, the order of steps in the foregoing aspects may be performed in any order. Words such as “thereafter,” “then,” “next,” etc., are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method performed by a processing system in a computing device, the processing system comprising a controller, a compute engine, an on-chip volatile memory, and a serial interface coupled to a non-volatile memory, the method comprising:
accessing, in the non-volatile memory, model weights of a neural network model in address ranges corresponding to respective layers of the neural network model;
streaming, by the controller through the serial interface and without loading first model weights into dynamic random-access memory (DRAM), first model weights for a first layer from a first address range of the non-volatile memory to the compute engine;
performing, by the compute engine, multiply-accumulate operations for the first layer using the first model weights;
streaming, by the controller through the serial interface and without loading second model weights into DRAM, second model weights for a second layer from a second address range of the non-volatile memory to the compute engine while the compute engine performs the multiply-accumulate operations for the first layer; and
storing intermediate state data of the neural network model in the on-chip volatile memory during inference.

2. The method of claim 1, wherein the non-volatile memory comprises flash memory, magnetoresistive random-access memory (MRAM), resistive random-access memory (ReRAM), or phase-change memory (PCM).

3. The method of claim 1, wherein the on-chip volatile memory comprises static random-access memory (SRAM), a register file, or a scratchpad memory.

4. The method of claim 1, wherein the serial interface conforms to a Universal Flash Storage (UFS) standard and uses MIPI M-Phy, and wherein the controller sequentially accesses the address ranges in a predetermined order that permits prefetching model weights for a subsequent layer.

5. The method of claim 1, further comprising selectively writing at least a portion of the intermediate state data to the non-volatile memory, distributing write operations across memory blocks of the non-volatile memory, tracking write counts for the memory blocks, and selecting a target memory block for a write operation based on the write counts.

6. The method of claim 1, further comprising, after performing inference with a first machine learning model whose model weights are stored in a first portion of the non-volatile memory, switching to a second machine learning model whose model weights are stored in a second portion of the non-volatile memory by streaming weights of the second machine learning model through the serial interface to the compute engine without loading the weights of the second machine learning model into DRAM.

7. The method of claim 1, further comprising, after completing computation for a given layer, releasing a buffered copy of model weights for the given layer and repeating the streaming and performing for one or more subsequent layers of the neural network model without loading weights of the one or more subsequent layers into DRAM.

8. A computing device, comprising:
a non-volatile memory;
a serial interface; and
a processing system coupled to the non-volatile memory by the serial interface and comprising a controller, a compute engine, and an on-chip volatile memory,
wherein the non-volatile memory stores model weights of a neural network model in address ranges corresponding to respective layers of the neural network model,
wherein the controller is configured to stream, through the serial interface and without loading first model weights into DRAM, first model weights for a first layer from a first address range of the non-volatile memory to the compute engine and to stream, through the serial interface and without loading second model weights into DRAM, second model weights for a second layer from a second address range of the non-volatile memory while the compute engine is processing the first layer, and
wherein the on-chip volatile memory is configured to store intermediate state data of the neural network model during inference.

9. The computing device of claim 8, wherein the processing system is implemented in a system-on-chip, and wherein the non-volatile memory is co-packaged with the system-on-chip in a system-in-package, stacked, or chiplet arrangement.

10. The computing device of claim 8, wherein the serial interface conforms to a Universal Flash Storage (UFS) standard and uses MIPI M-Phy.

11. The computing device of claim 8, wherein the controller is configured to selectively write at least a portion of the intermediate state data to the non-volatile memory, distribute the writes across memory blocks of the non-volatile memory, track write counts for the memory blocks, and select a target memory block for a write operation based on the write counts.

12. The computing device of claim 8, wherein the non-volatile memory stores weights of a plurality of machine learning models in different portions of the non-volatile memory, and wherein the processing system is further configured to switch from a first machine learning model to a second machine learning model without loading weights of the second machine learning model into DRAM.

13. The computing device of claim 8, wherein, after computation for a given layer, the processing system is configured to release a buffered copy of weights for the given layer and to repeat streaming and computation for one or more subsequent layers of the neural network model without loading weights of the one or more subsequent layers into DRAM.

14. The computing device of claim 8, wherein the neural network model comprises a state-space model or other recurrent computational model, and wherein the intermediate state data comprise hidden state vectors maintained in the on-chip volatile memory and having fixed dimensionality independent of sequence length.

15. A non-transitory processor-readable medium having stored thereon data, configurations, or processor-readable instructions that, when used to control a state machine or when executed by a processing system in a computing device, cause the processing system to perform operations for direct-from-non-volatile-memory inference of a neural network model, the operations comprising:
accessing, in a non-volatile memory, model weights of the neural network model in address ranges corresponding to respective layers of the neural network model;
streaming, through a serial interface and without loading first model weights into DRAM, first model weights for a first layer from the non-volatile memory to a compute engine;
causing the compute engine to perform multiply-accumulate operations for the first layer using the first model weights;
streaming, through the serial interface and without loading second model weights into DRAM, second model weights for a second layer from the non-volatile memory to the compute engine while the multiply-accumulate operations for the first layer are being performed; and
storing intermediate state data of the neural network model in on-chip volatile memory during inference.

16. The non-transitory processor-readable medium of claim 15, wherein the operations further comprise sequentially accessing address ranges corresponding to layers of the neural network model in a predetermined order that permits prefetching model weights for a subsequent layer while the compute engine is performing multiply-accumulate operations for a current layer.

17. The non-transitory processor-readable medium of claim 15, wherein the operations further comprise switching from inference with a first machine learning model to inference with a second machine learning model, both stored in the non-volatile memory, without loading weights of the second machine learning model into DRAM.

18. The non-transitory processor-readable medium of claim 15, wherein the operations further comprise, after completing computation for a given layer, releasing a buffered copy of model weights for the given layer and repeating the streaming and multiply-accumulate operations for one or more subsequent layers without loading weights of the one or more subsequent layers into DRAM.

19. The non-transitory processor-readable medium of claim 15, wherein the operations further comprise selectively writing at least a portion of the intermediate state data to the non-volatile memory, distributing write operations across memory blocks of the non-volatile memory, tracking write counts for the memory blocks, and selecting a target memory block for a write operation based on the write counts.

20. The non-transitory processor-readable medium of claim 15, wherein the operations accomplish inference using a state-space model or other recurrent computational model, and wherein the intermediate state data comprise hidden state vectors maintained in the on-chip volatile memory and having fixed dimensionality independent of sequence length.
